(19) United States
(12) Patent Application Publication
(10) Pub. No.: US 2025/0180758 A1
(43) Pub. Date: Jun. 5, 2025

(54) LOW COST, ROBUST AND HIGH SENSITIVITY ION-CONDUCTING POLYCRYSTALLINE RADIATION DETECTORS

(71) Applicant: Massachusetts Institute of Technology, Cambridge, MA (US)

(72) Inventors: Harry L. TULLER, Wellesley, MA (US); Thomas DEFFERRIERE, Cambridge, MA (US); Jennifer Lilia Marguerite Rupp, Starnberg (DE); Ju LI, Weston, MA (US); Ahmed Sami Helal Ali Elwakeil, Cambridge, MA (US)

(21) Appl. No.: 19/042,616

(22) Filed: Jan. 31, 2025

Related U.S. Application Data
(63) Continuation-in-part of application No. PCT/US2023/086168, filed on Dec. 28, 2023.
(60) Provisional application No. 63/477,409, filed on Dec. 28, 2022.

(51) Int. Cl. G01T 1/185

(52) U.S. Cl. CPC G01T 1/185

(57) ABSTRACT

A detector for gamma irradiation comprises an oxygen ion conducting polycrystalline solid, has positively charged grain boundaries or negatively charged grain boundaries and is coupled to electrodes that measure changes in the polycrystalline solid's ionic conductance. The polycrystalline solid may include lightly doped Gd-doped CeO₂, a polycrystalline ion conducting ceramic. The steady state passivation of space charge barriers at grain boundaries that may act as virtual electrodes, capturing radiation-induced electrons, in turn lowering space charge barrier heights, and thereby exclusively modulating the ionic carrier flow within the ceramic electrolytes. Such behavior may allow for an electrical response under low fields, i.e., <2 V/cm. The polycrystalline solids disclosed herein may be used in inexpensive, sensitive, low-power and miniaturizable solid-state devices, uniquely suited for operating in harsh (high temperature, high humidity, pressure, and/or corrosive) environments. The detectors disclosed herein may be suitable for simultaneous spectroscopy and dosimetry measurements.

### CROSS-REFERENCE TO RELATED APPLICATION

This application is a continuation-in-part of International Application No. PCT/US2023/086168, filed Dec. 28, 2023, entitled, “LOW COST, ROBUST AND HIGH SENSITIVITY ION-CONDUCTING POLYCRYSTALLINE RADIATION DETECTORS,” which in turn claims priority to U.S. Application No. 63/477,409, filed Dec. 28, 2022. Each of the aforementioned applications is incorporated herein by reference in its entirety for all purposes.

### GOVERNMENT SUPPORT

This invention was made with government support under DTRA1-20-2-0002 awarded by the Defense Threat Reduction Agency, and DE-SC0002633 awarded by the U.S. Department of Energy. The government has certain rights in the invention.

### BACKGROUND

High-performance, low-cost nuclear radiation detectors based on semiconductors have broad applicability in homeland security (nonproliferation of nuclear materials), industrial and medical imaging, nuclear energy, radioactive waste monitoring, oil/gas/geothermal exploration, and fundamental scientific research. For example, nuclear nonproliferation officers, first responders, and security personnel need to rapidly detect, identify, and quantify radioactive materials that may be security threats. While state-of-the-art semiconducting nuclear radiation sensing technologies can achieve high performance, they are either costly (e.g., CdZnTe) or inconvenient (e.g., cryogenic cooling required for high purity germanium, HPGe) for widespread use as portable or large-area device monitors. Furthermore, the detrimental impact of lattice defects on semiconducting performance requires complex crystal growth processing to achieve high-quality materials and, thereby, high sensing efficiency that relies on large electronic carrier mobility-lifetime (μτ) products.

Advances in new and emerging robust detector materials are warranted for the development of sensitive and convenient portable detectors and spectrometers at reduced cost. Design considerations may include simplicity of device design and materials processing, high sensitivity, robust operation and ability to distinguish between different radiation sources. The search for alternative defect-insensitive, high effective atomic number (i.e., high-Z) and wide-bandgap material candidates that can be produced with large areas and that are chemically, thermally, and mechanically robust has remained commercially elusive. Materials such as CsPbBr₃, TlBr, FAPbBr₃/MAPbBr₃, MAPbI₃, and TlInSe₂ have shown promising radiation monitoring properties, but proofs of concepts to-date still often require single crystals, limiting scalability. Moreover, they suffer from a variety of environmental and operational degradation mechanisms given low temperature stability limits and/or those related to ionic defect migration under applied DC potential, resulting in undesirable and irreversible electrochemical reactions at the electrodes that alter the charge transfer and collection efficiency of semiconductor-based sensing devices, ultimately complicating the overall device design and operation.

State-of-the-art radiation spectrometers generally rely on semiconducting materials constructed with simple photoconductor architectures or more complex p-i-n structures. The electron-hole pairs generated by ionizing radiation are separated by built-in and/or externally applied electric fields and drift towards the electrodes where they are collected. Key material figures of merit include overall dark resistance, which establishes the lower threshold limit of detection, above which sufficiently high concentration of photogenerated carriers can be detected, and the mobility-carrier lifetime (μ·τ) product, which defines how efficiently photogenerated charges can be extracted from the device and therefore the signal magnitude. In turn, the mobility and carrier lifetimes in semiconductors depend on the quality of the crystal, as defects can act as scattering or trapping centers that prevent charge collection.

Single crystal materials with reduced defect densities are thus preferred; unfortunately, this leads to increased fabrication costs and size limitations. For example, high purity germanium remains the gold standard of semiconductor gamma-ray spectrometers in terms of energy resolution, but, owing to its rather small band gap, requires cryogenic cooling to achieve reasonable dark resistances, thus limiting applications where small size and low power are important. Wider band gap materials are more promising for room temperature operation, as they allow more ready distinction of low radiation intensity signals from background thermal generation.

While CdZnTe (CZT) detectors operate at room temperature and provide high energy resolution, they remain costly. The complex ternary nature of the CZT compounds requires precise composition and temperature control during synthesis to obtain superior electrical transport properties. Structural (i.e., twinning, stacking faults, and grain boundaries) and chemical inhomogeneities (i.e., Te precipitates) can easily arise during synthesis, thereby limiting overall device performance by quenching or scattering charges generated by gamma irradiation. Significant efforts are needed to control crystal growth to minimize defect generation with meticulous harvesting from pristine sections of the boule needed to obtain the best quality crystals. This limits overall large-scale production capabilities and increases cost.

These examples of engineering challenges for state-of-the-art, room-temperature CZT detectors also translate to next generation candidate materials such as CsPbBr₃, TlBr, MAPbBr₃, MAPbI₃, Tl₆SeI₄, and TlInSe₂ that are currently in research and development phases and exhibit similar synthesis dilemmas. Of the next generation candidates that are most promising, the halides, such as TlBr, CsPbBr₃, or MAPbI₃, exhibit some of the most promising radiation monitoring properties with high μ·τ products and unique defect tolerance properties that make them less sensitive to point defects. However, they suffer from a broad range of engineering challenges, as related to various environmental degradation mechanisms (atmosphere, humidity, and temperature). Degradation mechanisms related to ionic defect migration and electrochemical reactions at the electrodes further affect performance under above band gap irradiation. It is difficult to find semiconducting materials that exhibit the superior transport properties required for accurate sensing while meeting desired cost, production, and operating specifications.

High-performance, low-cost nuclear radiation detectors based on semiconductors have broad applicability in homeland security (nonproliferation of nuclear materials), industrial and medical imaging, nuclear energy and radioactive waste safety, oil/gas/geothermal exploration, and fundamental scientific research. Thus, the development of radiation sensing technology characterized by low manufacturing costs, while offering high performance gamma ray detection, even under harsh operating conditions, is highly desirable.

### SUMMARY

In some aspects, the techniques described herein relate to a detector for gamma radiation, the detector including an oxygen ion conducting polycrystalline material to absorb the gamma radiation, wherein the oxygen ion conducting polycrystalline material is about 100 μm thick to about 100 mm thick, a pair of electrodes, electrically coupled to the oxygen ion conducting polycrystalline material, to apply a voltage across the oxygen ion conducting polycrystalline material, and a sensor, electrically coupled to the pair of electrodes, to measure a change in the voltage across the oxygen ion conducting polycrystalline material caused by absorption of the gamma radiation.

In some aspects, the techniques described herein relate to a detector wherein the sensor measures a change in conductance across the oxygen ion conducting polycrystalline material caused by absorption of gamma radiation.

In some aspects, the techniques described herein relate to a detector having a dark resistance>10¹⁴ ohm.

In some aspects, the techniques described herein relate to a detector having a sensitivity ΔR/R of about 10⁵.

In some aspects, the techniques described herein relate to a detector wherein the detector is not temperature sensitive below 400° C.

In some aspects, the techniques described herein relate to a detector wherein the detector is not temperature sensitive below 300° C.

In some aspects, the techniques described herein relate to a detector, wherein the voltage is about 10 mV to about 100 V. In some aspects, the techniques described herein relate to a detector wherein the voltage is about 50 mV to about 200 mV.

In some aspects, the techniques described herein relate to a detector wherein the voltage is an alternating voltage.

In some aspects, the techniques described herein relate to a detector wherein the ion conducting polycrystalline material includes a cerium, magnesium, lithium, sodium, fluorine, iodine, bromine, silver, copper, aluminum, or proton solid-state polycrystalline material. In some aspects, the techniques described herein relate to a detector wherein the ion conducting polycrystalline material conducts at least one of an oxygen ion, a magnesium ion, a lithium ion, a sodium ion, a potassium ion, a chlorine ion, a fluorine ion, an iodine ion, a bromine ion, a silver ion, a copper ion, an aluminum, hydroxide (OH−) ion, or a hydrogen (H+) ion.

In some aspects, the techniques described herein relate to a detector wherein the oxygen ion conducting polycrystalline material includes CeO₂ and a Gd dopant.

In some aspects, the techniques described herein relate to a detector wherein the Gd dopant may range from 0.5 atm % to 40 atm %.

In some aspects, the techniques described herein relate to a detector wherein the Gd dopant is 3 atm %.

In some aspects, the techniques described herein relate to a detector wherein the oxygen ion conducting polycrystalline material includes positively charged grain boundaries. In some aspects, the techniques described herein relate to a detector wherein the oxygen ion conducting polycrystalline material includes negatively charged grain boundaries.

In some aspects, the techniques described herein relate to a detector wherein the positively charged grain boundaries are spaced about 10 nm apart from each other to about 1 μm apart from each other. In some aspects, the techniques described herein relate to a detector wherein the negatively charged grain boundaries are spaced about 10 nm apart from each other to about 1 μm apart from each other.

In some aspects, the techniques described herein relate to a detector wherein the oxygen ion conducting polycrystalline material includes a pellet or a plate.

In some aspects, the techniques described herein relate to a detector wherein the oxygen ion conducting polycrystalline material is about 500 μm thick to about 10 mm thick.

In some aspects, the techniques described herein relate to a method of detecting gamma radiation, the method including irradiating an oxygen ion conducting polycrystalline material with the gamma radiation, the gamma radiation causing ions to migrate across grain boundaries within the oxygen ion conducting polycrystalline material, applying a voltage across a pair of electrodes, positioned to sandwich the oxygen ion conducting polycrystalline material and electrically coupled to the oxygen ion conducting polycrystalline material, and sensing a change in conductance of the oxygen ion conducting polycrystalline material caused by migration of the ions across the grain boundaries.

In some aspects, the techniques described herein relate to a detector, wherein the voltage is about 10 mV to about 100 V. In some aspects, the techniques described herein relate to a method wherein the voltage is about 50 mV to about 200 mV.

In some aspects, the techniques described herein relate to a method wherein the voltage is an alternating voltage. In some aspects, the techniques described herein relate to a detector, wherein the voltage is a constant voltage.

In some aspects, the techniques described herein relate to a method further including measuring an impedance of the oxygen ion conducting polycrystalline material in response to the alternating voltage at a frequency of about 1 MHz to about 0.01 Hz and determining a conductivity of a bulk of the oxygen ion conducting polycrystalline material based on the impedance of the oxygen ion conducting polycrystalline material.

In some aspects, the techniques described herein relate to a method further including measuring a temperature of the bulk of the oxygen ion conducting polycrystalline material and detecting degradation in the oxygen ion conducting polycrystalline material in response to the gamma radiation based the conductivity of the bulk of the oxygen ion conducting polycrystalline material and the temperature of the bulk of the oxygen ion conducting polycrystalline material.

In some aspects, the techniques described herein relate to a method of detecting radiation, the method including irradiating an oxygen ion conducting polycrystalline material with the radiation, the radiation causing ions to migrate across grain boundaries within the oxygen ion conducting polycrystalline material, applying a voltage across a pair of electrodes, positioned to sandwich the oxygen ion conducting polycrystalline material and electrically coupled to the oxygen ion conducting polycrystalline material, and sensing a change in conductance of the oxygen ion conducting polycrystalline material caused by migration of the ions across the grain boundaries.

In some aspects, the techniques described herein relate to a method, wherein the voltage is about 50 mV to about 500 mV.

In some aspects, the techniques described herein relate to a method, wherein the voltage is an alternating voltage, the method further including measuring an impedance of the oxygen ion conducting polycrystalline material in response to the alternating voltage at a frequency of about 1 MHz to about 0.01 Hz and determining a conductivity of a bulk of the oxygen ion conducting polycrystalline material based on the impedance of the oxygen ion conducting polycrystalline material. 20.

In some aspects, the techniques described herein relate to a method, wherein the voltage is a constant voltage, the method further including sensing a change in current across the pair of electrodes caused by the radiation and determining a type of the radiation in response to the change in current across the pair of electrodes caused by the radiation.

In some aspects, the techniques described herein relate to a method, further including determining an energy spectrum of the radiation based on the change in current across the pair of electrodes caused by the radiation.

In some aspects, the techniques described herein relate to a method, further including measuring a change in a concentration of ionic charge in the pair of electrodes and determining a total dose of radiation received by the oxygen ion conducting polycrystalline material over a period of time in response to the change in the concentration of ionic charge in the pair of electrodes.

In some aspects, the techniques described herein relate to a method wherein the ions comprise at least one of an oxygen ion, a magnesium ion, a lithium ion, a sodium ion, a potassium ion, a chlorine ion, a fluorine ion, an iodine ion, a bromine ion, a silver ion, a copper ion, an aluminum, hydroxide (OH−) ion, or a hydrogen (H+) ion.

All combinations of the foregoing concepts and additional concepts discussed in greater detail below (provided such concepts are not mutually inconsistent) are part of the inventive subject matter disclosed herein. In particular, all combinations of claimed subject matter appearing at the end of this disclosure are part of the inventive subject matter disclosed herein. The terminology used herein that also may appear in any disclosure incorporated by reference should be accorded a meaning most consistent with the particular concepts disclosed herein.

### BRIEF DESCRIPTIONS OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally and/or structurally similar elements).

FIG. 1A shows a schematic diagram of an oxygen ion conducting polycrystalline solid electrolyte thin film supported on an insulating substrate with porous platinum (Pt) surface electrodes under illumination.

FIG. 1B shows schematic spatial potential energy (ϕ_{GBC})/defect concentration (v_{Ö}, n) diagrams representative of the space charge zone at a grain boundary in the dark (on left) and under above band gap illumination (on right). As illustrated, the positively charged grain boundary core may lead to a potential that may induce a depletion of positively charged ionic defects v_{ö} in the adjacent grains near the interface, resulting in high total film resistance in the dark. Illumination induced reductions in space charge barriers occur as photogenerated negative charge carriers recombine in the grain boundary core, neutralizing the original positive charge and alleviating the depletion of ionic carriers and thus may increase the film's conductance.

FIG. 1C shows a schematic diagram of a radiation detector device including an oxygen ion conducting polycrystalline solid electrolyte in form of a pellet or disc.

FIG. 1D a schematic diagram of a radiation detector device including an oxygen ion conducting polycrystalline solid electrolyte in form of a pellet or disc inside of a chamber.

FIG. 2A shows a graph of log conductance (1/R), reciprocal of resistance R, vs reciprocal temperature under UV illumination vs. that in the dark comparing response of a polycrystalline film of 3 atm % Gd doped CeO₂ (3GDC) to an epitaxial film of the same composition.

FIG. 2B shows a graph of log conductance (1/R) vs reciprocal temperature under Gamma and UV illumination vs. that in the dark of a polycrystalline film of 3 atm % Gd doped CeO₂ (3GDC).

FIG. 3A shows an image of a heater stick for use in the in-situ heater/measurement device.

FIG. 3B shows an image of the in-situ heater/measurement device.

FIG. 3C shows the in-situ heater/measurement device of FIG. 3B positioned in an irradiator device.

FIG. 4A shows a normalized and cascaded view of X-ray diffraction (XRD) spectra for bulk samples of 3GDC series B, each exposed to various irradiation doses (0 (bottom spectra), 500 kGy (middle spectra), 1 MGy (top spectra)).

FIG. 4B shows an un-normalized magnification of superimposed (111) and (200) peaks for all three samples of FIG. 4A.

FIG. 5A shows a Raman spectrum with a 473 nm wavelength pump beam for two bulk samples of the 3GDC solid electrolyte film (Samples B and C) cut into three pieces and each exposed to various irradiation doses (0, 500 kGy, 1 MGy) illustrating the complete spectrum with a main F_{2g} peak (465 cm⁻¹) and defect bands 550 cm⁻¹ and 600 cm⁻¹).

FIG. 5B shows a Raman spectrum magnification of the F_{2g} peak shown in FIG. 5A for different radiation doses.

FIG. 6A shows an example Nyquist plot of the complex impedance response obtained at 141.7° C. for a 3GDC solid electrolyte pellet measured in the dark, with the inset explicitly showing the high-frequency arc.

FIG. 6B shows an equivalent circuit used to model the circuit elements composed of a resistor in series with 2 R/CPE parallel circuits in series.

FIG. 6C shows a semi log plot of the Arrhenius dependence of the conductance G as (1/R)×T vs. 1/k_{B}T derived from the high (bulk) and low frequency (grain boundary) arcs.

FIG. 7A shows a Nyquist plot of complex impedance response obtained for the 3GDC solid electrolyte pellet measured at near room temperature (approximately 23.8° C.) in the dark and under γ-ray exposure.

FIG. 7B shows a plot of the Arrhenius dependence of the logarithm of the conductance (1/R)×T vs. 1/k_{B}T corresponding to the high frequency and low-frequency arcs (related to grain and grain boundary contributions, respectively) obtained in the dark and under irradiation.

FIG. 8 shows a ⁶⁰Co source array.

FIG. 9 shows a Gammacell 220.

FIG. 10 shows the in-situ set-up of the heater/measurement device.

FIG. 11A shows a schematic of the in-situ heater/measurement device.

FIG. 11B shows a photo of the electrically insulated exterior of the device of FIG. 11A.

FIG. 11C shows the inner heat shield of the device of FIG. 11A.

FIG. 11D shows the insulated electrical wires connecting the sample to the electrical testing equipment. The structure of the heater stick includes screen-printed gold contacts, back side Pt-heater lines, and a front side Au—Pt thermocouple on an alumina substrate.

FIG. 12 shows the in-situ heater/measurement device, composed of the heater stick, connected to a power supply rated for (10V/0.5 A) and an impedance analyzer. The heater stick device is positioned inside the reactor main chamber and connected through the top. To begin, the main chamber was automatically lowered into the body of the Irradiator where it was exposed to the ⁶⁰Co source array.

FIG. 13A shows a schematic of a space charge zone with a spatially dependent potential barrier ϕ(x) in acceptor doped (Gd) CeO₂ in air a low temperature (<300° C.). A positive core charge results in the depletion of positively charged mobile carriers oxygen vacancies (V_{Ö}) and electron holes (p) and the accumulation of negatively charged mobile electrons (n). A simplified Mott Schottky approximation may be used where the dopant profile (Gd′_{Ce}) is assumed to be flat and frozen-in, and where the dopant is not able to redistribute during the measurement conditions.

FIG. 13B shows a schematic of the formation of space charge potential and ion depletion zones in the dark (left) and under above band gap illumination (right).

FIG. 14 shows a SEM micrograph of fracture surface of pristine polycrystalline 3GDC pellet at different magnifications—see markers: 1 μm (left) and 200 nm (right).

FIG. 15A shows the XRD results for the 3GDC solid electrolyte pellet sintered at 1300° C.

FIG. 15B shows the Rietveld fitting methods results.

FIG. 16 shows Raman results for the pristine 3GDC solid electrolyte pellet sintered at 1300° C. recorded using 473 nm wavelength illumination. The major peaks of interest are situated at 464.24 cm⁻¹ and around approximately 550/600 cm⁻¹ and are indicated by asterisks (*).

FIG. 17 shows an image of the solid electrolyte pellet Sample A connected to in-situ measurement setup with 5×9 mm Pt electrode on the front side.

FIG. 18A shows an example image of solid electrolyte film pellet B that was split into three equal 5×5×1 cm samples and exposed to various levels of γ irradiation.

FIG. 18B shows an image of the solid electrolyte samples from series B inside quartz test tubes used for the irradiation experiment in order from left to right of increasing irradiation dose. The discoloration and increasing opacity of the test tube with the irradiation dose confirms the exposure of the specimen to irradiation.

FIG. 19A shows unnormalized and superimposed XRD spectra displayed in cascade in FIGS. 4A-4B for bulk samples of the 3GDC series B solid electrolyte pellet, each exposed to various irradiation doses (0, 500 KGy, 1 MGy).

FIG. 19B shows a magnification of the 13-point averaged background for each sample of FIG. 19A, showing very little change in magnitude and shape.

FIG. 20A shows a Rietveld fitting method for the solid electrolyte sample B series for an unirradiated GDC crystal structure.

FIG. 20B shows a Rietveld fitting method for the solid electrolyte sample B series for an irradiated GDC structure at 500 KGy.

FIG. 20C shows a Rietveld fitting method for the solid electrolyte sample B series for an irradiated GDC structure at 1 MGy.

FIG. 21A shows a normalized and cascaded XRD spectra for bulk samples of the 3GDC solid electrolyte series C, each exposed to various irradiation doses (0 (bottom spectra), 500 KGy (middle spectra), 1 MGy (top spectra)).

FIG. 21B shows an un-normalized magnification of superimposed (111) and (200) peaks from FIG. 21A for all three samples.

FIG. 22A shows an unnormalized and superimposed XRD spectra displayed in cascade in FIGS. 21A and 21B for bulk samples of the 3GDC solid electrolyte (Sample C) each exposed to various irradiation doses (0, 500 KGy, 1 Mgy).

FIG. 22B shows a magnification of the 13-point averaged background for each sample of FIG. 22A, showing very little change in magnitude and shape.

FIG. 23A shows a Rietveld fitting method for the solid electrolyte sample C series for an unirradiated GDC crystal structure.

FIG. 23B shows a Rietveld fitting method for the solid electrolyte sample C series for an irradiated 3GDC structure at 500 KGy.

FIG. 23C shows a Rietveld fitting method for the solid electrolyte sample C series for an irradiated GDC structure at 1 MGy.

FIG. 24A shows a Nyquist plot of the complex impedance response for the 3GDC solid electrolyte pellet measured while supported on a heater stick in the dark, with inset showing the high frequency arc.

FIG. 24B shows a plot of the temperature correspondence between the heater stick thermocouple temperature and the actual sample temperature, as calculated from the high frequency arc and correlated with the furnace measurements.

FIG. 24C shows a plot of the Arrhenius dependence of the conductance as 1/R×T vs. 1/kT for the low frequency arc (grain boundary contribution) for both the furnace and the heater stick measurements.

FIG. 25 shows a high frequency close-up of Nyquist plots of the complex impedance response obtained under open-circuit conditions for the 3GDC solid electrolyte pellet measured at 23.8° C. in the dark and under gamma irradiation (Dark vs Gamma Ray), illustrating how the bulk impedance changes only very slightly under irradiation.

FIG. 26A shows plots of before-during-and-after gamma irradiation impedance cycles measured at 67° C. with the lower plot zoomed in on the high frequency response. The same Gammacell 220 was used to irradiate the sample, however, the irradiation dose was equal to approximately 20 Grey/min.

FIG. 26B shows a plot of three cycles of single-frequency relaxation, captured at 100 mHz, where the total impedance of the system is measured at a single frequency over time as the sample is cycled in and out of the gamma ray irradiator under similar irradiation conditions.

FIG. 27 shows a plot of the Arrhenius dependence of the logarithm of the conductance (1/R)×T vs. 1/k_{B}T corresponding to the high frequency and low-frequency arcs (related to grain and grain boundary (GB) contributions, respectively) obtained in the dark and under irradiation with additional repeat measurements. The repeat GB Dark values down to lower temperatures show that the high temperature extrapolation of the grain boundary resistance down to room temperature is valid, within fitting error. GB and Bulk Gamma ray single frequency results show that the measurements in FIGS. 26A-26B are consistent with the previous measurements displayed in FIGS. 7A-7B.

FIG. 28A shows the predicted mass attenuation coefficient for CeO₂.

FIG. 28B shows the mean penetration depth of High Energy Gamma Rays (0.01-10 MeV).

FIG. 29A shows Nyquist plots of complex impedance response obtained for the 3GDC pellet measured at near room temperature (about 23.8° C.) in the dark and under γ-rays exposure.

FIG. 29B shows a plot of the Arrhenius dependence of the conductance (1/R)×T vs. 1/k_{B}T corresponding to the high frequency and low-frequency arcs (related to grain and grain boundary contributions, respectively) obtained in the dark and under irradiation.

FIG. 30A shows an example of complex impedance plot at 31° C., measured from 1 MHz down to 0.01 Hz, where two semicircles (1 and 2) may be visible depending on the frequency.

FIG. 30B shows a plot of total impedance vs frequency. A plateau exists between 10 Hz and 10 KHz, whose impedance is characteristic of the bulk resistance.

FIG. 31A shows a simulated complex impedance plot at 21° C., from 1 MHz down to 0.001 Hz, where two semicircles (1 and 2) may be visible depending on the frequency, again characteristic of bulk vs grain boundary resistance. Two curves are plotted, one for a dark condition and another for a condition under irradiation where only the grain boundary resistance is modulated.

FIG. 31B shows a plot of total impedance vs. frequency. Only the grain boundary resistance at low frequency decreases under the action of the irradiation.

FIG. 32 shows a schematic diagram of an irradiation detection device including an ion-conducting polycrystalline solid electrolyte in the form of a membrane.

FIG. 33 shows a diagram of an irradiation detection device suitable for simultaneous spectroscopy and dosimetry.

FIG. 34A shows a plot illustrating the operational principle of the exclusively spectroscopic mode based on constant current measurements. The electrolyte channel resistance decreases upon optical illumination absorption, resulting in a decrease in applied voltage.

FIG. 34B shows that the magnitude of the decrease in applied voltage is proportional to the magnitude of the optical illumination absorbed in the device due to the proportional and temporary reduction in space charge potential barriers at the grain boundaries for operation of the irradiation detection device in an exclusive spectroscopic mode.

FIG. 34C shows a plot illustrating that for each detected radiation event, the irradiation detection device records the change in conductivity via a change in voltage, which can then be used to build an energy spectrum for the optical illumination.

FIG. 35A shows a plot illustrating the operational principle of the combined dosimetric and spectroscopic mode based on constant voltage measurements. The electrolyte channel resistance decreases upon absorption of radiation, resulting in an increase of the channel current.

FIG. 35B shows that the increase in channel current is proportional to the magnitude of the optical illumination absorbed in the irradiation detection device due to the proportional and temporary reduction in space charge potential barriers at the grain boundaries.

FIG. 35C shows a plot illustrating that for each radiation event, the amount of ionic charge transferred from one electrode to the other is proportional to the optical illumination dose rate and the overall ionic species transferred between the electrodes will be proportional to the total accumulated optical illumination.

### DETAILED DESCRIPTION

A solid-state sensing mechanism offers access to a broad class of materials that, to date, have not been considered for detecting ionizing radiation (e.g., gamma rays, X rays, neutrons and/or alpha particles). This sensing mechanism differs substantially from traditional electron-conducting semiconductors. Instead of single crystalline materials in which the measured current is electronic, the sensor comprises polycrystalline ion-conducting solid electrolytes for radiation detection. While this choice may seem counterintuitive, considering the large effective masses of ions compared to electrons and the very high concentrations of point defects that could capture photogenerated charges, it is possible to obtain high sensing response with above band gap irradiation. This can be used to design inexpensive, sensitive, robust, and scalable radiation detectors.

Grain boundaries (GBs) can act as barriers to the flow of ions in a variety of ionic conductors, leading at times to increases in ionic resistivity of many of orders of magnitude.

Illuminating a typical polycrystalline oxygen ion conducting solid electrolyte, 3 atm % Gd doped CeO₂ (GDC), with above band gap ultraviolet (UV) illumination, can reduce grain boundary resistance significantly.

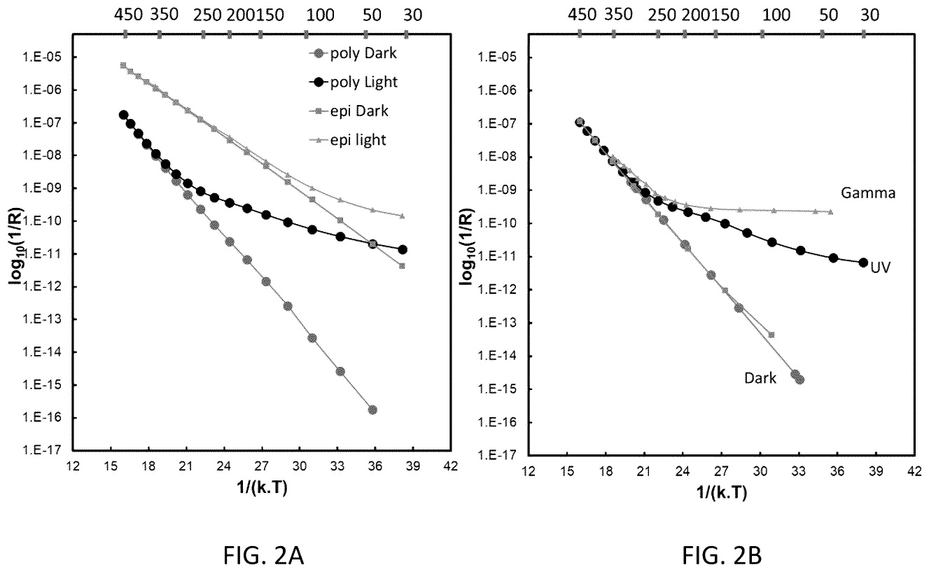

Comparing the resistance change under illumination of an epitaxial and a polycrystalline sample and theoretical considerations shows that the reduced ionic grain boundary resistance results from illumination-induced reductions in space charge barriers at grain boundaries, leading to large enhancements in photoconductance as illustrated in FIGS. 2A and 2B. When comparing a polycrystalline sample with an epitaxial sample, large differences in response at, e.g., 70° C., were observed, with the polycrystalline sample exhibiting a much stronger response (ΔR>10⁴ x) than the epitaxial counterpart (ΔR<100 x) as illustrated in FIG. 2A. This response change increased further as the temperature was moved towards room temperature. The physics of this phenomena may be related to the trapping of photogenerated charge carriers at grain boundaries, effectively modifying the electrostatic potential of the interface and therefore the barrier height needed for the ions to overcome during transport across the grain boundary barrier.

By relying on changes in ionic conductance due to irradiation as the sensing response, instead of changes in electronic conductance, the system may become less dependent on the deleterious impact of point and structural defects on the sensing response. Leveraging the interaction between photogenerated charge carriers and the ionic migration barriers present at grain boundaries yields a sensing response that instead relies on and benefits from structural defects. Owing to the blocking nature of the grain boundaries, a polycrystalline sample's dark resistance can be orders of magnitude higher than the epitaxial (near single crystalline) sample, reaching room temperature values as high as >10¹⁴ ohm, favorable for achieving extremely high sensitivity on the order of ΔR/R about 10¹.

Furthermore, photogenerated electronic charges, which remain as minority defect carriers in the material, need only drift and/or diffuse a short distance (typically sub-micron distances) to reach the grain boundaries where they interact with the migration barriers impeding ionic motion. This enables a very large fraction of photogenerated charge carriers to participate in the sensing response with fast response rates even for moderate electronic mobilities. In that sense, the criteria for developing a strong sensing response differs markedly from traditional semiconductor materials that are engineered to prevent their photogenerated charges from trapping.

In the detector disclosed herein, the trapping process of semiconductors may be utilized. In semiconductors, GBs, which may have excess point defects, may split photogenerated charge carriers. Due to the positive polarity of the space charge field, the negatively charged electrons may end up being trapped at the interface defect states via the Shockley Read recombination mechanism, while the positively charged holes are repelled from the GBs. The trapping process involves charges being split in the space charge zone of the GB where a carrier may become trapped at the GB interface, which may result in lowering the charge of the GB. The lowering in the charge of the GB may modulate the space charge properties and result in a reduction of the space charge potential, which may also lower the barrier to ionic migration. Moreover, the wide band gap of the solid electrolytes and their dopant-controlled majority low-mobility ionic species may ensure an overall ambient high dark resistivity with little impact of thermally generated ionic or electronic charge carriers. Further, their band gap, which lies in the ultraviolet spectrum (UV), also ensures that only wavelengths in the UV or above can be absorbed in the material, thus ensuring high selectivity to ionizing radiation. Further advantages may include the ability to utilize low-cost polycrystalline oxide materials, while exhibiting high stability under both ambient conditions and at elevated temperatures. Additionally, there is no need to maintain high chemical purity, given that these systems are heavily doped on purpose. For example, in the case of Gd substituted into CeO₂, the Gd dopant is typically at levels of several (e.g., about 2 to about 10) up to 20 fraction percent. The chemical and thermal stability of oxide materials, combined with the fact that a response to irradiation up to 400° C. is observed, new opportunities for designing radiation detectors for high temperature, high humidity, and/or corrosive/high pressure environments may be possible.

The response of Gd-doped CeO₂ (GDC) under gamma irradiation was examined using a Cobalt-60 (Co-60) source arranged in caged array. As shown in FIG. 2B, the response, investigated over a broad temperature range, exhibits excellent reversibility as well as a considerably stronger change in resistance under gamma irradiation versus UV illumination. The resistance exhibits little temperature dependence between near ambient temperatures and approximately 250° C. under gamma irradiation, allowing for detector designs that can operate without temperature control. The radiation hardness of the samples was also investigated by exposing specimens to high total gamma irradiation doses (about 1 MGy) continuously over a period of one month and changes in sample dark resistance of less than 10% were found, which may further confirm the overall robustness of the in-situ sensing response.

The physics of the grain boundary resistivity, as they relate to space charge effects, is not unique to the ceria system and has been reported, for example, for many lithium, sodium, and proton solid-state ion conductors. These materials can be used to make radiation sensors with various detection responses and material synthesis costs. Additionally, this may also create opportunities in detecting alternatives radiation sources such as X-rays or neutrons (e.g. with the addition of lithium).

In applications involving γ-rays, oxide ceramics have typically been employed as electrical insulators in core reactor circuits, host matrices for nuclear fuels, or radioactive waste encapsulation, considering their structural and insulating properties. Their refractory nature and chemical inertness allow them to withstand extreme conditions such as high temperature (e.g., about 400° C. to about 500° C.), high humidity (e.g., about >95% relative humidity), and/or chemical environments, such as atmospheres containing high concentrations of Ar, H₂, CO, CO₂ and NOx, while their open and stable crystalline structures lead to enhanced resistance to radiation damage. However, oxide materials have rarely been employed directly as voltage-biased “semiconductor” radiation detectors and have more often been used for their scintillation properties. This originates from their structural and chemical properties (high volumetric mass density, high effective atomic number Z, good optical transparency, adjustable host composition, and flexible doping), enabling rapid electronic charge carrier recombination kinetics and leading to high light output efficiency. While ZnO and or Ga₂O₃ exhibit some of the highest electron mobilities in wide band gap oxide systems, they have poor performance due to short electronic carrier recombination lifetimes.

Considering the high ionic defect concentrations commonly found in metal oxides, typically leading to electronic charge carrier trapping, poor detection performance may be expected in the semiconducting detection mode, where the aim is to efficiently collect generated electron/hole pairs at the outer electrodes. While high ionic defect concentrations are undesirable for electronic semiconducting applications, they may be useful in designing electrochemical-based energy conversion devices that are based on ionic conduction. Such high ionic defect concentrations in oxides may support fast ionic conduction (with ionic contribution to the electrical conductivity on the order of S/m (e.g., 1 S/m to 10⁻¹⁰ S/m bulk conductivity) at the operating temperatures of the devices, comparable to the electrical conductivity of lightly doped semiconductors forming the basis of solid electrolytes vital for applications ranging from batteries, solid oxide fuel cells and electrolyzers, oxygen gas sensors, and permeation membranes. To date, few studies have investigated how irradiation impacts ionic transport in purely ion-conducting solid electrolytes, and when they have been pursued, they have typically been focused on irreversible degradation induced within the oxide structures, rather than as a novel radiation detection mechanism. Given the large effective masses of ions, and exceptionally low carrier mobilities, polycrystalline oxides have, therefore, not been seriously considered as radiation detectors to date.

In contrast, the devices disclosed herein use the modulation of grain boundary space charge barriers by γ-ray irradiation in polycrystalline oxide-based solid electrolytes for direct radiation detection in solid electrolytes by ionic conduction. This provides a way to move away from costly electronically conducting materials and, instead, enables inexpensive, robust, and scalable radiation detectors based on polycrystalline ceramics that can operate under extreme environments, e.g., at high temperatures, humidity, and/or pressures and/or under corrosive environments.

Such detection schemes may have an impact on the development and operation of next-generation nuclear clean energy solutions. This encompasses, for example, deep geothermal directional drilling technologies, where in-situ identification and quantification of radioactive pockets deeper in the earth crust may be essential, and where high temperature, humidity, and/or pressure operation may be desirable. Likewise, the safe development, operation, and management of 3^{rd} and 4^{th} generation nuclear power plants use nuclear detection instrumentation to monitor neutron fluxes that presently utilize bulky, high-voltage boron-lined ionization chambers. The ability to move towards low voltage, miniaturizable solid-state systems that can distinguish between neutrons and gamma rays and operate with high dynamic range, while also being able to sustain harsh environments, may be a component in the design of high-temperature Small Modular Reactors (SMR). Finally, the need for large-area detectors for security and radioactive waste management would further benefit from the ability to scale such detectors into large and inexpensive polycrystalline ceramic panels.

The methods and devices disclosed herein show that γ-ray exposure may modulate the ionic conductivity of a polycrystalline bulk solid electrolyte ceramic. A similar effect in thin film samples of 3 at % Gd doped CeO₂ (3GDC) under UV irradiation has previously been shown. UV radiation occurs near the surface with a penetration depth of approximately 200 nm and thus may require the use of thin films. However, previous studies did not discuss γ-ray exposure. Space-charge barriers that form at grain boundaries in 3GDC may act as barriers to the flow of ions between adjacent grains, leading to many orders of magnitude increases in the overall ionic resistivity. Field-assisted photogenerated charge separation by built-in electric fields within the space charge zone may lead to subsequent trapping of the photogenerated electronic carriers at the grain boundaries. These trapped carriers serve to passivate the grain boundary (GB) core charge, thereby lowering the barriers to the flow of ions. These findings are analogous to reports made for polycrystalline semiconductors such as silicon and the III-V semiconductor compounds such GaAs. Theoretical considerations have also previously described how photogenerated charges screen the space charge potential existing at GBs due to dissimilar trapping of minority and majority charge carriers. However, a difference with the devices disclosed herein is that the majority charge carrier is a mobile ionic defect.

While having demonstrated the opto-ionic concept, the effective penetration depth of UV radiation of about 200 nm limited the studies to thin film geometries. The much larger penetration depths of high-energy ionizing radiation (e.g., from about 20 μm to about 5 cm, for example, in the case of high energy γ-rays), a large and reversible sensing response to ⁶⁰Co γ-Ray (1.1 and 1.3 MeV) in a bulk polycrystalline 3GDC pellet, an oxygen ion conducting solid electrolyte, is demonstrated herein. The penetration depth of the γ-rays may vary based on the type of radiation source and density and atomic number of the material being penetrated. For example, the penetration depth of Americium-241 (Am-241) at 23 keV and 60 keV may range from about 30 μm to about 150 μm, respectively. The penetration depth of Cobalt-60 (Co-60) at 1.1 MeV and 1.3 MeV may range from about 2.3 cm to about 2.7 cm. This measured “radio-ionic effect” under penetrating gamma irradiation may be associated with grain boundary resistance modulation over a broad temperature range of up to 300° C. 3GDC was selected as a model material for the device disclosed herein due to its non-toxicity, chemical inertness, thermal stability, and biocompatibility, making it easier to handle than alternative Cd or Pb based halide material counterparts, which also may be potentially toxic.

Furthermore, the materials disclosed herein may exhibit a high bulk oxygen ionic conductivity. Additionally, 3GDC may have a high grain boundary resistance at lower dopant levels (<5 at %) due to a larger space charge depletion of oxygen vacancies. The detailed physics associated with bulk and grain boundary ionic transport in polycrystalline ionic conductors are discussed below. Additionally, 3GDC's bandgap energy of just over 3 eV, high atomic number (Z) (e.g., about 60) and large bulk ionic migration energy (approximately 0.7 eV) may allow for a very high ambient dark resistance, all the while offering high radiation-stopping power, thereby enabling efficient absorption of radiation.

Structural deformation, amorphization, and different defect states are commonly generated in crystalline detector materials upon exposure to hard radiation leading to potential instabilities. This may lead to leakage charge currents through the formation of defects and subsequent mechanical failure due to induced swelling. In the context of ceramics, for example, reports indicate that this type of damage can strongly depend on the magnitude of the applied voltage in, for example, Al₂O₃, which is commonly used as a barrier coating in nuclear reactor and waste management components. Considering that during radiation detection, only the overall linear ionic resistance of the systems is measured, without trying to capture the photogenerated electronic charge carriers, high bias voltages are not utilized herein. Indeed, large resistance modulations were recorded using a sinusoidal driving voltage of only ±200 mV, leading to electric field strengths<2 V/cm. Furthermore, combined ex-situ long-range XRD and short-range Raman measurements show that the material disclosed herein, intentionally doped with a fixed valent element (i.e., Gd³⁺) to introduce ionic lattice defects and suppress the formation of Ce³⁺, may exhibit a strong resistance to irradiation induced defect formation and good structural stability even under large T-ray doses up to about 1 MGy.

Finally, considering that the GBs in the solid electrolyte film disclosed herein act as virtual electrodes to collect the photogenerated electronic charge carriers on the sub-micron scale, the physics of grain boundary recombination may impact our ionic device responses. Altogether, the device disclosed herein demonstrates the viability of using ion-conducting solid electrolyte materials for radiation detection purposes and lays the groundwork for developing future criteria that can aid in exploring alternative radio-ionic material systems and device design options for gamma radiation detectors.

The irradiation detection devices disclosed herein may include a polycrystalline material. The polycrystalline material may be an oxygen ion (O²⁻) conducting polycrystalline material. Instead of or in addition to an oxygen ion, the polycrystalline material may include one or more of the following ions: Li⁺, OH⁻, Na⁺, Mg²⁺, I⁻, K⁺, F⁻, Br⁻, Ag⁺, Cu⁺, Cl⁻, Al³⁺, H⁺. The polycrystalline materialmay be a cerium (Ce), zirconium (Zr), magnesium (Mg), lithium (Li), sodium (Na), fluorine (F), iodine (I), bromine (Br), silver (Ag), copper (Cu), aluminum (Al), lead (Pb), boron (B), helium (He), cadmium (Cd), gadolinium (Gd), promethium (Pm), samarium (Sm), scandium (Sc), europium (Eu), dysprosium (Dy), indium (In), hafnium (Hf), erbium (Er), bismuth (Bi), barium (Ba), gallium (Ga), or proton containing solid-state polycrystalline compound material. For example, the polycrystalline material may include CeO₂, ZrO₂, LiLaZrO₄, LiLaTiO₃, GaO₃, Bi₂O₃, BaZrO₃, BaCeO₃, a lithium-garnet material (e.g., Li₇La₃Zr₂O₁₂), a sodium super ionic conductor (NASICON) (e.g., Na₁₊ₓZr₂SiₓP₃₋ₓO₁₂, where 0<x<3), a lithium phosphate material (e.g., Li₁₊ₓTi₂₋ₓMₓ(PO₄)₃ (where M=aluminum (Al), Gadolinium (Ga), Indium (In), or Scandium (Sc)), or a lithium sulfide material (e.g., lithium germanium phosphorous sulfide (LGPS)). The proton solid-state polycrystalline material may include a perovskite (CaTiO₃) material, including but not limited, to BaCeO₃ or BaZrO₃.

The polycrystalline material may also be doped with one or more compounds, including but not limited to, boron (B), calcium (Ca), strontium (Sr), samarium (Sm), ytterbium (Yb), yttrium (Y), lanthanum (La), gadolinium (Gd), and/or lutetium (Lu). The doping may range from about 0.5 atm % to about 40 atm %, for example, about 1 atm % to about 20 atm %. For example, the polycrystalline material may be a Gd doped polycrystalline material, including but not limited to 3 atm % Gd doped CeO₂ (3GDC). Alternatively, the polycrystalline material may be Y doped ZrO₂ or Ca doped ZrO₂

The polycrystalline material may have a material density of >80% density and more preferably >90% density. For example, the polycrystalline material may have a material density of about 90% to about 95%, and preferably about 92%. The polycrystalline material may have one or more grain boundaries. The grain boundaries may be positively charged. The polycrystalline material may have positively charged grain boundaries for positively charged ions or defects (e.g., oxygen vacancies, Li interstitials, protons (e.g., OH−, H+), Mg interstitials, sodium interstitials, fluorine vacancies, bromine and iodine vacancies, silver interstitials, copper interstitials, aluminium interstitials, chlorine vacancies). Alternatively, the grain boundaries may be negatively charged. The polycrystalline material may have negatively charged grain boundaries for negatively charged ions or defects (e.g., oxygen interstitials, Li vacancies, Mg vacancies, sodium vacancies, fluorine interstitials, bromine and iodine interstitials, silver vacancies, copper vacancies, aluminium vacancies, chlorine interstitials). The spacing between adjacent grain boundaries in the polycrystalline materialmay range from about 10 nm to about several μm (e.g., about 1 μm to about 10 μm) including all values in between. For example, the grain boundaries in the polycrystalline material may be separated from each other by about 200 nm to about 400 nm. The grain size of the polycrystalline material may be modified via manufacturing through the use of nano powder fabrication, isostatic pressing, and/or rapid sintering, for example.

The polycrystalline material may be used in a variety of irradiation detection devices, including but not limited to, a large panel for use in security, a small, encapsulated cylinder for use in drilling and/or mining, or a thin film substrate for use on chip miniaturized radiation detection schemes. The polycrystalline material may be in the form of a film, a pellet, and/or a plate for use in a variety of irradiation detection devices.

### Example 1: A Solid Electrolyte Film Detector

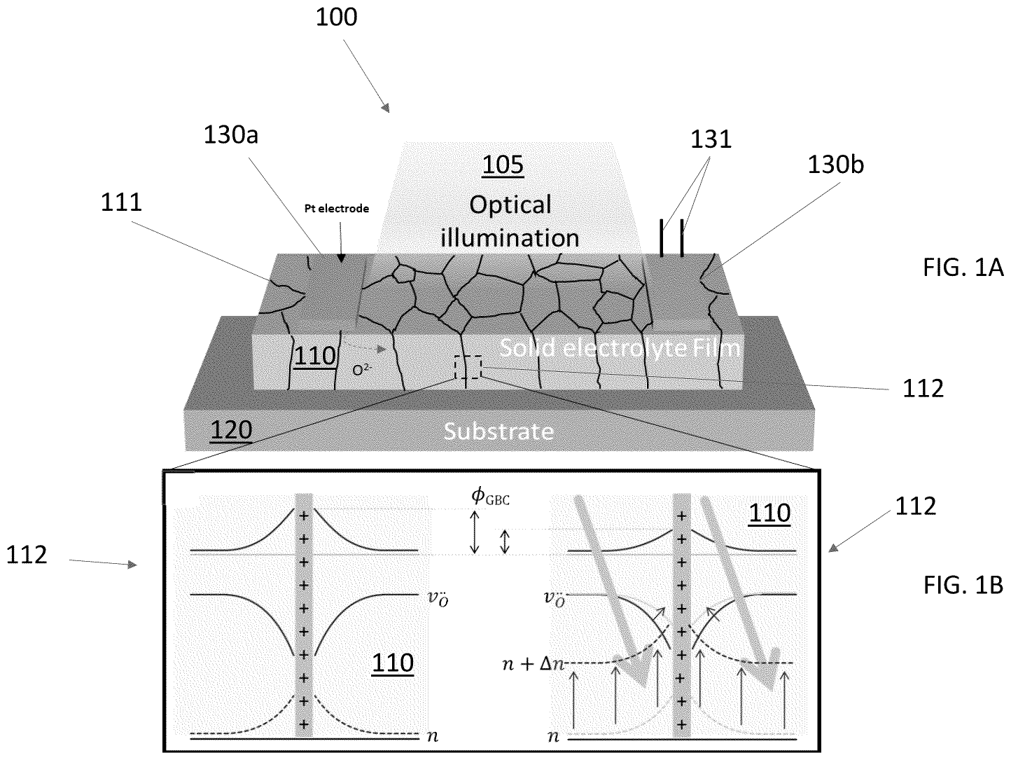

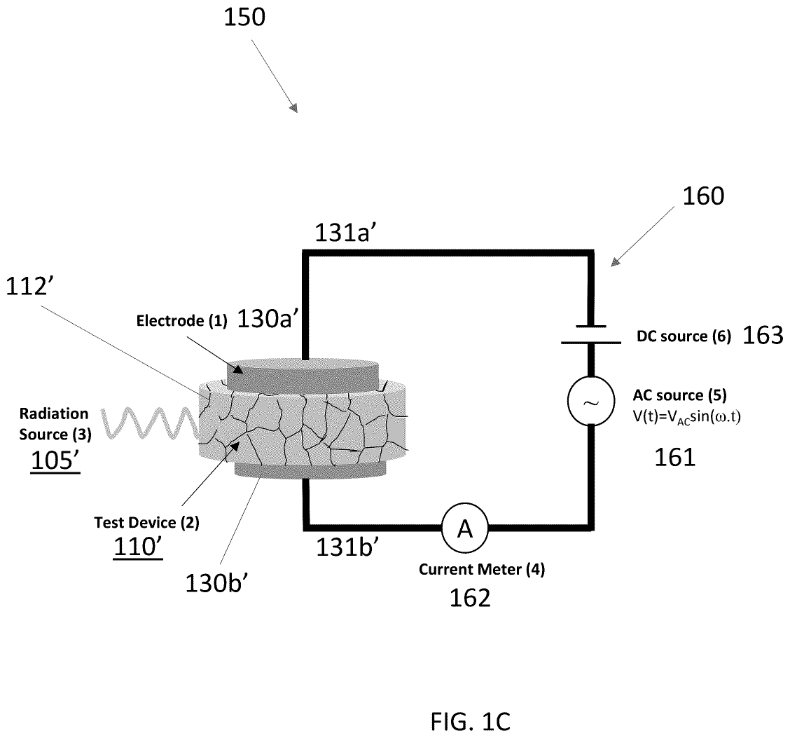

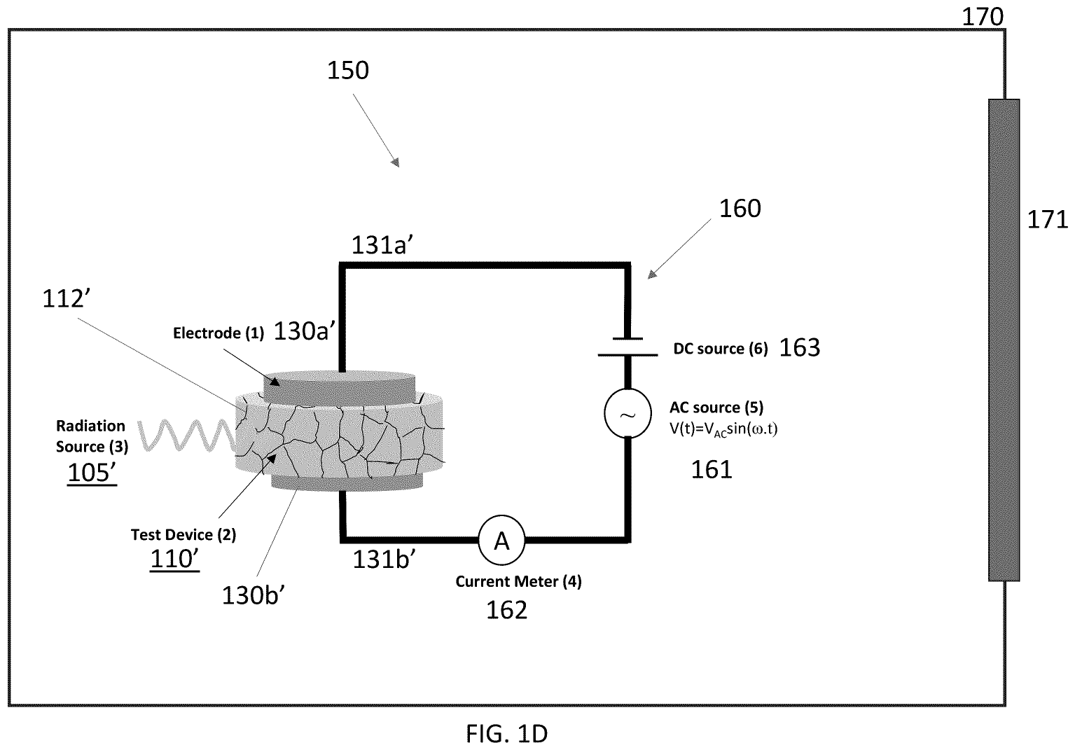

FIG. 1A shows a schematic diagram of an irradiation detection device 100. The irradiation detection device 100 may be used in chip miniaturized radiation detection devices. The chip miniaturized radiation detection device may range in size from about 1 mm×1 mm to about 5 mm×5 mm. The irradiation detection device 100 may include a solid electrolyte film 110 made of the polycrystalline material described above. The solid electrolyte film 110 may be made of any of the polycrystalline materials disclosed herein. In one embodiment, the solid electrolyte film 110 is an oxygen ion solid electrolyte film. For example, the solid electrolyte film 110 may be a CeO₂ solid electrolyte film. The solid electrolyte film 110 may also be doped with any of the materials disclosed herein. In one embodiment, the solid electrolyte film 110 may be a gadolinium (Gd) doped solid electrolyte film. The Gd doping may range from about 0.5 atm % to about 40 atm %, for example, about 1 atm % to about 20 atm %. Preferably, the solid electrolyte film 110 may be a 3 atm % Gd doped CeO₂ (3GDC) solid electrolyte film.

The solid electrolyte film 110 may be prepared as described below in the sample preparation section (e.g., by consolidating a powder through applied pressure and high temperature sintering). Other suitable methods for preparing the solid electrolyte film 110 include, but are not limited to, a traditional ceramic consolidation process (e.g., Pressing (uniaxial, isostatic), slip casting, or extrusion), 3D printing, robocasting, palletization, injection molding, physical vapor deposition (PVD), sputtering, thermal evaporation, pulsed laser deposition, chemical vapor deposition (CVD), atomic layer deposition (ALD), a sol-gel process (e.g., spin coat, dip coat, and/or spray coat), tape casting, slip casting, screen printing, phase inversion, and/or extrusion. The preparation of the solid electrolyte film 110 may also include a heat treatment (e.g., a furnace and/or UV irradiation).

The solid electrolyte film 110 may be approximately <1 μm thick (e.g., about 100 nm to about 900 nm thick) to about tens of μm thick (e.g., about 10 μm to about 100 μm thick). For example, the solid electrolyte film 110 may be about 100 nm, about 200 nm, about 300 nm, about 400 nm, about 500 nm, about 600 nm, about 700 nm, about 800 nm, about 900 nm, about 1 μm, about 10 μm, about 20 μm, about 30 μm, about 40 μm, about 50 μm, about 60 μm, about 70 μm, about 80 μm, about 90 μm or about 100 μm thick, including any values in between. The solid electrolyte film 110 may range in size from about 1 mm×1 mm to about 5 mm×5 mm. For example, the solid electrolyte film 110 may be about 1 mm×1 mm, about 1 mm×2 mm, about 1 mm×3 mm, about 1 mm×4 mm, about 1 mm×5 mm, about 2 mm×2 mm, about 3 mm×3 mm, about 4 mm×4 mm, or about 5 mm×5 mm, including all values in between. The solid electrolyte film 110 may range in diameter from about 1 mm to about 10 mm. For example, the solid electrolyte film 110 may have a diameter of about 1 mm, about 2 mm, about 3 mm, about 4 mm, about 5 mm, about 6 mm, about 7 mm, about 8 mm, about 9 mm, or about 10 mm, including all values in between. The solid electrolyte film 110 may be circular, semi-circular, rectangular, or any other suitable shape.

The solid electrolyte film 110 may have a material density of >80% density and more preferably >90% density. For example, the solid electrolyte film 110 may have a material density of about 90% to about 95%, and preferably about 92%. The solid electrolyte film 110 may have one or more grain boundaries 112 as shown in FIG. 1A. The grain boundaries 112 may be positively charged as shown in FIG. 1B. Alternatively, the grain boundaries may be negatively charged. The spacing between adjacent grain boundaries 112 may range from about 10 nm to about several μm (e.g., about 1 μm to about 10 μm) including all values in between. For example, the grain boundaries 112 may be separated from each other by about 200 nm to about 400 nm.

The irradiation detection device 100 may also include a substrate 120. The solid electrolyte film 110 may be attached to the substrate 120 via chemical or physical vapor deposition, including but not limited to chemical vapor deposition, sputtering, pulsed laser deposition, or molecular-beam epitaxy deposition. The substrate 120 may support the growth of the solid electrolyte film 110. The substrate 120 may be attached to the underside of the solid electrolyte film 110. The substrate 120 may be made of any electrically insulating material so as not to partially short out current flowing through the solid electrolyte film 110. For example, the substrate 120 may include a MgO, Al₂O₃, or SiO₂ substrate.

The irradiation detection device 100 may also include one or more electrodes 130. The electrodes 130 may be made of any metallic material that may conduct electrons at a conductivity of about >10⁻³S/cm and/or any metallic material that may conduct ions at a conductivity of about 10⁻⁵S/cm. For example, the electrodes 130 may be platinum (Pt), a platinum alloy, gold, or stainless-steel electrodes. The platinum alloy may include but is not limited to a PtNi alloy (e.g., Pt₄₀Ni₆₀, Pt₅₀Ni₅₀, and/or Pt₇₅Ni₂₅), a PtFe alloy (e.g., Pt₃Fe), a PtCo alloys (e.g., Pt₃Co and/or PtCo), and/or a PtCu alloys (e.g., Pt_{0.5}Cu_{0.5}). Alternatively, the electrodes 130 may be made of a highly electronically conducting metallic oxide (e.g., indium tin oxide (ITO)) and/or mixed ionic-electronic conducting metallic oxide (e.g., lanthanum strontium cobalt iron oxide (LSCF)). Alternatively, the electrodes may be made of graphite, lithium, lithium cobalt oxide (LiCoO₂), lithium manganese oxide (LiMn₂O₄), lithium iron phosphate (LiFePO₄), nickel manganese cobalt oxide (NMC), lithium nickel manganese cobalt oxide (LiNiₓMn_{y}Co_{z}O₂), lithium nickel cobalt aluminum oxide (LiNiCoAlO₂ or NCA), lithium titanate (Li₄Ti₅O₁₂), La_{0.6}Sr_{0.4}FeO_{3-δ} (LSF), La_{0.5}Sr_{0.5}Cr_{0.2}Mn_{0.8}O_{3-δ} (LSCrMn), La_{0.9}Sr_{0.1}CoO_{3-δ} (LSC), Ba_{0.5}Sr_{0.5}Co_{0.8}Fe_{0.2}O_{3-δ} (BSCF), La_{0.8}Sr_{0.2}MnO₃ (LSM), Sm_{0.5}Sr_{0.5}CoO_{3-δ} (SSC), La_{0.5}Sr_{0.5}MnO_{3-δ} (LSM), LSM with Sc doping, La_{0.8}Sr_{0.2}Sc_{0.5}Fe_{0.5}O_{3-δ} (LSSF), BaCe_{0.26}Ni_{0.1}Fe_{0.64}O_{3-δ} (BCNF10), BaCo_{0.4}Fe_{0.4}Zr_{0.1}Y_{0.1}O_{3-δ} (BCFZY_{0.1}), BaCe_{0.26}Ni_{0.1}Fe_{0.64}O_{3-δ} (BCNF10), NdBa_{0.5}Sr_{0.5}Co_{1.5}Fe_{0.5}O_{5+δ} (NBSCF), BaPr_{0.8}In_{0.2}O_{3-δ} (BPI), palladium (Pd), a palladium alloy (e.g., PdAg and/or PdCu), NaₓCoO₂, Na₃V₂(PO₄)₃, NaₓMnO₂, NaₓTiO₂, Na₂Ti₃O₇), K_{0.3}MnO₂, K_{0.55}CoO₂, KₓFe₂(CN)₆, K₂Fe₄(CN)₆, K₂Mn[Fe(CN)₆], KₓMnO₂, CuBr, AgBr, PbBr₂, CuBr₂, CsPbBr₃, CuI, AgI, PbI2, BiI3, and/or SnI₄. Preferably, the electrodes 130 are Pt electrodes. The electrodes 130 may be attached to the top surface 111 of the solid electrolyte film 110. Preferably the irradiation detection device 100 includes two electrodes 130. In this embodiment, a first electrode 130a may be a working electrode and the second electrode 130b may be a counter electrode. In another embodiment, the first electrode 130a may be a cathode and the second electrode 130b may be an anode. For example, at least two electrodes 130 may be attached to either side of the solid electrolyte film 110. The electrodes 130 may be interdigitated electrodes (e.g., with interwoven fingers to increase the electrode 130 surface area) or planar electrodes. Each electrode 130 may be approximately 100 nm thick. The electrodes 130a and 130b may be the same size (e.g., length, width, or diameter) as the solid electrolyte film 110. The electrodes 130a and 130b may be spaced about 1 μm apart to about >100 μm apart (e.g., about 100 μm to about 900 μm). If the electrodes 130a and 130b are interdigitated electrodes, the spacing between the digits may range from about 1 μm to about >100 μm (e.g., about 100 μm to about 900 μm). For example, the spacing between the digits of the interdigitated electrodes may be about 1 μm, about 10 μm, about 20 μm, about 30 μm, about 50 μm, about 60 μm, about 70 μm, about 80 μm, about 90 μm, about 100 μm, about 200 μm, about 300 μm, about 400 μm, about 500 μm, about 600 μm, about 700 μm, about 800 μm, or about 900 μm, including all values in between. The electrodes 130 may be oval, circular, square, or rectangular in shape. For example, each electrode 130 may be a rectangle covering an area of about 5 mm×1 mm on the surface 111 of the solid electrolyte film 110. The electrodes 130 may be deposited on the solid electrolyte film 110 via sputtering. The electrodes 130 may be attached to one or more wires 131 using a silver paste. The wires 131 may be made of any high melting point metal that exhibits corrosion resistance. For example, the wires 131 may be platinum, gold, and/or stainless-steel wires. The electrodes 130 may be used to apply a voltage to the solid electrolyte film 110. The irradiation detection device 100 may also include a thermocouple to measure the temperature of the solid electrolyte film 110.

The irradiation detection device 100 may be used to detect optical illumination 105 or other radiation, including gamma irradiation and/or UV radiation.

### Example 2: A Solid Electrolyte Pellet/Plate Detector

FIG. 1C shows a schematic diagram of another embodiment of an irradiation detection device 150. The irradiation detection device 150 may be used in a variety of formats. For example, the irradiation detection device 150 may be in the form of a large panel or plate for use in security. The large panel device may range in size from about 2 mm×2 mm to about 1 m×1 m. Alternatively, the irradiation detection device 150 may be in the form of a small, encapsulated cylinder for use in drilling and/or mining. The small, encapsulated cylinder device may range in size from about 2 mm in diameter to about 10 mm in diameter and from about 1 cm long to about 5 cm long.

The irradiation detection device 150 may include a solid electrolyte plate or pellet 110′ made of the polycrystalline material described above. The solid electrolyte pellet 110′ may be made of any of the polycrystalline materials disclosed herein. In one embodiment, solid electrolyte pellet 110′ is an oxygen ion solid electrolyte pellet. For example, the solid electrolyte pellet 110′ may be a CeO₂-based solid electrolyte pellet. The solid electrolyte pellet 110′ may also be doped with any of the materials disclosed herein. In one embodiment, the solid electrolyte pellet 110′ may be a gadolinium (Gd) doped solid electrolyte pellet. The Gd doping may range from about 0.5 atm % to about 40 atm %, for example, about 1 atm % to about 20 atm %. Preferably, the solid electrolyte pellet 110′ may be a 3 atm % Gd doped CeO₂ (3GDC) solid electrolyte pellet.

The solid electrolyte pellet 110′ may be prepared as described below in the sample preparation section (e.g., by consolidating a powder through applied pressure and high temperature sintering). Other suitable methods for preparing the solid electrolyte pellet 110′ include, but are not limited to, a traditional ceramic consolidation process (e.g., Pressing (uniaxial, isostatic), slip casting, or extrusion), 3D printing, robocasting, palletization, injection molding, physical vapor deposition (PVD), sputtering, thermal evaporation, pulsed laser deposition, chemical vapor deposition (CVD), atomic layer deposition (ALD), a sol-gel process (e.g., spin coat, dip coat, and/or spray coat), tape casting, slip casting, screen printing, phase inversion, and/or extrusion. The preparation of the solid electrolyte pellet 110′ may also include a heat treatment (e.g., a furnace and/or UV irradiation).

The solid electrolyte pellet 110′ may be approximately 100 μm thick to about 100 mm thick, preferably about 500 μm thick to about 10 mm thick. The thickness of the solid electrolyte pellet 110′ may vary depending on the type of polycrystalline material and/or the type of irradiation to be detected. For example, the solid electrolyte pellet 110′ may be about 100 μm, about 200 μm, about 300 μm, about 400 μm, about 500 μm, about 600 μm, about 700 μm, about 800 μm, about 900 μm, about 1 mm, about 10 mm, about 20 mm, about 30 mm, about 40 mm, about 50 mm, about 60 mm, about 70 mm, about 80 mm, about 90 mm, or about 100 mm thick, including all values in between. The solid electrolyte pellet 110′ may range in size depending on the type of detector. The solid electrolyte pellet 110′ may be circular, semi-circular, rectangular, square, or any other suitable shape. The solid electrolyte pellet 110′ may range from about 2 mm in diameter to about 10 mm in diameter. For example, the solid electrolyte pellet 110′ may have a diameter of about 2 mm, about 3 mm, about 4 mm, about 5 mm, about 6 mm, about 7 mm, about 8 mm, about 9 mm, or about 10 mm, including all values in between. Alternatively, the solid electrolyte pellet 110′ may range from about 1 cm long to about 5 cm long. For example, the solid electrolyte pellet 110′ may be about 1 cm long, about 2 cm long, about 3 cm long, about 4 cm long, or about 5 cm long, including all values in between. In another embodiment, the solid electrolyte pellet 110′ may range in size from about 2 mm×2 mm to about 1 m×1 m. For example, the solid electrolyte pellet 110′ may be about 2 mm×2 mm, about 2 mm×5 mm, about 5 mm×9 mm, about 2 mm×10 mm, about 5 mm×5 mm, about 5 mm×10 mm, about 5 mm×20 mm, about 5 mm×30 mm, about 5 mm×50 mm, about 5 mm×60 mm, about 5 mm×70 mm, about 5 mm×80 mm, about 5 mm×90 mm, about 5 mm×100 mm, about 10 mm×10 mm, about 20 mm×20 mm, about 30 mm×30 mm, about 40 mm×40 mm, about 50 mm×50 mm, about 50 mm×100 mm, about 60 mm×60 mm, about 70 mm×70 mm, about 80 mm×80 mm, about 90 mm×90 mm, about 100 mm×100 mm, 100 mm×1 m, about 200 mm×200 mm, 200 mm×1 m, about 300 mm×300 mm, 300 mm×1 m, about 400 mm×400 mm, 400 mm×1 m, about 500 mm×500 mm, 500 mm×1 m, about 600 mm×600 mm, 600 mm×1 m, about 700 mm×700 mm, 700 mm×1 m, about 800 mm×800 mm, 800 mm×1 m, about 900 mm×900 mm, 900 mm×1 m, or about 1 m×1 m, including all values in between.

The solid electrolyte pellet 110′ may have a material density of >80% density and more preferably >90% density. For example, the solid electrolyte pellet 110′ may have a material density of about 90% to about 95%, and preferably about 92%. The solid electrolyte pellet 110′ may have one or more grain boundaries 112′ as shown in FIG. 1C. The grain boundaries 112′ may be positively charged. Alternatively, the grain boundaries may be negatively charged. The spacing between adjacent grain boundaries 112′ may range from about 10 nm to about several μm (e.g., about 1 μm to about 10 μm) including all values in between. For example, the grain boundaries 112′ may be separated from each other by about 200 nm to about 400 nm.

The irradiation detection device 150 may also include one or more electrodes 130′ as described above. The electrode 130′ may be made of any suitable metallic material that can be used to collect current and apply a voltage to the solid electrolyte pellet 110′. For example, the electrodes 130′ may be made of any metallic material that may conduct electrons at a conductivity of about >10⁻³S/cm and/or any metallic material that may conduct ions at a conductivity of about 10⁻⁵S/cm. For example, the electrode 130′ may be platinum (Pt), a platinum alloy, gold, or stainless-steel electrodes. The platinum alloy may include but is not limited to a PtNi alloy (e.g., Pt₄₀Ni₆₀, Pt₅₀Ni₅₀, and/or Pt₇₅Ni₂₅), a PtFe alloy (e.g., Pt₃Fe), a PtCo alloys (e.g., Pt₃Co and/or PtCo), and/or a PtCu alloys (e.g., Pt_{0.5}Cu_{0.5}). Alternatively, the electrodes 130′ may be made of a highly electronically conducting metallic oxide (e.g., indium tin oxide (ITO)) and/or mixed ionic-electronic conducting metallic oxide (e.g., lanthanum strontium cobalt iron oxide (LSCF). Alternatively, the electrodes may be made of graphite, lithium, lithium cobalt oxide (LiCoO₂), lithium manganese oxide (LiMn₂O₄), lithium iron phosphate (LiFePO₄), nickel manganese cobalt oxide (NMC), lithium nickel manganese cobalt oxide (LiNiₓMn_{y}Co_{z}O₂), lithium nickel cobalt aluminum oxide (LiNiCoAlO₂ or NCA), lithium titanate (Li₄Ti₅O₁₂), La_{0.6}Sr_{0.4}FeO_{3-δ} (LSF), La_{0.5}Sr_{0.5}Cr_{0.2}Mn_{0.5}O_{3-δ} (LSCrMn), La_{0.9}Sr_{0.1}CoO_{3-δ} (LSC), Ba_{0.5}Sr_{0.5}Co_{0.8}Fe_{0.2}O_{3-δ} (BSCF), La_{0.8}Sr_{0.2}MnO₃ (LSM), Sm_{0.5}Sr_{0.5}CoO_{3-δ} (SSC), La_{0.5}Sr_{0.5}MnO_{3-δ} (LSM), LSM with Sc doping, La_{0.8}Sr_{0.2}Sc_{0.5}Fe_{0.5}O_{3-δ} (LSSF), BaCe_{0.26}Ni_{0.1}Fe_{0.64}O_{3-δ} (BCNF10), BaCo_{0.4}Fe_{0.4}Zr_{0.1}Y_{0.1}O_{3-δ} (BCFZY_{0.1}), BaCe_{0.26}Ni_{0.1}Fe_{0.64}O_{3-δ} (BCNF10), NdBa_{0.5}Sr_{0.5}Co_{1.5}Fe_{0.5}O_{5+δ} (NBSCF), BaPr_{0.8}In_{0.2}O_{3-δ} (BPI), palladium (Pd), a palladium alloy (e.g., PdAg and/or PdCu), NaₓCoO₂, Na₃V₂(PO₄)₃, NaₓMnO₂, NaₓTiO₂, Na₂Ti₃O₇), K_{0.3}MnO₂, K_{0.55}CoO₂, KₓFe₂(CN)₆, K₂Fe₄(CN)₆, K₂Mn[Fe(CN)₆], KₓMnO₂, CuBr, AgBr, PbBr₂, CuBr₂, CsPbBr₃, CuI, AgI, PbI2, BiI3, and/or SnI₄. Preferably, the electrodes 130′ are Pt electrodes.

In one embodiment, the irradiation detection device 150 may have two electrodes 130a′ and 130b′. In this embodiment, the first electrode 130a′ may be a working electrode and the second electrode 130b′ may be a counter electrode. In another embodiment, the first electrode 130a′ may be a cathode and the second electrode 130b′ may be an anode. Electrodes 130a′ and may be placed on either side of the solid electrolyte pellet 110′ (e.g., sandwiching the solid electrolyte pellet 110′) as shown in FIG. 1C. In this embodiment, the electrodes 130a′ and 130b′ may be spaced approximately 100 μm apart to about 1 cm apart depending on the thickness of the solid electrolyte pellet 110′. For example, the electrodes 130a′ and 130b′ may be spaced about 100 μm, about 200 μm, about 300 μm, about 400 μm, about 500 μm, about 600 μm, about 700 μm, about 800 μm, about 900 μm, about 1 mm, about 10 mm, about 20 mm, about 30 mm, about 40 mm, about 50 mm, about 60 mm, about 70 mm, about 80 mm, about 90 mm, or about 1 cm apart, including all values in between.

The electrodes 130 may be interdigitated electrodes (e.g., with interwoven fingers to increase the electrode 130 surface area) or planar electrodes. The spacing between the digits of the interdigitated electrodes may be about 1 μm, about 10 μm, about 20 μm, about 30 μm, about 50 μm, about 60 μm, about 70 μm, about 80 μm, about 90 μm, about 100 μm, about 200 μm, about 300 μm, about 400 μm, about 500 μm, about 600 μm, about 700 μm, about 800 μm, or about 900 μm, including all values in between. The electrodes 130a′ and 130b′ may be oval, circular, square, or rectangular in shape. The electrodes 130a′ and 130b′ may be deposited on the solid electrolyte pellet 110′ via sputtering or by painting on an appropriate electrode ink. The electrodes 130a′ and 130b′ may be used to apply a voltage to the solid electrolyte pellet 110′. The electrodes 130a′ and 130b′ may be approximately 100 nm thick. The electrodes 130a′ and 130b′ may be the same size (e.g., length, width, or diameter) as the solid electrolyte pellet 110′.

The detection device 150 may also include a circuit 160. The circuit 160 may include AC source 161. The AC source 161 may be used to operate the detection device 150 and measure the impedance of the detection device 150. The impedance of the detection device 150 may be measured by applying an AC source 161 with varying frequency (o) and locking in on the output current to measure amplitude and phase. The current applied by the AC source 161 may range from about 10 mV to about 100 V, including all values in between. For example, the current applied by the AC source 161 may range from about 10 mV to about 10 V, or about 50 mV to about 500 mV. The circuit 160 may also include a current meter 162. The current meter 162 may measure the current running through the detection device 150 under the applied AC source 161. The AC source 161 and the current meter 162 may be connected to the electrodes 130a′ and 130b′ through one or more wires 131a′ and 131b′ forming the circuit 160 as shown in FIG. 1C. The wires 131a′ and 131b′ may be platinum wires. The wires 131a′ and 131b′ may be attached to the electrodes 130a′ and 130b′ using a silver paste as described above. The circuit 160 may also include a DC source 163. The DC source 163 may be used to apply a DC overpotential to the circuit 160. The overpotential may range from about 0 V to about 10 V. When the circuit 160 includes the DC source 163, the current meter 162 may also measure any DC overpotential induced current by the DC source 163. The irradiation detection device 150 may also include a thermocouple to measure the temperature of the solid electrolyte pellet 110′.

A 1-inch diameter by 800-micron thick pellet of the 3GDC solid electrolyte pellet 110′ (sample A) as shown in FIG. 1C was fabricated according to the procedures outlined below. To maintain a relatively large grain boundary 112′ density, the sintering temperature was limited to 1300° C. for 8 hours, yielding a relative theoretical density of about 92% and an average grain size of approximately 400 nm (the SEM, XRD and Raman and SEM of the as-prepared solid electrolyte pellet 110′ sample A are disclosed below). The solid electrolyte pellet 110′ of sample A was cut in two so that one half was used in the in-situ radiation conductivity studies, while the other half was used for chemical and structural analysis. Ex-situ long-range and short-range structural measurements (XRD and Raman) confirm the overall structural and chemical stability of the 3GDC solid electrolyte pellet 110′ specimens under T-ray exposure.

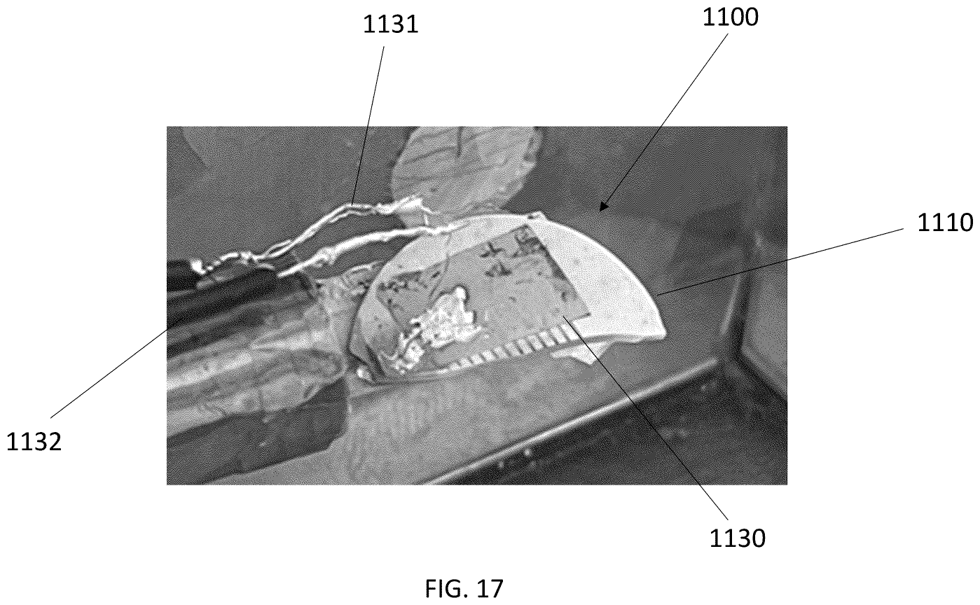

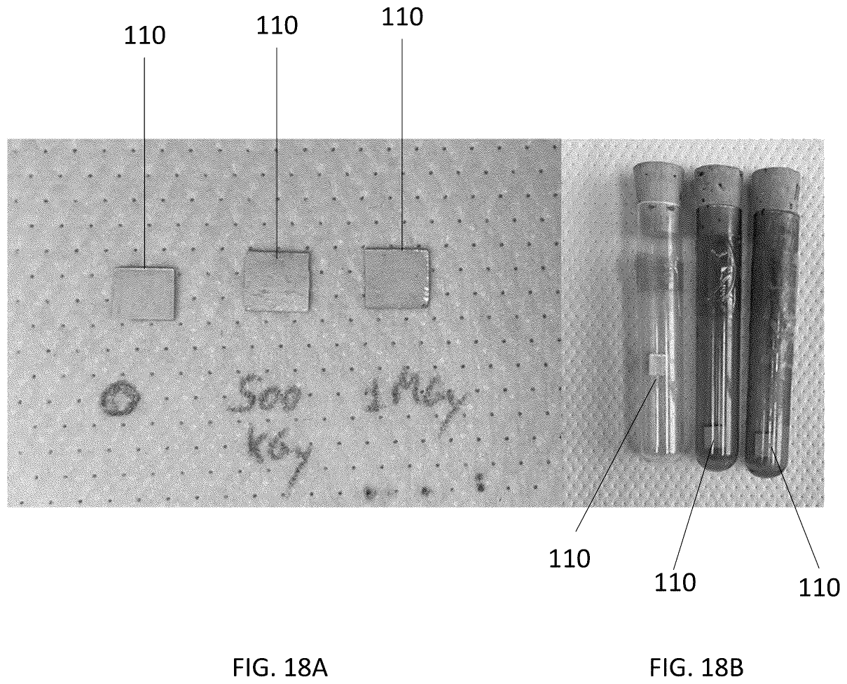

To further demonstrate the stability of the solid electrolyte pellet 110′ under high irradiation dose, two additional pellets of the 3GDC solid electrolyte pellet 110′ (samples B and C) were prepared. Solid electrolyte pellet 110′ samples B and C were sintered as bars and cut into three identically shaped pieces with cross-sections of about 5 mm×5 mm as shown in FIG. 18A. One piece of each sample was kept as a reference for measuring the sample's “non-irradiated” condition, while the other pieces were placed inside glass test tubes sealed with a cork and exposed to 500 kGy and 1MGy doses, respectively, as shown in FIG. 18B. This was achieved by placing them in a Gammacell 220 irradiator at room temperature for durations of 15 and 30 days respectively. After exposure, all samples were collected and their XRD and Raman spectra were measured. Images of all samples, and details of their geometries, are provided in FIGS. 17 and 18A-18B and in Table 2.

In operation, the detection device 150 (and the detection device 100) may be used to detect irradiation, such as gamma irradiation. The detection device 150 may be operated by the AC source 161 and the current running through the detection device 150 may be measured using the current meter 162. When the detection device 150 is exposed to optical illumination 105′ (e.g., gamma irradiation) the detection device 150 may experience a change in ionic conductivity. The optical illumination 105′ may cause ions in the solid electrolyte pellet 110′ to migrate across the grain boundaries 112′. This migration across the grain boundaries 112′ may result in a change in ionic conductivity of the solid electrolyte pellet 110′ and thus a change in the current flowing through the circuit 160. The change in ionic conductivity of the solid electrolyte pellet 110′ may then be measured by the circuit 160 using AC impedance measurements in which the ratio of the amplitudes of the respective voltage and current signals and the phase shift between them are examined. Thus, the ionic conductivity of the solid electrolyte pellet 110′ may be measured using the electrodes 130a′ and 130b′. Alternatively, the ionic conductivity of the solid electrolyte pellet 110′ may also be measured using a DC voltage and ionically reversible electrodes.

As illustrated in FIG. 1D, the detection device 150 may be housed in a chamber 170 in which the temperature of the detection device 150 can be controlled. The chamber 170 may also control the atmosphere surrounding the detection device 150. One or more windows 171 can be inserted into the chamber 170 that may minimize the absorption of incident radiation.

After exposure to optical illumination 105′, the detection device 150 (or the detection device 100) may fully relax back to its pre-irradiated state following removal of the optical illumination 105′. The change in ionic conductivity of the solid electrolyte pellet 110′ may be fully reversible. During relaxation, the ions in the solid electrolyte pellet 110′ will migrate away from the grain boundaries 112′ and the ionic conductivity of the solid electrolyte pellet 110′ may return to normal. The relaxation time may range from milliseconds to seconds depending on the temperature. For example, the relaxation time may be approximately 1 millisecond to approximately 10 seconds, including all values in between. The relaxation time of the solid electrolyte pellet 110′ may also vary based on the composition of the solid electrolyte pellet 110′.

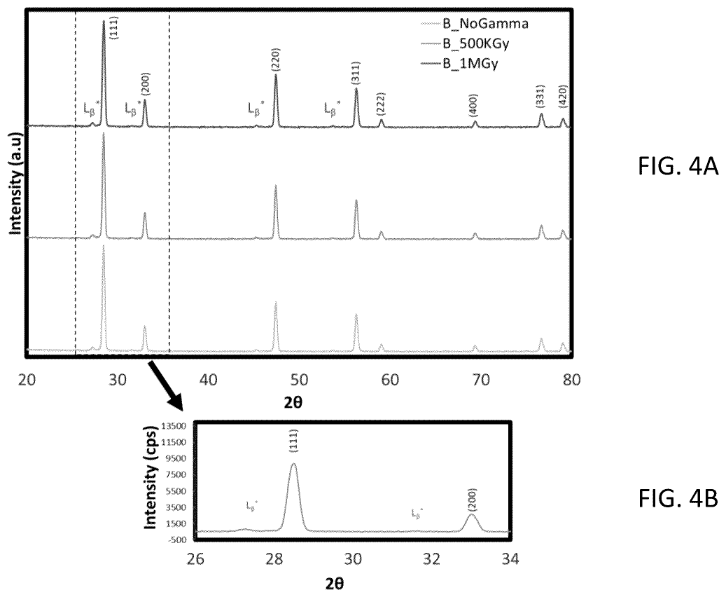

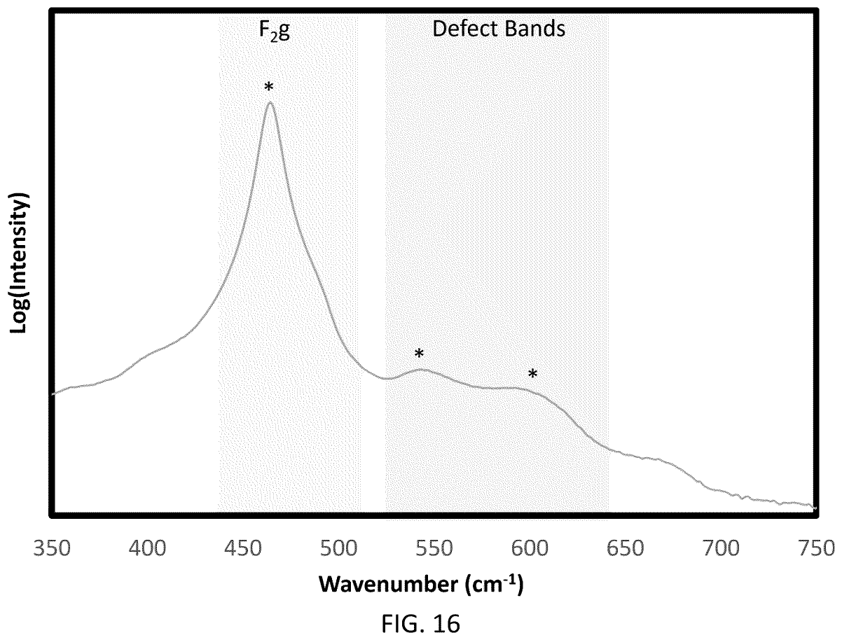

In FIGS. 4A-4B the XRD results for one of the two bulk solid electrolyte pellet 110′ specimens (sample B) for the various irradiation doses (no exposure, 500 kGy, 1 MGy) are displayed. FIG. 4A illustrates that the same peaks are present for all three samples, similar to the solid electrolyte pellet 110′ (e.g., the pristine sample or Sample A) (displayed in FIG. 16), at the same positions, demonstrating good phase purity of the face-centered cubic structure of CeO₂. The results of the Rietveld fits for both solid electrolyte pellet 110′ samples B and C are also disclosed below and show good agreement with GDC reference patterns and consistent agreements with each other when comparing spectra obtained for the various irradiation doses. Table 1 below summarizes the lattice constant, lattice volume, March/Dollase, and atomic site occupancies obtained from the fits for the solid electrolyte film 110 pristine in-situ sample and solid electrolyte pellet 110′ sample B (results are also disclosed below for samples from series C in Table 2).

TABLE 1
Structural parameters for the pristine in-situ sample
and GDC solid electrolyte pellet 110′ sample
B series for various γ irradiation conditions.

| | Pristine in- | | | |
|---|---|---|---|---|
| | situ sample | | | |
| Parameters | (Sample A) | 0 kGy | 500 kGy | 1000 kGy |
| Lattice Constants | 5.412 | 5.412 | 5.412 | 5.412 |
| Å, a = b = c | | | | |
| Volume | 158.516 | 158.516 | 158.516 | 158.516 |
| (Å)³ | | | | |
| March/Dollase | 0.89 | 0.81 | 0.85 | 0.84 |
| (Preferred orientation) | | | | |

Occupancy

| | | | | |
|---|---|---|---|---|
| Ce | 0.970 | 0.970 | 0.972 | 0.970 |
| Gd | 0.0299 | 0.0300 | 0.0285 | 0.0299 |

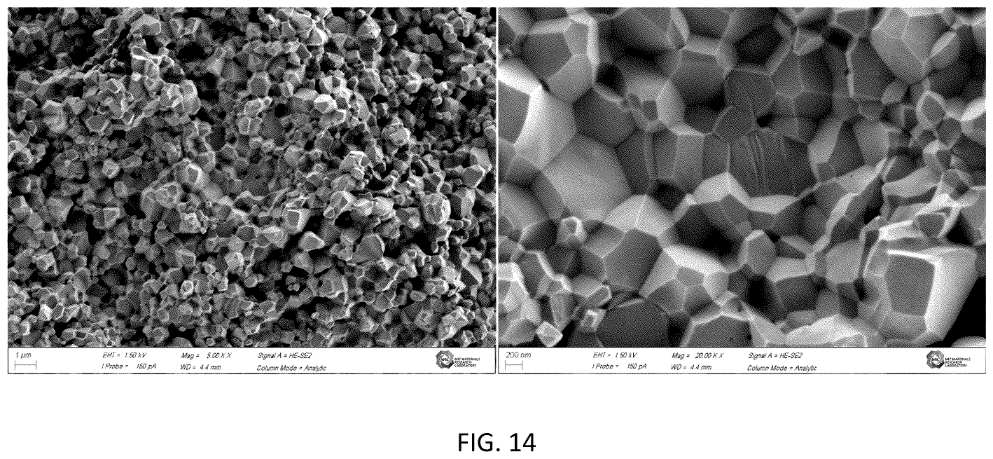

The solid electrolyte pellet 110′ samples exhibit a slightly preferred crystal orientation (texture), with a March/Dollase factor<1 indicative of plate-like morphologies. This orientation was found in all three sets of solid electrolyte pellet 110′ samples (pristine in-situ sample, B and C). Moreover, FIG. 14 reveals no visible orientation indications for these microstructures for the pristine in-situ sample. GDC sintered by conventional means are known to show a (111) over (200) orientation preference, indicating this may be an artifact of the powder preparation introduced due to preferential alignment during uniaxial pressing.

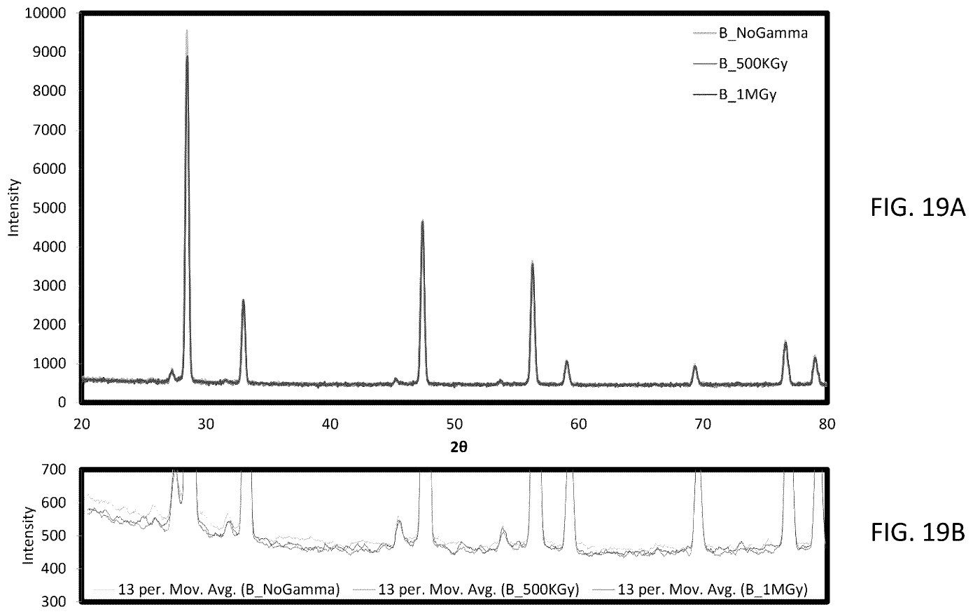

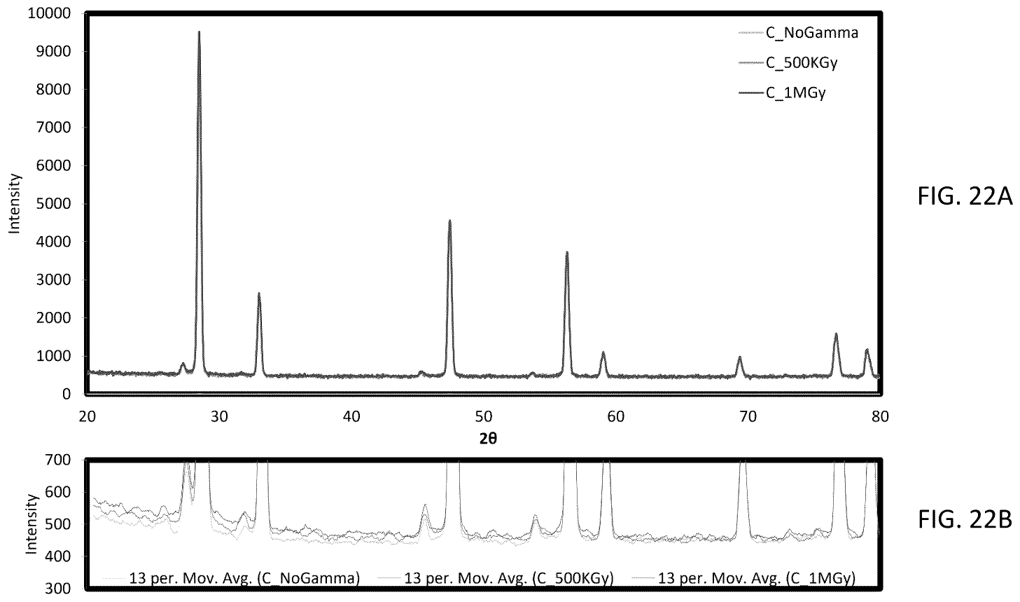

In FIG. 4B the magnification of superimposed (111) and (200) peaks for all three solid electrolyte pellet 110′ samples demonstrates that the peaks perfectly overlap, both in position and width. In FIGS. 19A-19B and 22A-22B an unnormalized data set for the solid electrolyte film 110 samples from series B and C, with a magnification of the background for all three samples is provided. These observations support the conclusion that no measurable structural degradation was induced during irradiation (i.e., amorphization, changes related to strain, or changes in grain size or orientation). Raman spectroscopy, which can probe the symmetric breathing mode of the oxygen octahedra surrounding the host Ce cation, can be used to identify changes in the occupancy of the oxygen sublattice, which is associated with changes in the oxidation state of the Ce ion.

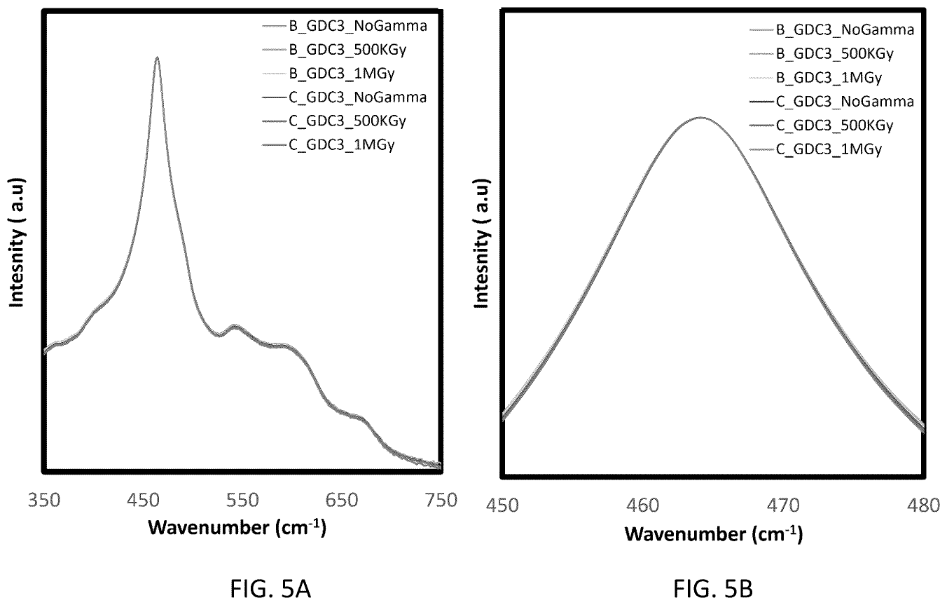

FIGS. 5A and 5B display the Raman spectra for the additional 3GDC solid electrolyte pellet 110′ samples that were prepared and exposed analogous to the XRD section to various radiation doses (no exposure, 500 kGy, 1 MGy). Compared to the Raman spectrum of the sample presented in FIG. 16, the same Raman features are present: F_{2g} (464.61 cm⁻¹), 550 cm⁻¹, and 600 cm⁻¹, confirming the similarities in sample chemistry. The exposure to γ-rays had no visible impact on any of these bands, with no evidence for the appearance of secondary phases. A closer zoom-in on the F_{2g} peak in FIG. 5B reveals no apparent peak shift in the F_{2g} (464.61 cm⁻¹) vibrational mode, consistent with no change in the oxidation state of Ce under irradiation. A secondary finding is that the oxygen non-stoichiometry and defect-related Raman modes show no indication of any alterations upon exposure to γ-rays within error, these modes being very sensitive to changes in intrinsic or extrinsic defects.

These observations suggest that gamma irradiation at room temperature has no apparent long-term impact on the chemistry or structure of the solid electrolyte pellet 110′ material, especially as they relate to changes in defect concentration, grain size, crystallinity degree, or local lattice microstrain due to changes in cation oxidation state. While some reduction of Ce⁴⁺ to Ce³⁺ may occur during irradiation, this is not demonstrated in the Raman studies, meaning the sample would have had to reoxidize rather rapidly upon removal from the irradiator, even at room temperature. Thus, 3 at % Gd doped CeO₂ may demonstrate an opto-ionic effect and may also be a candidate for gamma-ray driven radio-ionic effect and radiation detectors, given its stability and ease of handling for sensing device architectures.

### Electrical Characterization

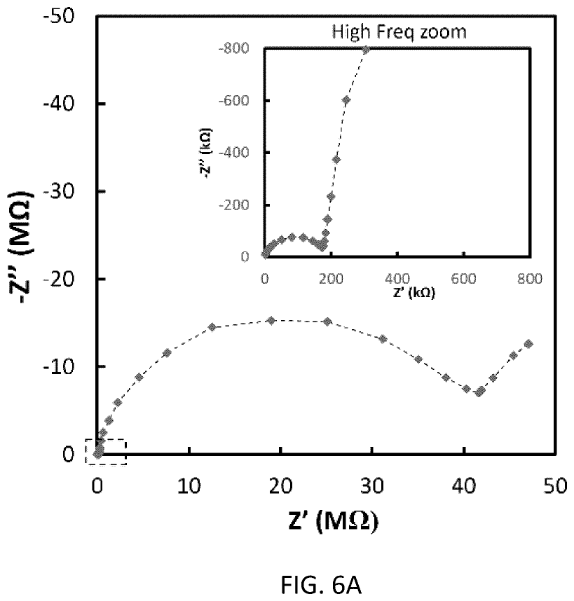

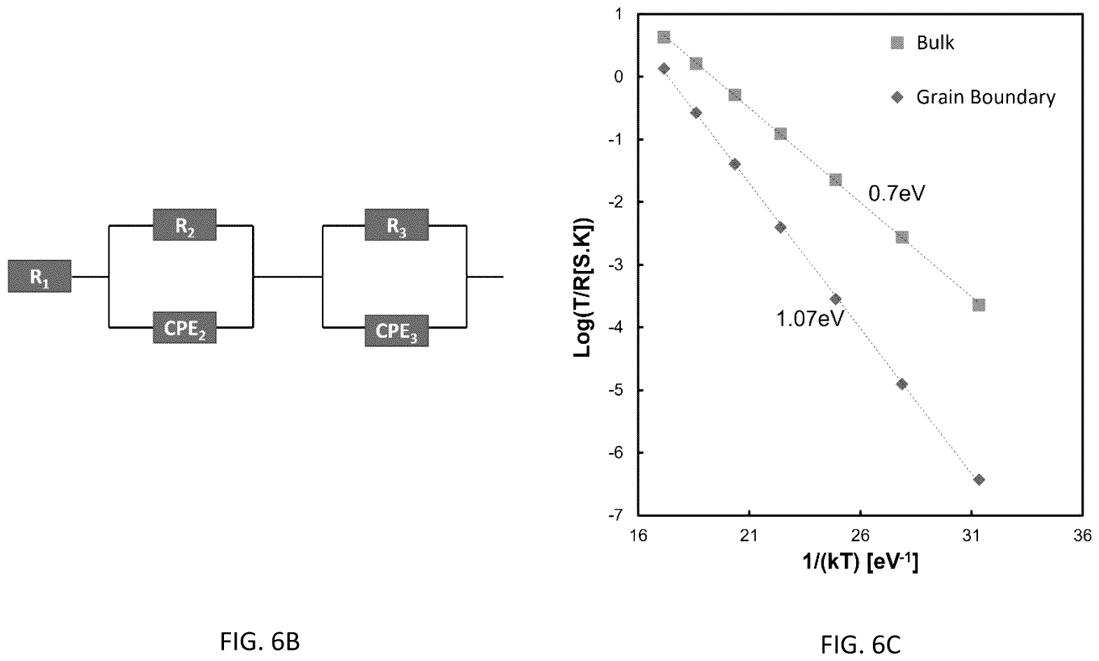

Electrochemical impedance measurements were performed on the 3GDC solid electrolyte pellets 110′ onto which 5 mm×9 mm platinum electrodes 130 were deposited on either side by DC sputtering. To establish a reference value for the electrical conductivity in the dark, the impedance from 100° C. to 300° C. was characterized to aid in isolating the grain and grain boundary resistance contributions. A typical impedance spectrum measured at 141.7° C. is displayed in FIG. 6A, and the equivalent circuit used to extract impedance parameters is given in FIG. 6B. As constant phase elements (CPEs) were used instead of capacitance, capacitance values were calculated using the following equation:

$$C = {( {R}^{1 - n} Q )}^{\frac{1}{n}} ,$$

where Q is the constant phase element capacitance, R is the resistance, and n is the non-ideality factor obtained from the fitting procedure.

The complex impedance spectra show two dominant semi-circles, one at high and one at low frequency, which when fitted to an equivalent circuit model, yield resistance and capacitance values, after correcting for the 8% porosity. Resistance values of 1.51×10⁵Ω and 3.35×10⁷Ω and capacitance values of 2.44×10⁻¹¹ F and 4.67×10⁻⁹ F were extracted at high and low frequencies, respectively, at 141.7° C. FIG. 6C shows the Arrhenius plots of the two resistance contributions, corrected for porosity, allowing the activation energies for the high (0.7 eV) and low-frequency contributions (1.07 eV), respectively, to be extracted. The activation energy for the high-frequency resistance of 0.7 eV and the magnitude of capacitance of 2.44×10⁻¹¹ F match well with previous reports of the extrinsic bulk ionic conductivity (0.71 eV) and capacitance (1.9×10⁻¹¹ F) in 0.2 at % Gd doped CeO₂ with the former relating to the migration enthalpy of oxygen vacancies for a fixed oxygen vacancy concentration, introduced by the Gd dopant according to the following charge balance relation [Gd′_{Ce}]=2[V_{Ö}].

Here [Gd′_{Ce}] represents the concentration of Gd³⁺ ions substituted on Ce⁴⁺ sites, creating net singly negatively charged impurity defects and [V_{Ö}] represents the concentration of doubly positively charge oxygen vacancies that form for charge compensation. The derived high-frequency capacitance can be confirmed to be associated with the bulk grain properties of this ceria-based material by calculating the dielectric constant from the measured capacitance according to

$$C = {ε}_{0} {ε}_{bulk} ( \frac{A}{n {d}_{g}} ) ,$$

where A is the cross-sectional area, d_{g} the grain size and n the number of grains along the conduction path. Assuming average cubic grains of the same size, and homogenous grain boundaries (400 nm in average over 1600 grains), a value of ε_{bulk}=37, was obtained in reasonable agreement with values reported for bulk CeO₂ and Gd doped CeO₂.

The low-frequency capacitance, on the other hand, matches well with previous reports of grain boundary contributions in Gd-doped CeO₂ (5×10⁻⁹ F vs. 4.67×10⁻⁹ F). In terms of the activation energy, while it is known that the grain boundary activation energy is sensitive to the doping concentration, in the low dopant concentration range, its value matches the expectation for 3GDC observed in previous reports (>1 eV). The total effective grain boundary space charge width δ_{GB} can be estimated from Equation 1:

$${δ}_{G B} = \frac{{ε}_{G B}}{{ε}_{bulk}} ( \frac{{C}_{bulk}}{{C}_{G B}} ) {d}_{g} \approx ( \frac{{C}_{bulk}}{{C}_{G B}} ) {d}_{g} , \qquad ( 1 )$$

where ε_{bulk} & ε_{GB} are the bulk and grain boundary dielectric constant, dg is the grain diameter, and C_{bulk} and C_{GB} are the bulk and grain boundary capacitances, respectively, obtained from the impedance fits. If the dielectric constant of the space charge layer ε_{GB} is equal to the bulk dielectric constant (i.e., ε_{bulk}), this leads to δ_{GB}=2.38 nm for 400 nm averaged grain size. This approximation is not unreasonable since the dielectric constant of CeO₂ is insensitive to dopant concentration and the validity of the approximation for E_{GB} has been experimentally demonstrated for acceptor-doped SrTiO₃, in which εGB was determined to be 0.95 ε_{bulk}. The measured space charge width value also aligns with other reports for the Gd-doped CeO₂ bulk systems.

In terms of extracting a space charge potential, to first order, assuming a Mott-Schottky scenario where the dopant profile is flat and frozen in during processing, then for large space charge potentials

$$( \frac{z e Δ ϕ ( 0 )}{{k}_{B} T} > 3 ) ,$$

an approximate expression for the grain boundary resistance R_{gb} associated with a space charge potential can be used, given by Equation 2:

$$\frac{{R}_{gb , tot}}{{R}_{bulk , tot}} \approx \frac{{δ}_{G B}}{{d}_{g}} \cdot \frac{{e}^{\frac{z e Δ ϕ ( 0 )}{{k}_{B} T}}}{\sqrt{\frac{2 z e Δ ϕ ( 0 )}{{k}_{B} T}}} , \qquad ( 2 )$$

where z is the relative charge of the defect (2+ for doubly ionized oxygen vacancies), Δϕ(0) is the space charge potential at the grain boundary core, and R_{gb,tot} and R_{bulk,tot} are the total GB and bulk resistance contributions respectively. Fitting the results to this expression, an average space charge potential equal to 0.20 eV was obtained, which falls within expected values observed previously for this material system (>0.2 eV). The mathematical treatment leading to Equation 2 is similar to the description of the double Schottky barrier model and shows how the grain boundary resistance relates to the bulk resistance with an additional activation energy term for the space charge potential (i.e., E_{GB}˜E_{Bulk}+Δϕ(0), where E_{GB} and E_{Bulk} are the activation energies associated with R_{gb,tot} and R_{bulk,tot}, respectively). While Equation 2 is an approximation and may not be valid for small space charge potentials, the general expectation is that when the space charge potential approaches zero, the grain boundary resistance becomes equivalent to the bulk resistance as discussed below. Using the linear fitting of the grain boundary resistance, the total sample resistance to room temperature can be extrapolated, yielding a resistance of 4×10¹²Ω.

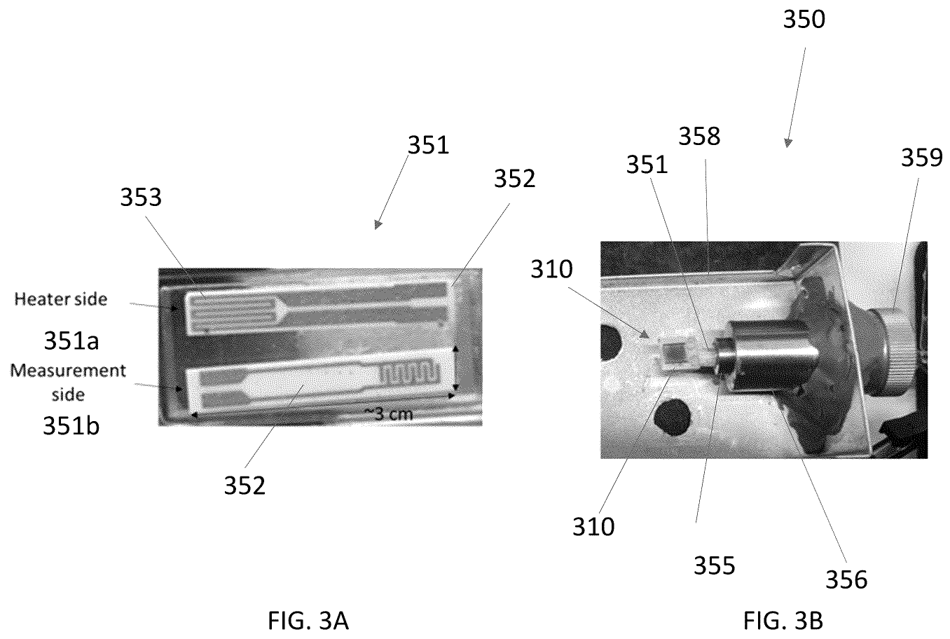

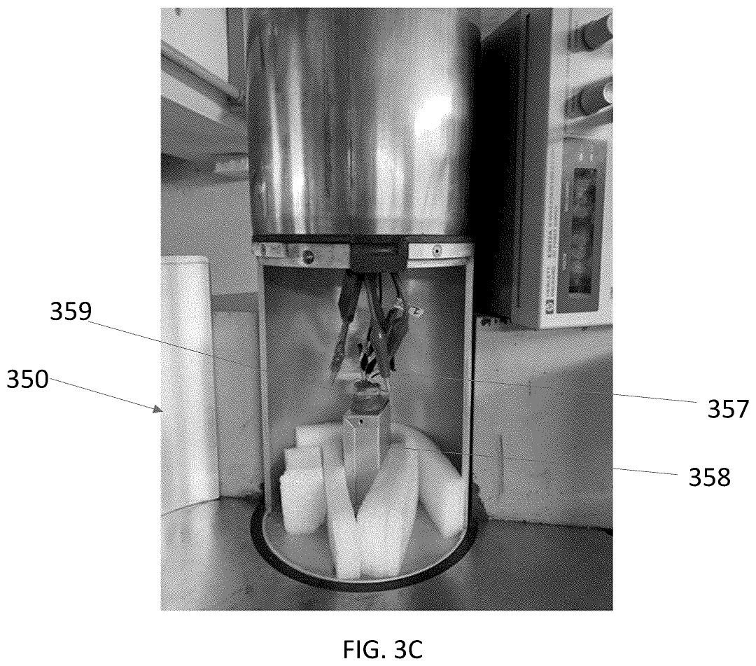

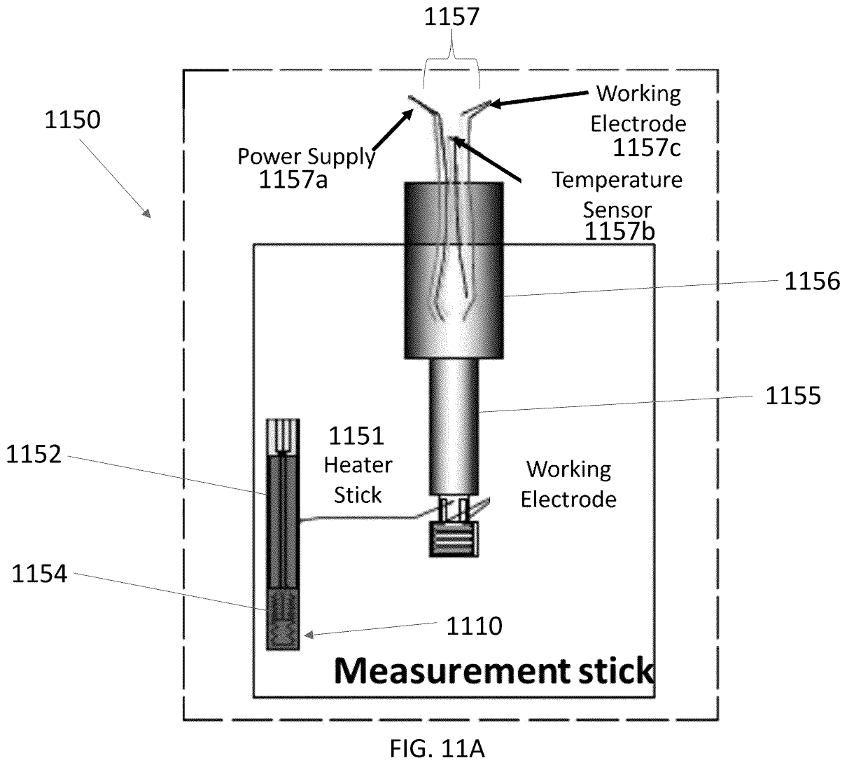

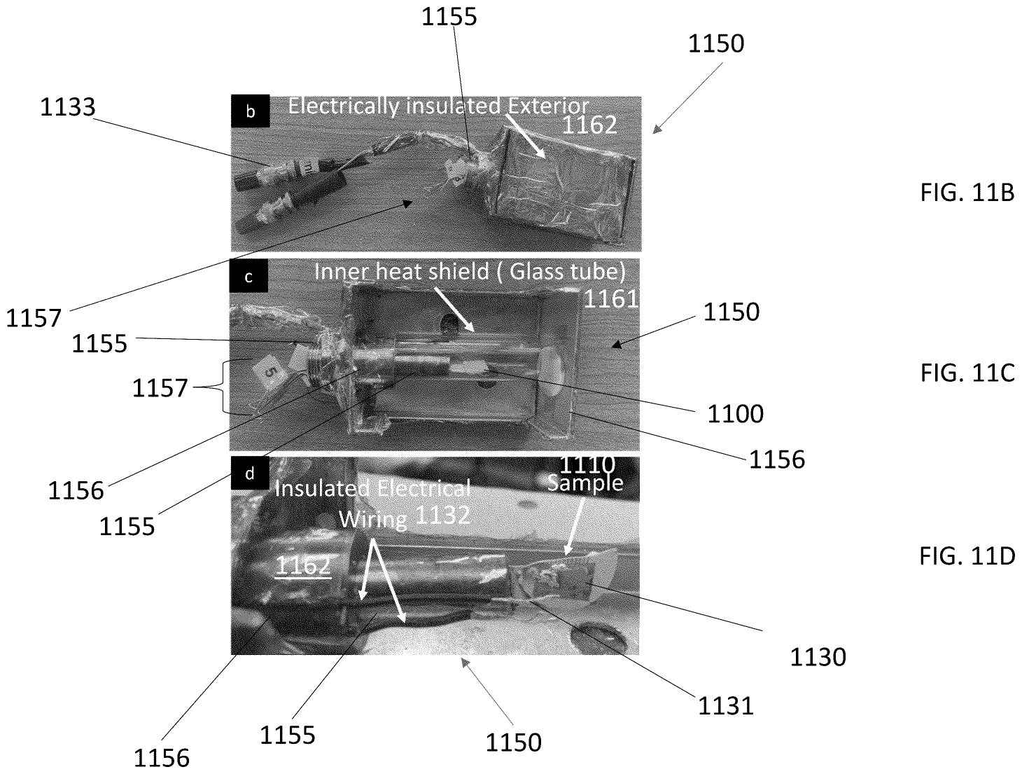

Having established the conductivity of the solid electrolyte pellet 110′ in the dark as the reference, the solid electrolyte pellet 110′ was loaded within a custom-built heater/measurement device (as shown in FIGS. 3A-3C and 11A-11D and described below) and into a gamma-ray radiation source (the details of setup and temperature calibration protocol are disclosed below) to measure the sample's impedance under γ-ray exposure.

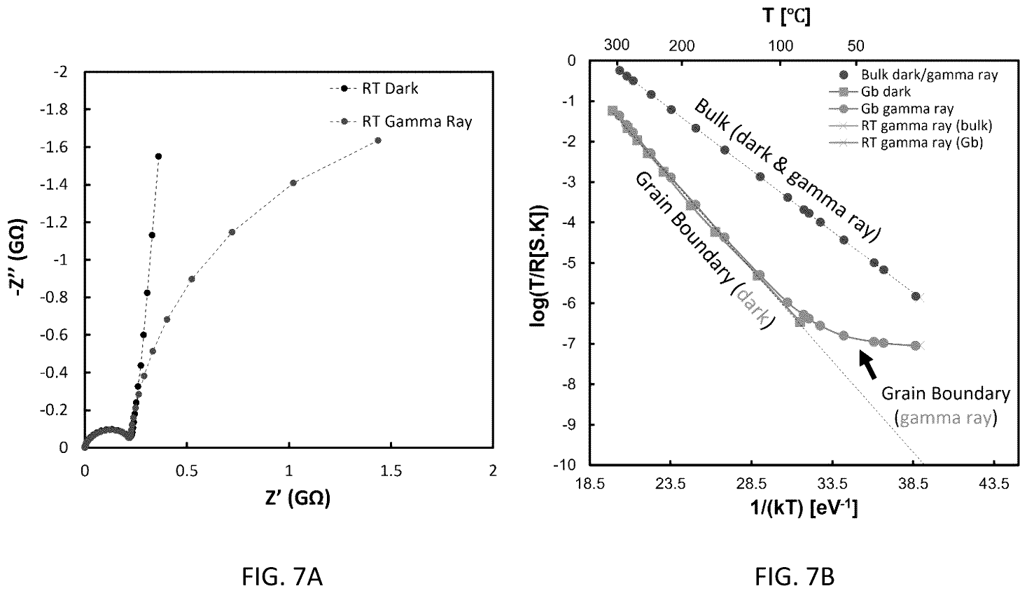

FIG. 7A shows a plot of the near room temperature (about 23.8° C.) impedance spectra obtained for the 3GDC solid electrolyte pellet 110′ specimen measured both un-irradiated (in the “dark”) and under γ-ray exposure (dose rate of 35 Gy·min⁻¹), following equilibration for 1 minute under irradiation conditions. The impedance under irradiation conditions was measured twice to confirm stability. The observed impedance spectra were fully reversible upon removal from the radiation source, indicating no evidence of degradation under irradiation, with the resistance of the system returning to its dark value within less than seconds of having removed it from the irradiation chamber, demonstrating that the potential γ-ray detector may have a reasonably good time sensitivity.

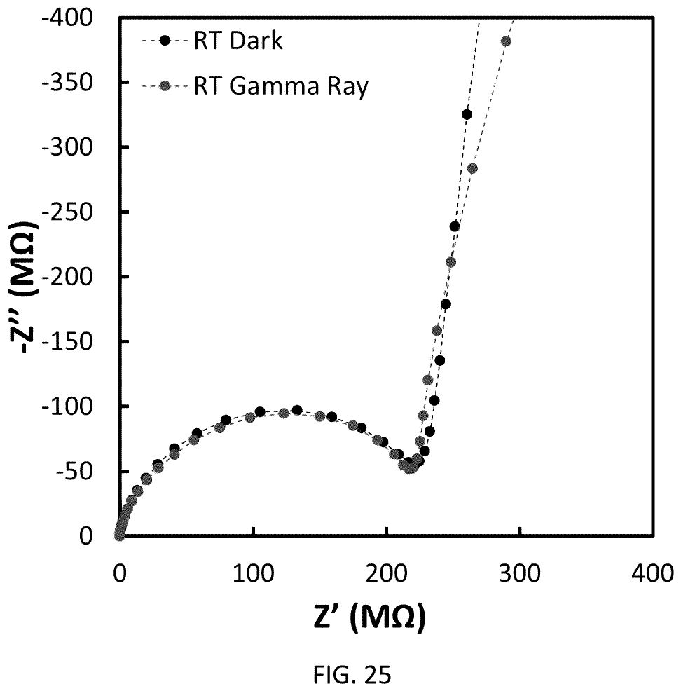

FIGS. 7A, 7B, and 25 show that: (1) the bulk resistance contribution is nearly unchanged under irradiation ΔR/R<1%; (2) the grain boundary resistance at 26.1° C. is about 3.36×10⁹Ω, a decrease by a factor of approximately 680 compared to the dark value. Additionally, both contributions' capacitance remained nearly unchanged (Dark: Freq C_{HF}=2.44×10⁻¹¹ F, C_{LF}=4.61×10⁻⁹ F, Under γ-ray exposure: C_{HF}=3.33×10⁻¹¹ F, C_{LF}=3.76×10⁻⁹ F). The negligibly small change in bulk resistance confirms that the specimen remains a predominantly ionic conductor (i.e., low electronic transference number t_{electronic}<<1) even under irradiation, with the small observed change that may be tied to radiation-induced heating. The measured change based on the known activation energy may involve a temperature change of only approximately 0.1 K. This is similar to the results for UV irradiation-induced changes in thin film temperatures where an approximate 0.2 K increase in solid electrolyte film 110 temperature under an illumination intensity of 630 mW/cm² has been reported.

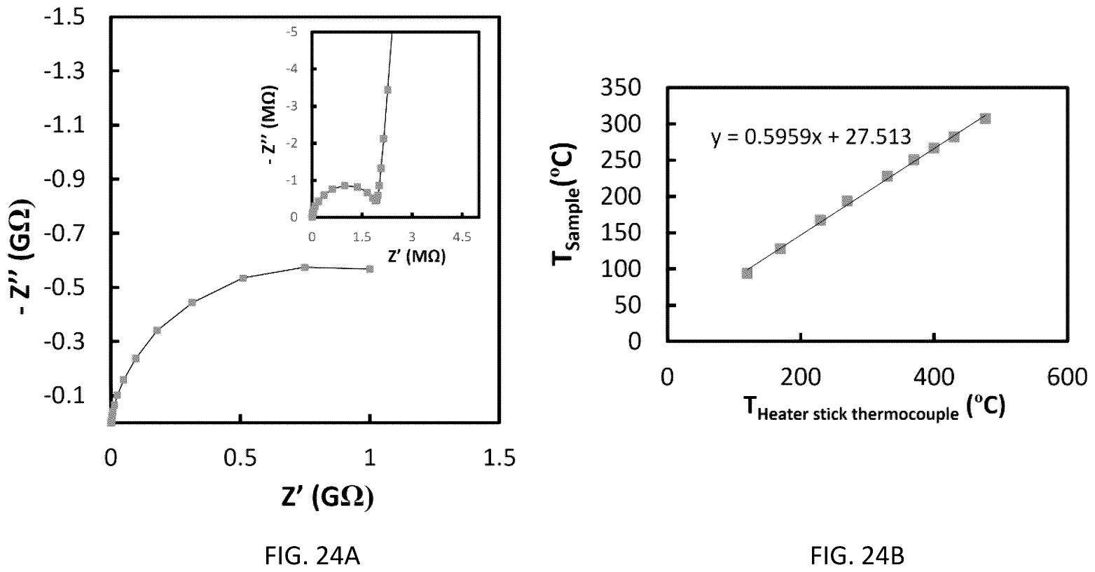

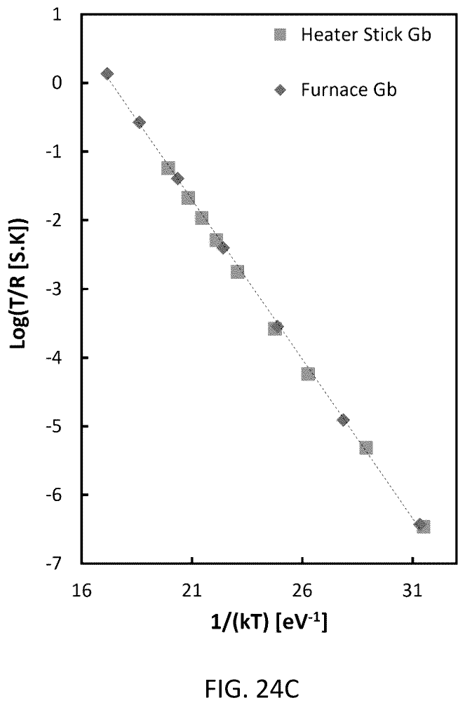

These measurements show that only the grain boundary resistance may be modified under irradiation. Using these observations, calibrated temperature curves (see FIGS. 24A-24C for details) were applied to plot the resistance values as a function of temperature under 7-ray exposure. FIG. 7B shows a plot of the resistances in the dark and under irradiation as a function of temperature. At higher temperatures (>100° C.), the grain boundary resistance in the dark and under irradiation may coincide very well, resulting in an activation energy of 1.07 eV. On the other hand, below approximately 100° C. the grain boundary resistance dependence on temperature begins to decrease, leading ultimately to a very shallow effective activation energy of approximately 0.08 eV. By extrapolation of the two curves to room temperature, it may be found that the resistance is approximately three orders of magnitude lower under irradiation than when unirradiated. By the end of the measurement series, for the lowest temperature (approximately 26.1° C.), the sample had been continuously irradiated for approximately three hours.

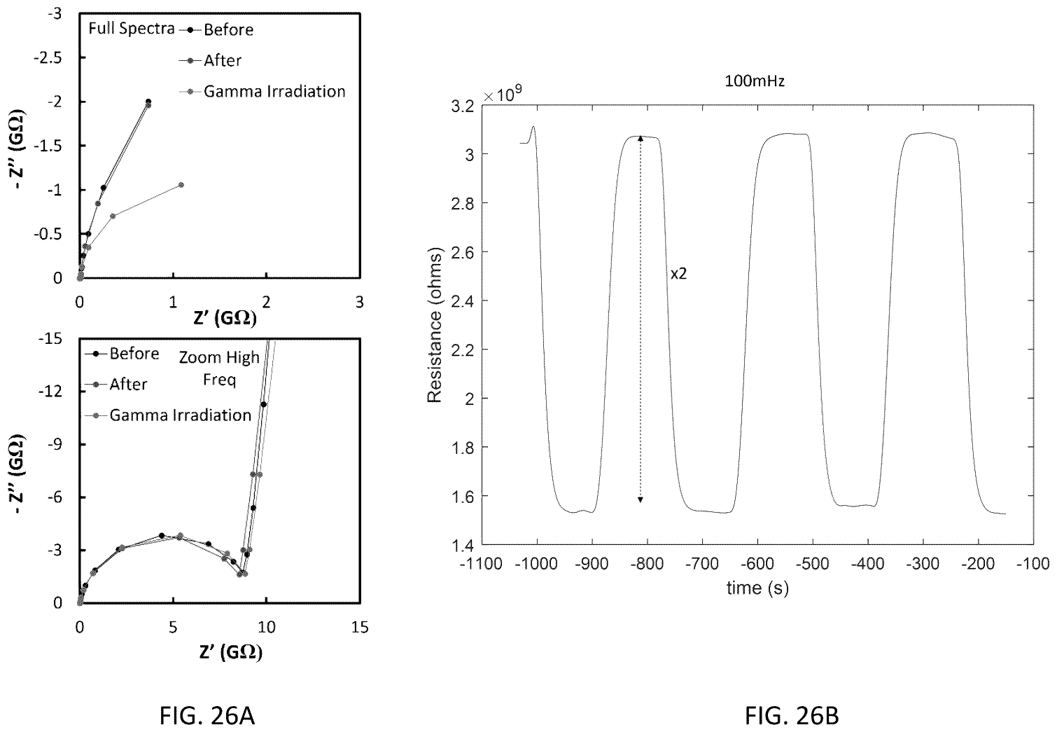

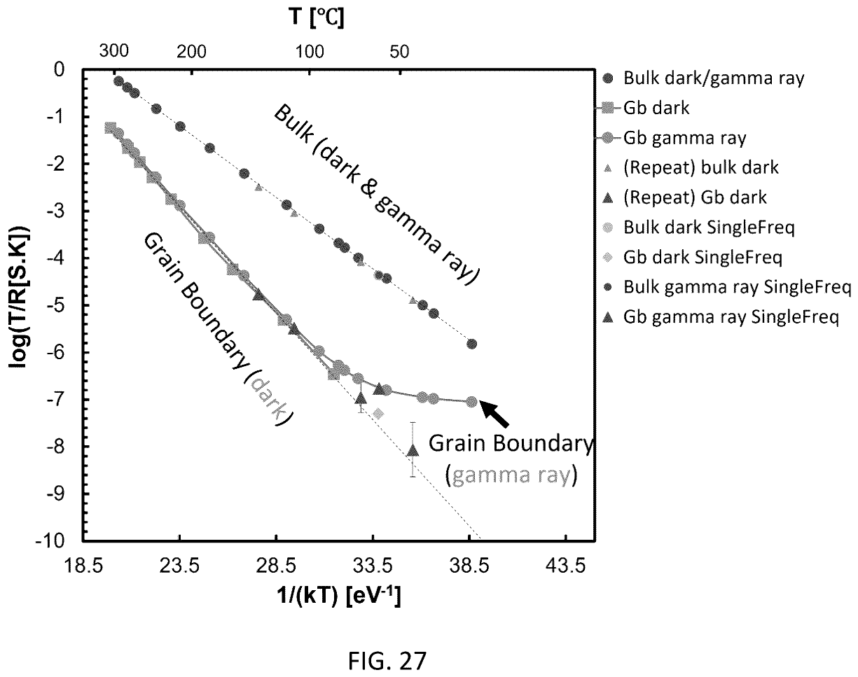

The conductance data at 26.1° C. under irradiation conditions matches the trend with the data that was obtained at near room temperature (approximately 23.8° C.) prior to the measurement series, confirming that no degradation was observed, even following the temperature cycle under irradiation. To further support the reproducibility and reversibility of these observations, additional impedance measurements made prior to, during and following cycling inside the gamma irradiator, alongside three cycles of single-frequency transient measurements are provided in FIGS. 26A and 27. This is also consistent with the measurement shown in FIGS. 4A-4B, which confirms the overall stability and reversibility.

This demonstrates enhanced ionic conductance in a 3GDC bulk polycrystalline solid electrolyte pellet 110′ under penetrating gamma radiation, herewith called radio-ionic effect. A large decrease in ionic resistance, by a factor of 680 at 26.1° C. for a 35 Gy·min⁻¹ irradiation dose rate, indicates strong sensitivity to γ-ray exposure. This originates from the high dark ionic resistance, dominated by the grain boundary resistance, exhibiting a large thermal activation energy (1.07 eV) and the modification of that grain boundary resistance by gamma-ray irradiation. The bulk conductivity may be barely modified, confirming, as observed in the impedance spectra, that the 3GDC solid electrolyte film 110 remains predominantly an ionic conductor throughout the measured temperature range and that more substantial dark vs. irradiation conductance ratios may be expected at even lower temperatures.

For example, extrapolating the dark grain boundary conductivity according to Equation 2 and the observed grain boundary resistance under irradiation with weak thermal activation energy (0.08 eV) to 21° C. may produce resistance ratios on the order of 1300. Moreover, the weak temperature dependence of the grain boundary conductance under irradiation conditions may enable a robustness to temperature variations. Furthermore, the lack of radiation response in the bulk, and its natural thermally activated behavior, may allow for the use of higher frequency measurements to monitor the impact of environmental temperature variations on the dark resistance. This may allow for improved temperature insensitivity and the design of a simple, miniaturized radiation detection devices that can be operated in a variety of environments, without the need for water cooling.

Previous studies demonstrating the related opto-ionic response under UV illumination were restricted to thin films, given the strong optical absorption coefficient of 3GDC near its band gap edge. The present radio-ionic effect observations may present several advantages: (1) bulk specimen fabrication may be simpler and less costly than that of thin films, and (2) due to the larger thickness of the specimens (800 microns vs. 200 nm), much higher stopping powers can be achieved as needed for the more highly energetic ionizing γ-rays. Additionally, in contrast to traditional single crystalline semiconductor materials that can only be grown defect-free in limited dimensions and at elevated costs, thick polycrystalline ceramics may be prepared over large areas at low cost, paving the way for creating large-area, cost-effective detector panels.

Furthermore, in traditional semiconductor detectors, the electrode geometries, and their separation, need to match charge transport lengths to achieve large responses and fast rates. This relies on the need for photogenerated charge carriers to reach the external circuit before recombining to generate a signal. Instead, in the system disclosed herein, the photogenerated electronic carriers may only need to be trapped at the grain boundaries for ionic conduction modulation to occur. Thus, the drift/diffusion lengths may be reduced to the order of grain size dimensions (e.g., 100's of nm), rather than electrode spacings of 100's of microns to multiple mm. In this way, grain boundaries may act as virtual electrodes, reducing the effective drift path length required to obtain a signal. This may enable the use of materials that typically have very short carrier recombination lifetimes, as well providing additional flexibility in engineering electrode geometries for such devices. Also, a greater sensitivity may be expected by increasing the dark GB barrier heights, leading to greatly enhanced dark resistivities and lowered background noise. These attributes offer unique opportunities to optimize devices with enhanced sensitivity and operational range. Increasing the GB barrier height may optimize the sensitivity and operational range of the devices disclosed herein. For example, increasing the dark GB barrier height may increase the overall dark resistance and improve the overall sensitivity of the devices disclosed herein by reducing background noise. Increasing dark GB barrier height may also improve the sensitivity of the optoionic effect such that lower irradiation doses may result in measurable resistance modulations, which may enable a wider operational range of the devices.

### Reduced Activation Energy at Lower Temperatures:

The origin of the shallow activation energy of the grain boundary under γ-rays exposure is far below the activation energy of oxygen vacancy migration within the bulk (approximately 0.7 eV). In previous studies involving UV on thin films, an activation energy decrease of the effective grain boundary resistance was observed under illumination, with its value coinciding with that of the bulk migration energy of oxygen ions. While the conductivity under UV irradiation exhibited a bulk-like migration energy, the absolute value of the conductance remained far smaller than that of the epitaxial sample with no grain boundaries. This may be explained by noting that not all the space charge barriers responsible for the ion-blocking GBs in 3GDC specimens fully collapsed upon UV illumination. Given the expected distribution of space charge potentials in such polycrystalline samples that may originate from the varying tilt angles, grain misorientations, and impurity/dopant segregation, correspondingly higher photogeneration rates may collapse the higher barriers. This served as the basis of the development of the constriction model described herein. The constriction model specifies that the space charge potential, in only a fraction of the parallel current pathways, is fully collapsed by irradiation for a given radiation intensity. Under UV illumination at 250° C., for example, the fully activated cross-sectional area, i.e., with space charge potentials brought down to zero, may reach values of only approximately 3%. Following a similar analysis, the sample resistance at lower temperatures may be described according to Equation 3 below:

$$\frac{{R}_{gb , tot}^{( / / )}}{{R}_{bulk , tot}} = {f}_{p ath} , \qquad ( 3 )$$

where R^{(//)}_{gb,tot} is the constricted resistance and fₚₐₜₕ is a lumped geometrical factor accounting for the decreased conductive area (as compared to the sample's full conductive area) and the tortuosity and the elongation of the pathway. From this relation, the activated cross-sectional area may be about 10% of the total at the lowest measurement temperature (26.1° C.).

However, the measured apparent activation may still be lower than the bulk oxygen vacancy migration energy (e.g., 0.7 eV) that may be expected for a fully collapsed space charge potential at a grain boundary. Based on the constriction model, this observation may be rationalized by considering the fact that the cross-sectional area of the unconstrained conduction pathway (i.e., fₚₐₜₕ) may not remain constant with temperature under constant illumination conditions and may be temperature dependent. If the parameter fₚₐₜₕ decreases with increasing temperature, then the activation energy in the low temperature regime may end up being effectively smaller, reflecting the balance between the increasing bulk ionic migration kinetics versus the decreasing area of the unconstrained conduction path with increasing temperature.

The Negative Temperature Dependence of fₚₐₜₕ:

The physics of the electronic charge carrier trapping kinetics at the grain boundaries may explain the negative temperature dependence of fₚₐₜₕ. The ability of space charge fields to split and collect charges as well as the core grain boundary traps' capacity to retain trapped charges may both be factors that may be expected to demonstrate negative temperature dependences. The space charge field may weaken with increasing temperature, while the minority carrier capture cross section may be expected to show a negative thermally activated behavior. These combined effects may lead to a negative exponential temperature dependence for the grain boundary recombination kinetics and thereby the fₚₐₜₕ parameter with temperature.

Cause for Reduced Response Vs. Thin Film:

While similar response characteristics were obtained with bulk ceramics under γ-ray exposure compared to thin films under UV illumination, the bulk specimens only exhibited resistance changes below 100° C. In contrast, the previous work on thin films exhibited changes up to 250° C. Extrapolating previous thin film results shows that the bulk sample under γ-ray exposure may exhibit a smaller response magnitude. While an a-priori difference in electronic charge carrier photogeneration rate might exist between the two different sources, even at equal rates, a lower response in the bulk specimen may correlate with the fact that the bulk specimens were fabricated via a high-temperature sintering process (1300° C.), with much larger grain sizes (approximately 400 nm) as compared to those in the thin film samples (about 50-100 nm). The grain boundaries may be considered as virtual electrodes, where the opto-ionic or radio-ionic effect relies on radiation generated charge carriers being able to reach the grain boundary interfaces. A smaller fraction of photogenerated charge carriers may be expected to reach the grain boundaries for considerably larger grain sizes. Thus, a smaller radio-ionic effect in the bulk ceramics may be expected.

### Material Stability Under Applied Bias and Irradiation Conditions:

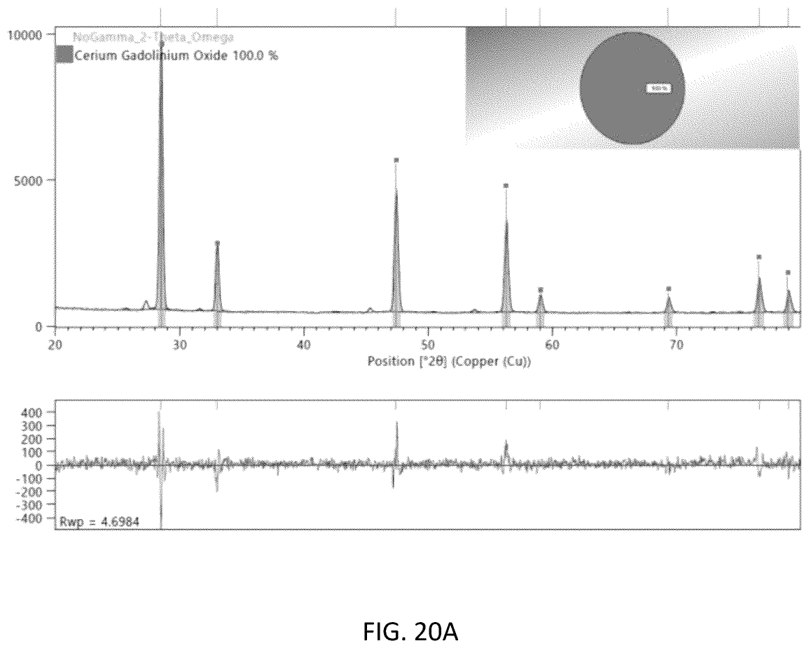

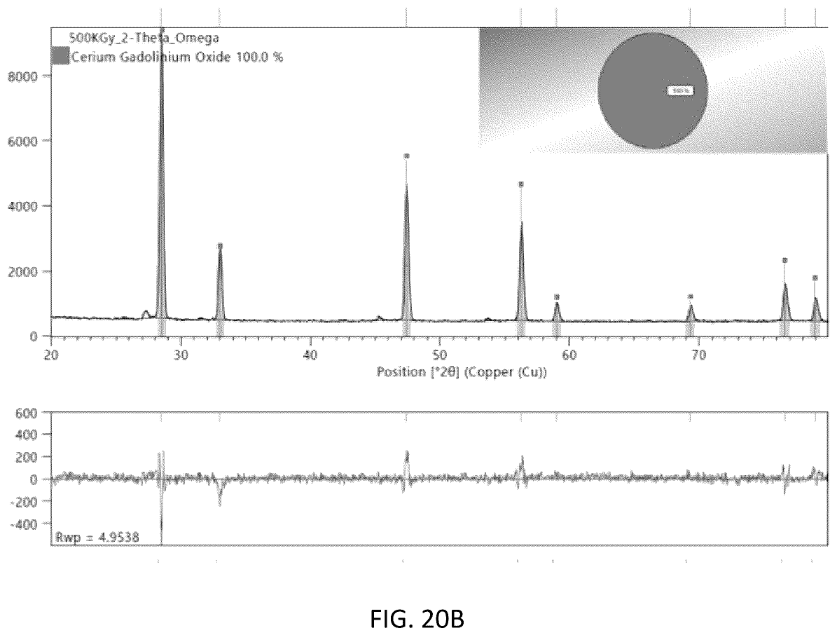

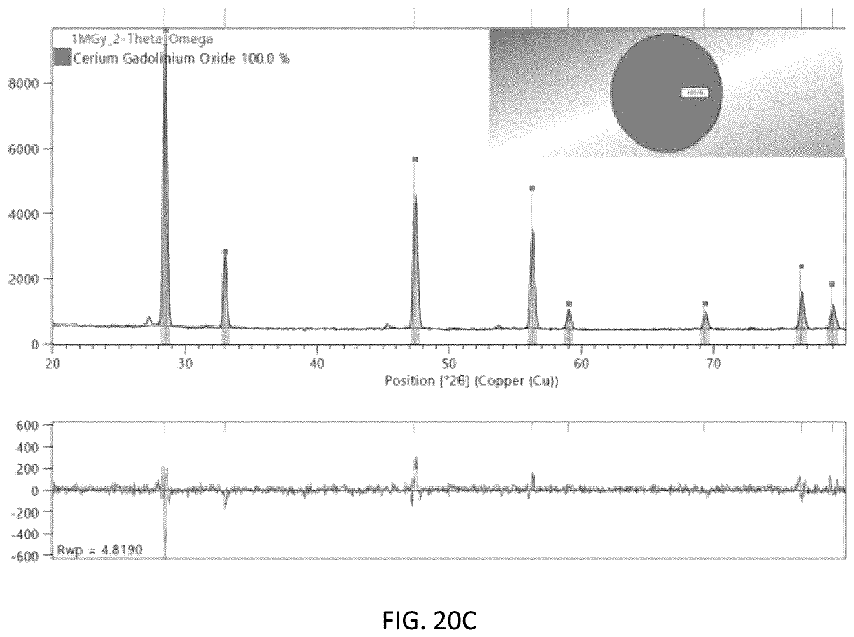

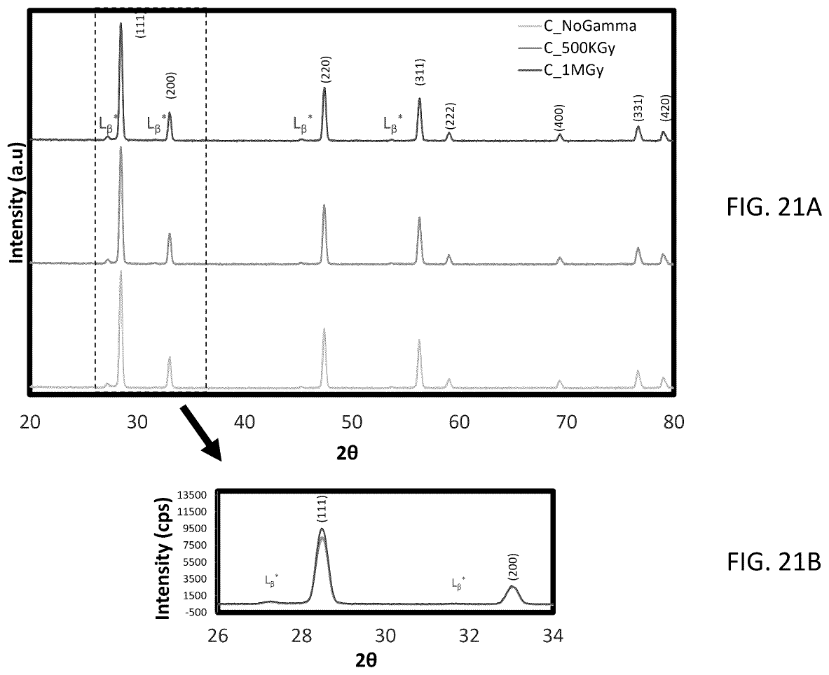

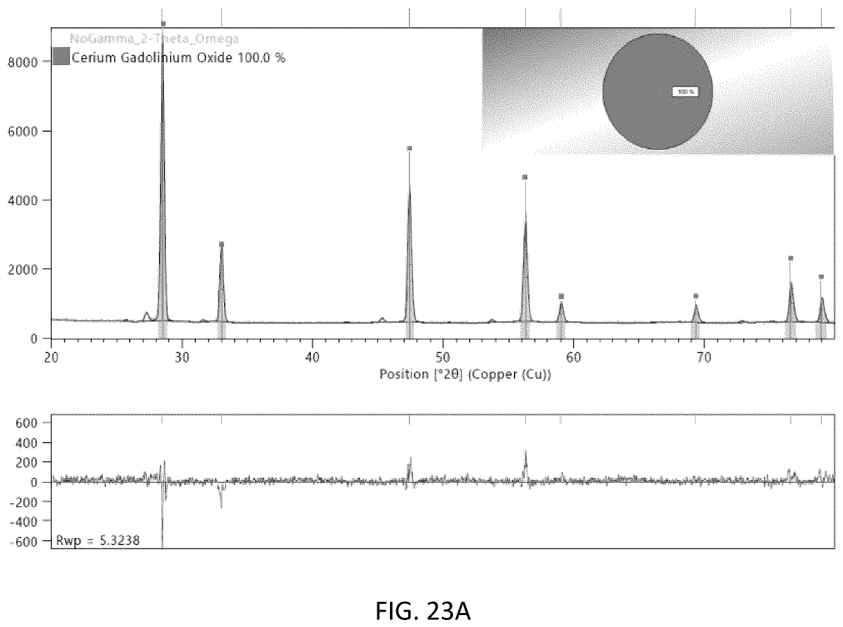

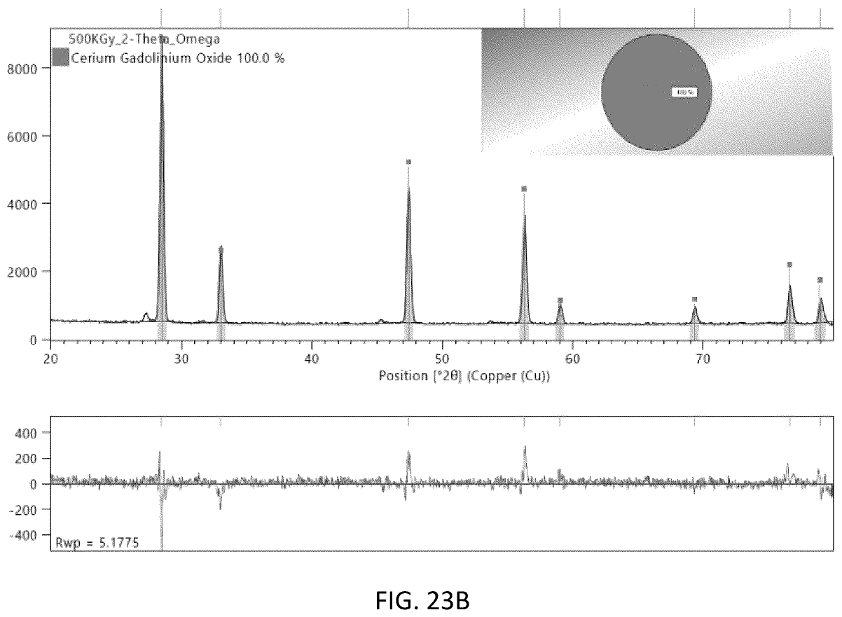

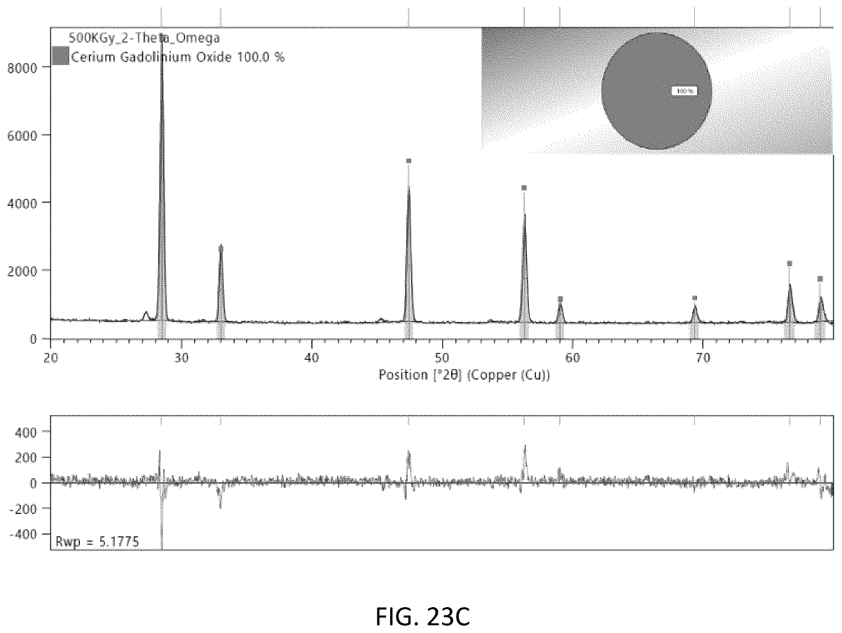

From quantitative analyses of the X-ray diffraction spectra disclosed herein by application of the Rietveld analysis for the 3GDC solid electrolyte film samples B and C irradiated at 500 and 1000 kGy, the 3GDC solid electrolyte pellet 110′ may exhibit radiolytic stability as the crystal structure remained intact (See FIGS. 4A-4B and 19A-23C). Tables 1 and 3 show that there is no detectable change in lattice parameter and volume with increasing γ-ray dose, confirming that the atomic positions remain unaltered. Raman spectroscopy measurements further allowed the evaluation of how the oxygen sublattice's occupancy and the cerium ion's oxidation state may have been impacted by irradiation conditions. As seen in FIGS. 5A-5B, no changes in the main F_{2g} peak and the defect bands, position, or broadness were observed for any of the samples, supporting the notion that the solid electrolyte film samples did not undergo any perceivably measurable change in [Ce³⁺] or [Vₒ²⁺] with γ-ray exposure.

Traditionally in semiconductor-based detectors, high electric fields are used for achieving higher electronic charge carrier collection efficiencies. In ionic systems, for example as reported for halide-based semiconductor detector materials, high fields may lead to polarization of the mobile ionic carriers. On a short time scale, this may lead to time dependent evolution of the detection response, whereas on the long-term, it may lead to electrochemical phase decomposition at the electrodes due to a large pile up of ionic carriers at the blocking electrode interfaces, both effects may be undesirable for stable and durable detector operation.

However, since the measurements herein focus on the overall sample linear resistance at small voltage bias, which relates to ionic conductivity, and not photogenerated charge carriers, high DC voltages may not need to be used. Instead, a very low magnitude (±200 mV) sinusoidal AC voltage may be applied, resulting in very low peak electric field strengths (<2 V/cm). This may minimize potential point defect generation and also may lead to minimal ionic polarization, in stark contrast to traditional semiconductor-based detection that require high field strengths for efficient charge collection.

Moreover, when comparing the material system disclosed herein to halide counterparts, e.g., CsPbBr₃, TlBr, FAPbBr₃, and MAPbI₃, the latter generally have a rather limited ability to sustain local compositional changes that may lead to irreversible phase decomposition at the electrodes under applied bias. This may be accentuated by the fact that these materials are often incompatible with open-air electrodes, making phase decompositions difficult to reverse and therefore requiring advanced packaging solutions.

In contrast, oxide-based material systems are compatible with an open-air environment and may be able to accommodate significant deviations in local stoichiometry without altering the phase or crystal structure. The defect chemistry of oxide materials is commonly studied by examining their conductivity dependence on gas phase oxygen activity at elevated temperatures, and such changes are typically reversible. Therefore, it may be possible to heal stoichiometric changes resulting from extended periods of irradiation and applied bias by annealing the material at elevated temperatures in air.

Collectively, these observations demonstrate the potential of ion conducting polycrystalline ceramic materials for detecting radiation. Moreover, their unique thermal and chemical stability may present opportunities for precise γ-ray detection under extreme conditions in various industrial fields, such as nuclear energy solutions, aerospace, oil & gas, and medicine.

This disclosure extends the grain boundary opto-ionic effect observed in solid electrolyte thin films to bulk solid electrolyte ceramics under deeply penetrating gamma radiation. These bulk solid electrolyte ceramics may be used as new all-solid-state radiation detecting devices that rely on the changes in ionic conductance in polycrystalline ceramic solid electrolytes, herewith named the radio-ionic effect. Considering that the majority of defects in these materials are already ionic in nature, the interaction between photogenerated charge carriers and the ionic migration barriers present at grain boundaries can be leveraged to develop a sensing response that relies on and benefits from structural defects. Owing to the blocking nature of the grain boundaries, the polycrystalline sample's dark resistance may be orders of magnitude higher than the bulk values, reaching values as high as >10¹²Ω near room temperature, which may be favorable for achieving high sensitivities of ΔR/R≥10³. This response may be further enhanced by modulating the dark grain boundary resistance by moving towards nanocrystalline systems or engineering the grain boundary properties to enhance the space charge potential heights.

Furthermore, photogenerated electronic charges that remain as minority defect carriers in the material may drift/diffuse very short distances (typically sub-micron) to reach the grain boundaries where they interact with the migration barriers that impede ionic motion. In essence, the grain boundaries that trap the electronic charge carriers may act as virtual electrodes. This may enable a large fraction of photogenerated charge carriers to participate in the sensing response with fast response rates, even for moderate electronic mobilities. In that sense, the criteria for developing a strong sensing response differs from traditional semiconductor materials engineered to prevent their photogenerated charges from trapping. On the other hand, the trapping process may be favored at the grain boundaries.

This disclosure opens a broad new category of materials suitable for radiation detection composed of large band gap (>3 eV), high Z (>60) and easy-to-handle oxide-based ceramics as disclosed above that can be manufactured at low cost as thick and large area devices. Further advantages may include utilizing low-cost polycrystalline oxide materials, which may exhibit high stability in ambient and elevated temperatures. The chemical and generally high-temperature stability of oxide materials may open new opportunities for designing radiation detectors for high-temperature and/or corrosive/high-pressure environments, which are desirable features in next-generation nuclear technology solutions such as geothermal directional drilling, small modular nuclear reactors, nuclear security, and waste management. Moreover, grain boundary resistivities, as they relate to space charge effects, have also been reported for lithium, sodium, and proton solid state ion conductors. This may open many new materials opportunities for determining optimum detection response and for reducing materials synthesis costs, as well as designing radiation detection schemes selective to alternative ionizing radiation (e.g., alpha, neutron, and/or X ray radiation). For example, neutrons may be detected using a polycrystalline material with, including but not limited to, Li⁺, OH⁻, or H⁺ ions. Gamma radiation may be detected with any of the polycrystalline material disclosed herein and preferably a polycrystalline material with a high atomic number (e.g., Z>40). For example, a polycrystalline material including iodine, bromine, or lead may be used to detect gamma radiation. Neutrons may be detected with a polycrystalline material including at least one of the following elements: boron, helium, lithium, cadmium, gadolinium, promethium, samarium, europium, dysprosium, indium, hafnium, erbium, or gold. Alpha radiation may be detected with any of the polycrystalline materials disclosed herein.

### Sample Preparation:

Gd_{0.03}Ce_{0.97}O₂ (3GDC) powder was synthesized by a solution combustion route, starting from Ce(NO₃)₃·6H₂O (99.99%, Alfa Aesar), Gd(NO₃)₃:6H₂O (Strem Chemicals) (99.99%) precursors and citric acid. The solution was heated on a hot plate, and following gel combustion, the reaction resulted in the formation of a whitish powder. The resulting GDC powders were calcined at 900° C. for 1 hour to obtain the GDC powder crystallized in the fluorite structure. The powder was then pressed into a 30 mm diameter disk with a uniaxial press (1 Tcm⁻²) and sintered at 1300° C. for 8 hours, followed by cooling at 1° C. min⁻¹ to limit crack formation, resulting in a 3GDC solid electrolyte film pellet with 92% density. 100 nm thick platinum electrodes were subsequently DC sputtered on either side of the pellet using Kapton tape to serve as a shadow mask covering a rectangular area of about 5 mm×9 mm. The electrode was subsequently attached to Pt wires in both the furnace setup and custom-built microheater device using a commercial Ag paste purchased from Fuel Cell Materials (#321201) and dried using a hand-held heat gun for 10 minutes and then subsequently dried in a furnace to 450° C. while holding for 1 hour.

Another suitable sample preparation method may include a powder fabrication method (co-precipitation) followed by surface infiltration and subsequent powder consolidation and sintering. For example, a GDC powder may be synthesized using a coprecipitation method. Cerium nitrate (Ce(NO₃)₃·6H₂O) and gadolinium nitrate (Gd(NO₃)₃·6H2O) may be dissolved in distilled water to form a solution of gadolinium and cerium in a 3:97 stoichiometric ratio. Ammonium carbonate may then be dissolved in distilled water to reach a concentration of 0.5M. This solution may be used as the precipitation agent and may then poured drop-wise into the stirred nitrate solution at room temperature to elicit precipitation. The resulting precipitate may be filtered from the solution using a filter (e.g., a Buchner filter) connected to a vacuum pump. While filtering, the precipitate may be washed in ethanol to remove surface hydroxyl groups that can lead to the formation of micron-order agglomerations. The filtered powder may be dried for 24 hours at about 100° C., and calcined at about 750° C. for 2 hours to obtain a GDC nanocrystalline powder. To synthesize an infiltrated powder, the GDC powder may be sonicated in anhydrous ethanol for approximately 15 minutes to break up particle agglomerations. Simultaneously, either aluminum nitrate (Al(NO₃)₃*9H₂O) or gallium nitrate (Ga(NO₃)₃*8H₂O) may be dissolved in ethanol. The GDC suspension and impurity solution may then be combined in a crystallization dish on a hot plate set to about 120° C. until all liquid evaporated while being stirred with a magnetic stirrer. The resulting powder may be calcined at about 400° C. for 2 hours. Batches of powder may be uniaxially pressed under about 2000 psi, then cold isostatically pressed under about 30,000 psi in round dies (d=0.5 in). Samples can then be sintered in a tube furnace at about 1100° C. for 2 hours, about 1200° C. for 2 hours, or about 1300° C. for 2 hours in O₂.

### Material Characterization (XRD/SEM/Raman):

X-ray diffraction patterns were obtained with a Rigaku SmartLab with Cu Kα rotating anode source in a coupled scan. To determine the lattice parameters of irradiated GDC samples, a Rietveld refinement was performed using High Score Plus software. Refinement quality can be determined using different statistical parameters, such as goodness of fit. The refinement process was continued until the convergence became close to 1 or reached the lowest number. The structural properties of GDC before and after γ-rays exposure are tabulated in Tables 1 and 2.

SEM Images of the cross-sections of the device sample after freshly fracturing the surface were acquired on a Zeiss Merlin high-resolution scanning electron microscope and are shown in FIG. 14. A Matlab script was used to analyze the image's grain size.

Raman spectroscopy was employed to study the vibrational modes of oxygen-cation bonds since it is sensitive to both to the oxidation state of the cation and the site occupancy of the anion and because it was useful in corroborating phase purity and for investigating defect formation under high irradiation doses. A Renishaw Invia Reflex Micro Raman was employed with a 50× objective yielding a 10-micron spot size, with a spectral resolution of ±0.5 cm⁻¹, and laser power of 5 mW. An excitation wavelength of 473 nm (2.63 eV) was selected. The data were analyzed by fitting the peak curves and subtracting the baseline to remove the background. The data was then normalized by the highest peak intensity.

### MIT Cobalt-60 Gamma Irradiation Facility:

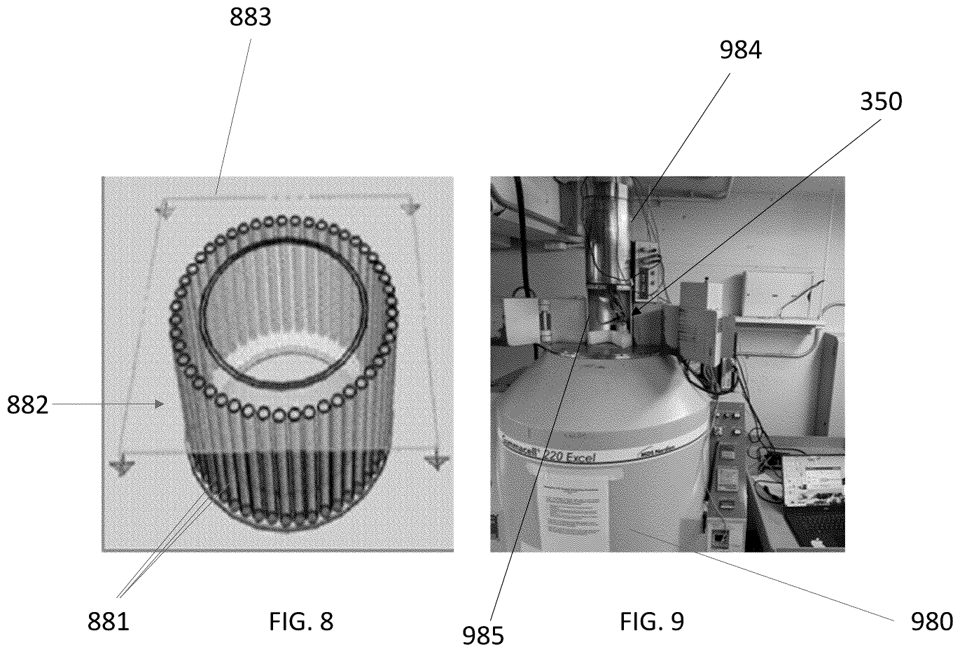

The MIT Core User Facility γ-ray irradiator was used to irradiate the irradiation detection device 150 in-situ. The irradiator 980 may be a Gammacell 220 Excel self-shielded high dose rate irradiator manufactured by MDS Nordion on Oct. 13, 2003, and contained an initial quantity of Cobalt-60 (⁶⁰Co) of 375.2 Terra Becquerel (TBq) and a current activity of 97.3 TBq. The current irradiation dose rate is approximately 35 Grey/min. The ⁶¹Co sources 881 are arranged in a caged array 882 allowing for a uniform dose to the materials being irradiated as illustrated in FIG. 8. The ⁶¹Co sources 881 are contained within a lead biological shield 883 which allows for the safe use of the irradiator 980 by trained radiation workers. The sample to be irradiated is transported by an internal elevator 985 into the source array. The irradiator is equipped with a top shield plug that can be adjusted to allow the insertion of cabling to perform the in-situ investigations.

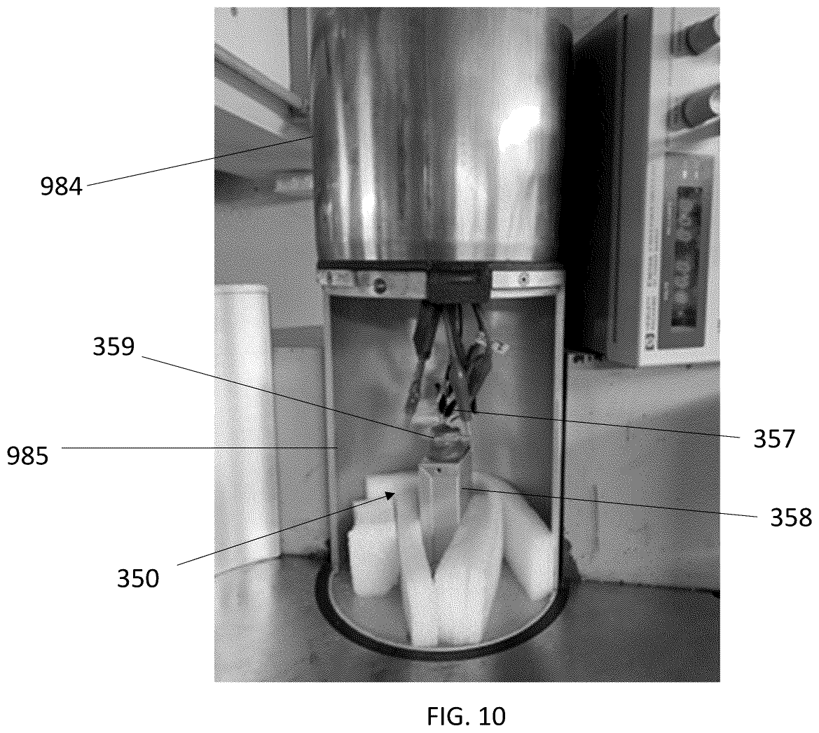

The measurement device 350 including the polycrystalline ceramic conductor 100′ was loaded into the irradiator 980 (e.g., a Gammacell 220) as shown in FIG. 9. The irradiator 980 may be a thin-walled, closed, non-porous metal cylinder with a full-width door. The inside dimensions of the chamber are approximately 6.10 inches (15.49 cm) in diameter and approximately 8.06 inches (20.47 cm) high. The measurement device 350 was connected to analysis equipment via the top shield plug raceway 984 and lowered by an elevator 985 into the ⁶⁰Co source array 882 as shown in FIGS. 9 and 10. FIG. 10 shows a close-up view of the measurement device 350 in the elevator 985. The system may be operated in either automatic or manual mode. In manual mode, the user controls the irradiation and retrieval of the sample chamber. The in-situ experiments disclosed herein used operation in manual mode to allow the cycling of the test article in and out of the radiation field.

### Measurement Setup

### Example 3: Custom-Built Heater Stick

FIGS. 3A-3C illustrate the use of another embodiment of an irradiation detection device 350. The irradiation detection device 350 may include a solid electrolyte pellet 310 made of the polycrystalline material described above. The solid electrolyte pellet 310 may be manufactured similar to the solid electrolyte pellet 110′ described above. The irradiation detection device 350 may include a heater stick 351. The heater stick 351 may include a heater side 351a and a measurement side 351b as shown in FIG. 3A. The heater stick 351 may be composed of an alumina plate 352 with screen-printed electrical tracks 353. The screen-printed electrical tracks 353 may be platinum (Pt) tracks. The screen-printed electrical tracks 353 may be located on the heater side 351a for heating). The heater stick 351 may also include a thermocouple. The thermocouple may be in the form of screen-printed thermocouple tracks (e.g., Au/Pt thermocouple tracks). The thermocouple may be located on the measurement side 351b for accurate temperature sensing of the solid electrolyte pellet 310. The thermocouple may allow the temperature of the irradiation detection device 350 to be controlled. The thermocouple may also act as a reference temperature sensor to determine any degradation in the solid electrolyte pellet 310 based on the conductivity of the bulk (e.g., the grain) as discussed below. The electrical tracks 353 and the thermocouple may be located on the same end of the heater stick 351, with the electrical tracks 353 on one side of the heater stick 351 (e.g., the heater side 351a) and the thermocouple on the other side of the heater stick 351 (e.g., the measurement side). Alternatively, the thermocouple may be attached to the surface of the solid electrolyte pellet 310. The heater stick 351 may be about 3 cm to about 5 cm in length and about 0.5 cm to about 2 cm wide, for example, about 1 cm wide. The solid electrolyte pellet 310 may be bonded to the end of the heater stick 351 (e.g., on the end of the heater stick 351 and on the opposite side of the electrical tracks 353) with a ceramic paste (e.g., Ceram-Bond©) that was first dried with a hand-held heater gun for 150 min and then subsequently dried by heating the heater stick up to 300° C. for one hour.

The heater stick 351 may be inserted inside a cylindrical stainless-steel pipe 355. The pipe 355 may be inserted inside a Swagelok stainless steel Ultra-Torr Vacuum Fitting (RA-TORR SS) 356, such that the temperature control and sensor wires 357 may exit the back end of the pipe 355 (away from the solid electrolyte pellet 310) as shown in FIG. 3B. This assembly was inserted into a stainless-steel box 358 with a custom hole drilled on one end for the back end 359 of the Swagelok fitting 356 to stand out with its wires 357 as shown in FIGS. 3B and 3C. The box 358 can be manually opened for easy sample access. The box 358 may be surrounded by Kapton tape on all sides to allow for electrical insulation with its surroundings.

FIGS. 11A-11D show another embodiment of an irradiation detection device 1150. The irradiation detection device 1150 may include a solid electrolyte pellet 1110 made of the polycrystalline material described above. The solid electrolyte pellet 1110 may be manufactured similar to the solid electrolyte pellet 110′ described above. Like the irradiation detection device 350, the irradiation detection device 1150 includes a heater stick 1151. As shown in FIG. 11A, the heater stick 1151 may be composed of an alumina plate 1152 with screen-printed electrical tracks (not shown). The screen-printed electrical tracks 353 may be platinum (Pt) tracks. The screen-printed electrical tracks may be located on one side of the heater stick 1151 (e.g., the back of the heater stick 1151). The heater stick 1151 may also include screen-printed thermocouple tracks 1154. The thermocouple tracks 1154 may be Au/Pt thermocouple tracks. The thermocouple tracks 1154 may be located on the other side of heater stick 1151 relative to the electrical tracks. For example, the thermocouple tracks 1154 may be located on the front of the heater stick 1151. The thermocouple tracks 1154 may allow for accurate temperature sensing of the solid electrolyte pellet 1110. The heater stick 1151 may be about 3 cm to about 5 cm in length and about 0.5 cm to about 2 cm wide, for example, about 1 cm wide.

The heater stick 1151 may be inserted inside a cylindrical stainless-steel pipe 1155. The pipe 1155 may be inserted inside a Swagelok stainless steel Ultra-Torr Vacuum Fitting (RA-TORR SS) 1156, such that all the temperature control and sensor wires 1157 may exit the back end of the pipe 1155 (away from the solid electrolyte pellet 1110) as shown in FIG. 11C. The wires 1157 may include a power supply wire 1157a, a temperature sensor wire 1157b, a working electrode wire 1157c, and other wires as shown in FIG. 11A. This assembly was inserted into a stainless-steel box 1158 with a custom hole drilled on one end for the back end 1159 of the Swagelok fitting 1156 to stand out with its wires 1157 as shown in FIGS. 11A-11C. The box 1158 can be manually opened for easy sample access. The box 1158 may be surrounded by Kapton tape 1162 on all sides to allow for electrical insulation with its surroundings.

A borosilicate glass tube 1161 may be put around the detection device 1150 to act as a heat shield and prevent partial thermal leakage as shown in FIG. 11C. Two insulated electrical leads 1132 supporting electrical conductivity measurement (impedance) may be connected to the solid electrolyte pellet 1110 via wires 1131 that are bonded to the electrodes 1130 using silver paste as shown in FIG. 11D. The electrodes 1130 may be Pt electrodes. The electrodes 1130 may be a plate of sputtered Pt film. Alternatively, the electrodes 1130 may be Pt pads. These insulated electrical leads 1132 may be connected externally to BNC connectors 1133 to enable a secured connection to the electrical testing equipment as shown in FIG. 11B.

The solid electrolyte pellet 1110 may be bonded to the end of the heater stick 1151 (e.g., near the thermocouple tracks 1154) with a ceramic paste (e.g., Ceram-Bond©) that was first dried with a hand-held heater gun for 150 min and then subsequently dried by heating the heater stick up to 300° C. for one hour. The actual sample temperature in the custom heater stick 1151 may then be calibrated according to the protocol described in the section entitled heater stick temperature calibration below. FIG. 17 shows a close-up image of the solid electrolyte pellet 1110 connected to the measurement device 1150. As shown in FIG. 17, the polycrystalline ceramic conductor 1100 may include a solid electrolyte pellet 1110 and an electrode 1130. The electrode 1130 may include one or more wires 1131. The wires 1131 may be attached to the insulated electrical leads 1132, which are in turn externally connected to electrical testing equipment as described above in Example 2.

### In Situ Gammacell Irradiator Measurements:

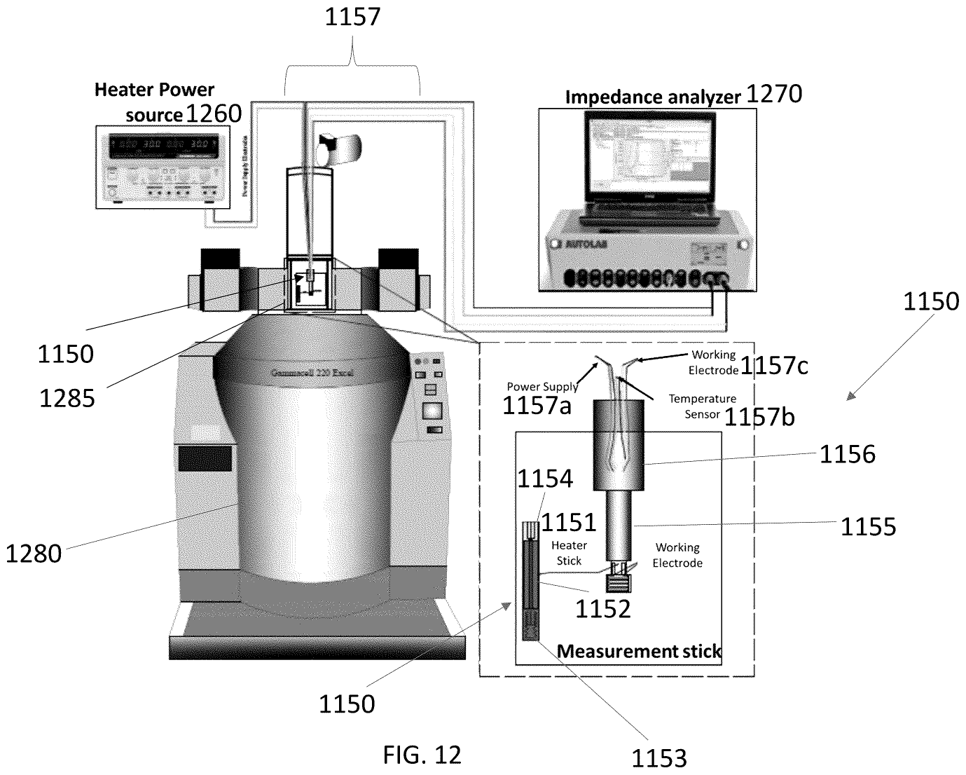

FIG. 12 shows the in-situ heater/measurement device of FIGS. 11A-111D, composed of the heater stick 1151, connected to a heater power source 1260 rated for (10V/0.5 A) and an impedance analyzer 1270. The device 1150 may sit inside the reactor main chamber of an irradiator 1280 (e.g., a Gammacell) and be connected through the top via one or more wires as shown in FIGS. 9 and 12. The device 1150 may be lowered into the irradiator 1280 through an elevator 1285 as described previously.

### Electrical Measurements:

Measurements were performed by continuously irradiating the solid electrolyte film 110 at a dose rate of 35 Gy min⁻¹ and heating up to the highest temperature, then measuring the impedance on the way back down incrementally and allowing the solid electrolyte film 110 to equilibrate for 5 minutes at each temperature step. All EIS measurements were performed with an Autolab PGSTAT302N Impedance Analyzer. A 200 mV amplitude was necessary to achieve a sufficient current response in the highly resistive samples. The frequency range was 0.01 Hz to 1 MHz.

### Bulk Ionic Transport:

Several features of the physics associated with bulk and grain boundary ionic transport in polycrystalline ionic conductors are summarized below.

Ion transport in solid electrolytes is a thermally activated hopping process. Neglecting microstructural effects, then the bulk ionic conductivity σᵢₒₙ can be defined to a first approximation based on Equation 4:

$${σ}_{ion} = {c}_{i} \cdot {q}_{i} \cdot {μ}_{i} = {c}_{i} \cdot {q}_{i} \cdot {μ}_{0} exp ( - \frac{Δ {H}_{m , i}}{kT} ) , \qquad ( 4 )$$

where cᵢ is the concentration of mobile ionic species i, qi their net charge, μᵢ their mobility, μ₀ the mobility preexponential term, k the Boltzmann constant, T temperature in degrees Kelvin, ΔH_{m,i} the migration enthalpy. Doping to introduce lattice defects is a common strategy to enhance cᵢ but may come with drawbacks due either to limited dopant solubility, or in the case of highly doped systems (approximately >5-10 at %), defect-dopant association or longer-range defect ordering that contribute to higher ΔH_{m,i}. Gd doped CeO₂, an oxygen ion conductor where oxygen ions migrate through the lattice by hopping via mobile oxygen vacancy sites (V_{Ö}), introduced into the systems by addition of the substitutional dopant Gd′_{Ce}, with net negative charge to the lattice, through the following charge balance relation: [Gd′_{Ce}]=2[V_{Ö}]. The migration enthalpy may range from 0.7-0.9 eV depending on the doping level of the system.

### Interfacial Ionic Transport in Polycrystalline Solids:

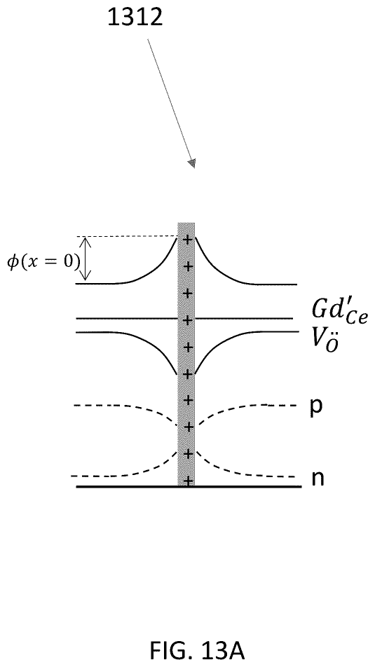

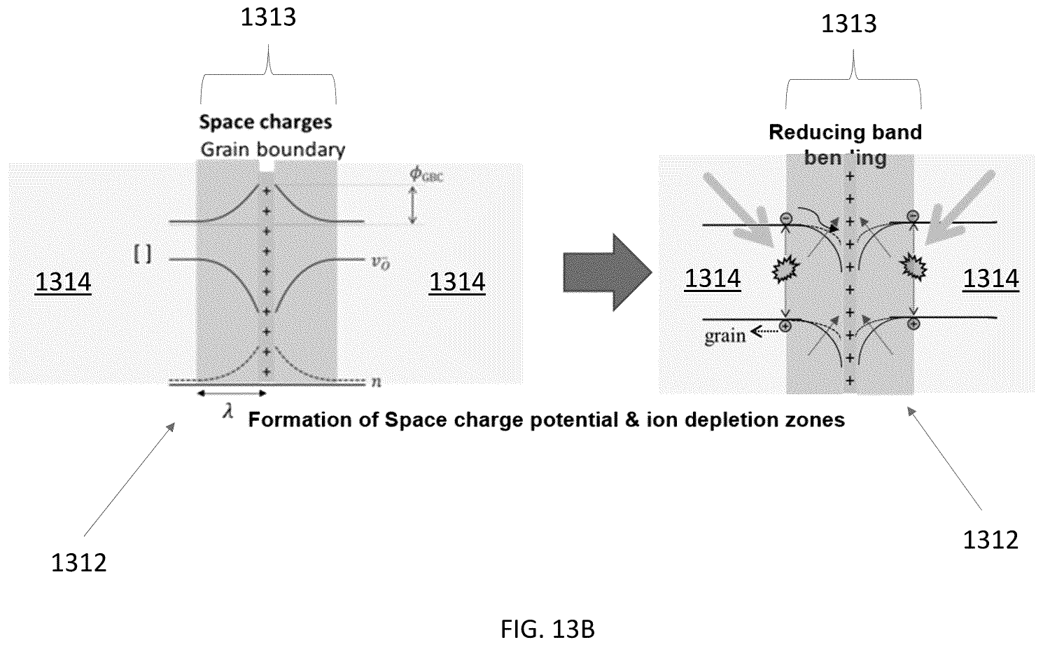

While solid electrolytes and their selected dopant levels may be optimized to achieve the highest ion conductivities, the materials used are polycrystalline. These grain boundaries may act as barriers to the flow of ions between the grains, leading at times, to many orders of magnitude increases in ionic resistivity. Over the years, with many efforts in powder purification, the resistance of the grain boundary remains and relates to space charge barriers that develop due to the presence of net charges in the core of the grain boundaries (due, for example, to segregation of charged impurities) result in built-in electric fields in the adjacent grains. These fields induce a redistribution of mobile charged defects in a so-called space charge zone. The physics is no different than space charge effects at grain boundaries in electronic semiconductors (e.g., polycrystalline Si or Ge) with one difference being the nature of the mobile charge carriers (for semiconductors, electrons, and holes while for wide band gap solid electrolytes, ionic defects). For ionic conductors, the majority ionic carriers become depleted in the space charge zone, resulting in orders of magnitude higher local ionic resistances. Herein a simplified dilute limit picture is considered and the Mott-Schottky case is applied to describe the space charge zone. In this model the dopant profile is assumed flat and frozen-in during processing and only the oxygen vacancies can redistribute within the proximity of the grain boundary. The spatial profiles of the charged majority oxygen vacancy and minority electronic species are shown in FIG. 13A.

The corresponding Boltzmann distribution expression describing the distribution of carriers is given below in Equation 5 with z being the relative charge of the defect, c_{gb} & c_{bulk} the grain boundary and bulk defect concentrations and Δϕ_{gb}(x) the spatially dependent grain boundary potential. The majority ionic oxygen vacancy defect concentration and electronic hole defect may be depleted, while the minority electron concentration n may be accumulated within the space charge region.

$$\frac{{C}_{gb} ( x )}{{c}_{bulk}} = {e}^{- \frac{ze Δϕ ( x )}{{k}_{B} T}} \qquad ( 5 )$$

The conductivity of the grain boundary across the space charge zone can then be defined using Equation 6:

$${σ}_{gb} ( x ) = {σ}_{bulk} {e}^{- \frac{ze Δϕ ( x )}{{k}_{B} T}} , \qquad ( 6 )$$

which describes how the space charge zone conductivity relates to the bulk conductivity (σ_{bulk}) and the depletion of ionic carriers within the depletion zone following the spatial distribution of the space charge potential in the vicinity of the interface. Equation 6 shows that as space charge potential tends to zero then the grain boundary conductivity tends toward the bulk conductivity.

The potential distribution may be found by solving Poisson's equation, but no exact analytical solution can be obtained. However, an approximate expression in the case of sufficiently large space charge potentials can be derived

$$( i . e . , \frac{2 ze Δϕ ( 0 )}{{k}_{B} T} > 3 ) .$$

In the Mott-Schottky case the expression for grain boundary resistance and its relation to the space charge potential in the grain boundary core (Δϕ(0)) can be obtained by integrating Equation 6 to yield Equation 2 (reproduced again below for reference):

$$\frac{{R}_{gb , tot}}{{R}_{bulk , tot}} \approx \frac{{δ}_{GB}}{{d}_{g}} \cdot \frac{{e}^{\frac{ze Δϕ ( x )}{{k}_{B} T}}}{\frac{2 ze Δϕ ( 0 )}{{k}_{B} T}} , \qquad ( 2 )$$

where d_{g} is the grain edge length (assuming a simplified brick layer model) and δ_{GB} is the effective grain boundary space charge width, defined as δ_{GB}=2λ, where the grain boundary core contributions may be neglected and a being the Mott-Schottky space charge width as shown in Equation 7 below:

$$λ = 2 {( \frac{k T ε}{2 {e}^{2} [ {Gd}_{Ce , bulk}^{′} ]} )}^{0.5} {( \frac{e Δϕ ( 0 )}{kT} )}^{0.5} , \qquad ( 7 )$$

which relates to the Debye length L_{D} (first term in Equation 7 in parenthesis) and the space charge potential. Equations 2 and 7 are approximations for the Mott-Schottky case. It is also possible to derive an approximate solution for another scenario, called the Gouy-Chapman case, that considers the dopant to also be mobile and able to redistribute in the space-charge zone throughout the measurement conditions. In that case, the space charge width is smaller and equates to the Debye length (i.e., λ=L_{D}). The Gouy-Chapman case, however, may only be valid in ceria when the dopant is mobile, which is typically only true at elevated sintering temperatures (>1000° C.) and is generally not considered for lower temperature conductivity measurements, warranting the use of the Mott-Schottky approximation herein.

The Mott-Schottky approximation may be due to large errors on the extracted grain boundary space charge potential from conductivity data, as non-uniform concentrations of the dopant profile in the grain boundary vicinity arise during high temperature or high humidity processing conditions and end up subsequently frozen in upon cooling. This may lead to a so-called restricted equilibrium scenario, which is out of equilibrium and lies between the Mott-Schottky and Gouy-Chapman cases. This can be evaluated via numerical simulations and knowledge of the dopant profile frozen in, which may be impractical for most experimental studies.

While most studies of GB resistivity in ionic conductors derive a single effective barrier potential, GBs in a given solid are known to differ, depending on the misorientation angle between adjacent grains, impacting impurity and defect segregation, leading ultimately to a broad range of GB potentials that cannot be easily distinguished from simple electrical measurements. This is exacerbated by the fact that electrical measurement techniques measure the weighted average of all current paths across the numerous grain boundaries, dominated by the paths of least resistance. This implies that the use of approximate analytical solutions for the fitting of grain boundaries space charge potentials based on electrical measurements may be used to consider general trends.

### Structural Characterization

FIG. 14 shows the SEM micrograph of the fractured surface of the pristine 3GDC solid electrolyte pellet 110′. Using a Matlab script for analyzing the grain structure from the image, an average grain size of approximately 400 nm was obtained.

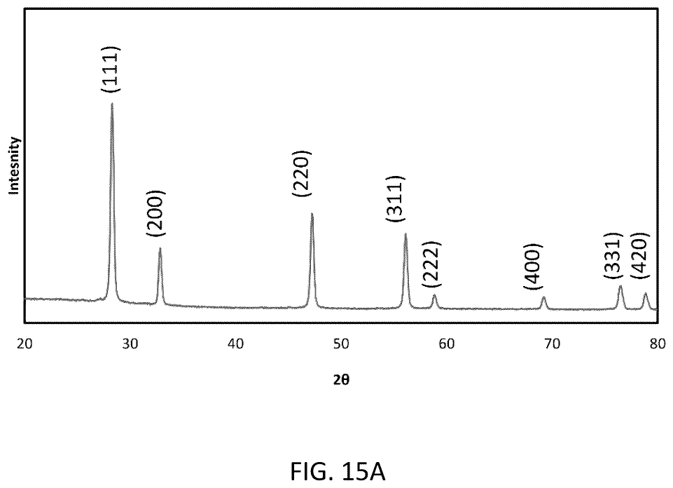

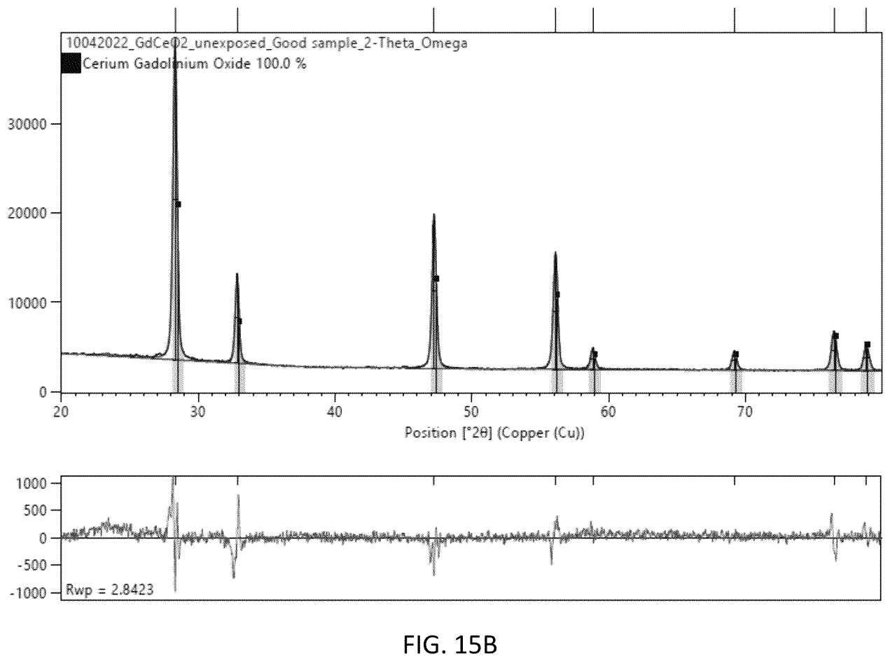

The XRD results of the pristine 3GDC solid electrolyte pellet 110′ sintered at 1300° C. are shown in FIGS. 15A-15B. The sample showed reflection peaks (111), (200), (220), (311), (222), (400), (331) and (420) at 2θ of 28.30, 32.85, 47.25, 56.13, 58.86, 69.21, 76.49 and 78.87 respectively. From the Rietveld fitting, the XRD pattern agrees with expectations for the face-centered cubic structure of CeO₂.

FIG. 16 shows the Raman spectra of the surface of the GDC solid electrolyte pellet 110′ recorded using 473 nm wavelength illumination. The major peak at 464.24 cm⁻¹ is consistent with the symmetric oxygen breathing mode around the Ce⁴⁺ cation with F₂g symmetry and relates to bond length changes between O—Ce—O. On the other hand, the two peaks around approximately 550/600 cm⁻¹ may be associated with the presence of the dopant ions and oxygen vacancies. The peak at 550 cm⁻¹ may exist when oxygen vacancies are present in the system. Moreover, the peak at 600 cm⁻¹ may be activated by the presence of aliovalent dopants with the addition of Gd³⁺ and may originate from the F₁u (LO) phonon mode, usually only IR active, becoming Raman active due to the local lattice distortion relaxing symmetry rules. The presence of oxygen vacancies in the system can be confirmed, as would be expected through the incorporation of aliovalent dopants such as Gd according to the following defect chemical reaction:

Gd₂ [symbol] →2Gd′_{Ce}+V_{Ö}+3O_{O}^{x}

Table 2 below outlines the details of the geometries of the solid electrolyte film 110 samples A, B, and C.

TABLE 2
Details of sample name, thickness and active area

| Name | Thickness | Active Area | Electrode |
|---|---|---|---|
| Sample A | 800-micron | 5 × 9 mm | yes |
| Sample B | 1 mm | 5 × 5 mm | no |
| Sample C | 1 mm | 5 × 5 mm | no |

### Additional Radiation Stability Data (XRD):

Table 3 outlines the structural parameters for the 3GDC solid electrolyte pellet 110′ sample C series under various γ irradiation conditions.

TABLE 3
Structural parameters for the 3GDC solid electrolyte pellet 110′
sample C series for various γ irradiation conditions.

| Parameters | 0 Kgy | 500 Kgy | 1000 Kgy |
|---|---|---|---|
| Lattice Constants | 5.412 | 5.412 | 5.412 |
| Å, a = b = c | | | |
| Volume | 158.516 | 158.516 | 158.516 |
| (Å)³ | | | |
| March/Dollase | 0.89 | 0.90 | 0.80 |
| (Preferred orientation) | | | |

Occupancy

| | | | |
|---|---|---|---|
| Ce | 0.970 | 0.970 | 0.970 |
| Gd | 0.0292 | 0.0297 | 0.0298 |

### Correcting for Porosity:

Since the sample may not be 100% dense, the resistance and capacitance values obtained from the impedance spectra may need to be corrected. This can be done using the Bruggeman symmetric model for 3-3 connectivity of spherical grains and pores (assuming the latter to have zero conductivity) using Equation 8.

$${R}_{corrected} = {R}_{porous} ( 1 - \frac{3}{2} f ) , \qquad ( 8 )$$

where f is the volume fraction of pores. Other porosity correction models can also be considered, such as the Bruggeman asymmetric model or the Archie's model. Others have also demonstrated a good agreement between similarly porosity-corrected data for porous nano-YSZ and dense spark plasma-sintered YSZ specimens of comparable grain size. The porosity corrected capacitance can then be determined by assuming that the time constant (RC) of each arc remains unchanged by the correction given in Equation 9:

$${R}_{corrected} {C}_{corrected} = {R}_{porous} {C}_{porous} \qquad ( 9 )$$

### Heater Stick Temperature Calibration:

The temperature scale on a heater stick may be calibrated by characterizing the dark conductivity of the same sample that was characterized in a tubular furnace, as displayed in FIGS. 6A-6C. Considering the small heating volume of the heater stick chip relative to the solid electrolyte film pellet, this step may be useful to determine the actual temperature of the solid electrolyte film supported on the heater stick.

As seen in FIG. 24A, two semicircles were once again obtained. These impedance spectra match well with the observations in FIG. 7A and by fitting with the same equivalent circuit, capacitance values (high frequency: 2.6×10⁻¹¹ F, low frequency: 4.5×10⁻⁹ F, respectively) can be obtained allowing the similar assignment of bulk (high frequency) and grain boundary (low frequency) contributions. To calibrate the effective temperature of the samples A, B, and C of the solid electrolyte pellet 110′, the bulk resistance values obtained on the heater stick were cross-referenced with those measured in the furnace, allowing the true temperature of the solid electrolyte pellet 110′ samples A, B, and C to be calculated (see FIG. 24B). To verify the validity of this cross-referencing, the grain boundary resistance values were then plotted as a function of the effective temperature with those obtained in the furnace. As displayed in FIG. 24C, the grain boundary values and the effective temperatures calculated by cross-referencing the bulk resistance value match well with the grain boundary values obtained for the solid electrolyte pellet 110′ heated within the furnace, confirming the adequacy of the calibration protocol.

### High Frequency Close-Up of Nyquist Plot:

FIG. 25 illustrates a high frequency close-up of the complex impedance response obtained under open-circuit conditions for the 3GDC solid electrolyte film 110 pellet measured at 23.8° C. in the dark and under gamma irradiation (Dark vs Gamma Ray). FIG. 25 shows how the bulk impedance changes only very slightly under irradiation.

### Reproducibility and Reversibility:

FIG. 26A displays the impedance of the sample measured at 67° C. (before-during-and-after exposing it to approximately 20 Grey/min Gamma irradiation). The fitting and porosity corrected results are summarized in Table 4. As shown in the impedance spectra in FIG. 26A, the high frequency semi-circle, associated with bulk transport remains predominantly unchanged (small 2% change), before and after gamma irradiation, while the lower frequency impedance associated with grain boundary resistance is depressed by 240% under irradiation and returns to its dark value upon removal from the radiation source within a variance of 4%. The small changes in the bulk and grain boundary data upon return to dark conditions may be associated with the low accuracy of the manual temperature control. As can be seen in FIG. 26B, the single frequency measurements over time show that the total electrical response is fully reversible as the solid electrolyte film 110 is cycled in and out of the irradiator 1280 (e.g., a gammacell 220). The frequency is selected based on the impedance such that it captures part of the resistance of the grain boundary, while also remaining experimentally accessible (measurement duration for frequencies below 100 mHz is so slow that it may lead to errors given the manual temperature control).

TABLE 4
Impedance fit results (Resistance and Capacitance) of the
spectra's presented in FIG. 26A, corrected for porosity.

| | | Bulk | | Grain Boundary | |
|---|---|---|---|---|---|
| | | Resistance | Capacitance | Resistance | Capacitance |
| | | (ohms) | (F) | (ohms) | (F) |
| | before | 7.79E+06 | 1.02E−11 | 6.79E+09 | 4.92E−09 |
| | After | 7.63E+06 | 9.54E−12 | 6.56E+09 | 4.95E−09 |
| | Gamma | 7.94E+06 | 9.48E−12 | 1.98E+09 | 4.35E−09 |
| Before/Under | ratio of | 0.981174749 | | 3.425445022 | |
| Irradiation | Conductances | | | | |
| | percentage | 2% | | −243% | |
| | change | | | | |
| Before/After | ratio of | 1.021197051 | | 1.035063245 | |
| Irradiation | Conductances | | | | |
| | percentage | −2% | | −4% | |
| | change | | | | |

In terms of response time, based on the single frequency relaxation curves, the devices disclosed herein may take several 10's of seconds to reach steady state under irradiation at 67° C. As established previously, the response rate of the optoionic response may be controlled by the rate of anion diffusion in and out the space charge region. By using values of the bulk ionic diffusivity (Do) in 3 atm % Gd doped CeO₂, that depends on the vacancy diffusivity Dₒ≈nᵥDᵥ multiplied by the site fraction of oxygen vacancies to oxygen ions in the lattice

$${n}_{v} = \frac{[ V ]}{[ 0 ]} ,$$

a diffusion time

$$τ = \frac{{x}^{2}}{{D}_{o}}$$

can be calculated within the length of a space charge width (approximately 1-2 nm). From these values, a diffusion coefficient equal to 1.25×10⁻¹⁴ to 5.33×10⁻¹⁴ cm²/s at 50-70° C. may be obtained, that leads to expected diffusion times of approximately 9 to 40 seconds. These time scales align with the single frequency relaxation data obtained at 67° C. Alternative ion conducting material systems, with faster bulk ionic mobilities, such as Li⁺, OH⁻, or H⁺, may be expected to achieve orders of magnitude faster response times. This could, in turn, be more enabling for certain technologies such as spectroscopy.

### Constriction Model:

This simplified model aids in understanding the temperature dependence of the measured resistance of a polycrystalline solid electrolyte (e.g., the solid electrolyte pellet 110′ in FIG. 1C) under steady state irradiation conditions. The key elements are summarized herein to explain how the calculation of the 10% constriction area at room temperature was derived.

Considering the naturally expected distribution of space charge potentials that exist at grain boundaries in polycrystalline oxides, and the fact that for a given light intensity only fraction of barriers (starting with the smallest barrier) can be fully collapsed, then the current pathway through the material may be modelled as a percolating pathway. This observation arises from the fact that the resistance of grain boundaries, whose space charge potential have not collapsed will be high, especially at lower temperatures (due to the higher activation energy), and that the current may prefer to flow through the grain contact points with a space charge potential that collapsed to zero under irradiation. In that scenario, current flow may possess a resistance R^{(//)}_{gb,tot} with bulk-like behavior, but only represent a fraction of the total film volume that can be described using Equation 3 (reproduced below for reference):

$$\frac{{R}_{gb , tot}^{( / / )}}{{R}_{bulk , tot}} = {f}_{path} , \qquad ( 3 )$$

where fₚₐₜₕ is defined as a lumped geometrical factor accounting for the decreased conductive area (as compared to the sample's full conductive area) and the tortuosity, the elongation of the pathway. The whole system may then be described as two parallel resistances, where the measured resistance R′_{gb,tot} is given by Equation 10:

$$\frac{1}{{R}_{gb , tot}^{′}} = \frac{1}{{R}_{gb , tot} ( T )} + \frac{1}{{R}_{gb , tot}^{( / / )} ( T )} , \qquad ( 10 )$$

where the main parameter being impacted by light is the factor fₚₐₜₕ and reaches a maximum value of 1 when all the grain boundaries become non-blocking (space charge potential of zero).

### Mean Penetration Depth:

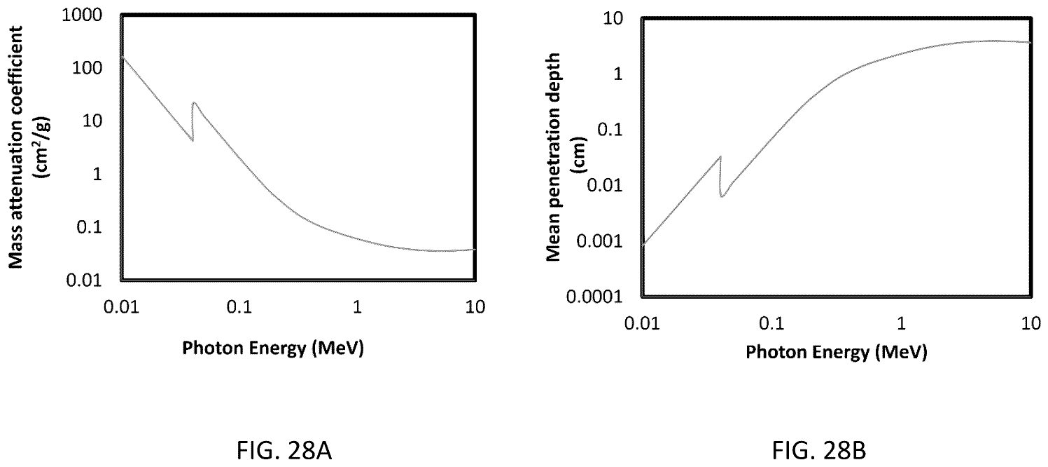

The program “XCOM” (NIST XCOM: Element/Compound/Mixture) may be used to calculate the attenuation coefficients for undoped CeO₂ as a first approximation. This information may also be useful in order to determine whether the incident radiation may interact with the entirety of the sample volume. FIGS. 28A and 28B show plots of total mass attenuation coefficients and mean penetration as a function of photon energy, respectively. At a photon energy of 1 MeV, the mean penetration in CeO₂ is approximately 1 cm.

Temperature Dependance of fₚₐₜₕ:

To understand the temperature dependence of the opto-ionic effect referred to here, the physics that relates to the charge trapping kinetics at grain boundaries in semiconductors under illumination may be considered. Generally, illumination of a polycrystalline semiconductor may produce a non-equilibrium distribution of both majority and minority electronic carriers near the grain boundaries 1312. The minority electronic n type carriers (see FIGS. 13A-13B) may drift rapidly towards the boundaries 1312 due to the field gradient in the space-charge regions 1313 and away from the bulk 1314. This flux of minority carriers to the boundary and their subsequent trapping into the interface states, may lower the net charge on the boundary. This in turn may reduce the grain boundary space charge potential and surrounding band-bending. A steady state condition may be reached when the flux of minority carriers down the now reduced potential gradient is balanced by a flux of majority carriers to the interface states. This condition can be stated under zero applied bias using Equation 11:

$$2 {qD}_{n} \frac{dn}{dx} = 2 cAexp ( \frac{Δφ ( 0 )}{kT} ) , \qquad ( 11 )$$

where Dₙ is the minority carrier diffusion coefficient, n is the concentration of minority electronic carriers, the c parameter describes the majority (electronic) carrier capture rate at grain boundaries, and A is the pseudo-Richardson coefficient. The equilibrium recombination velocity is then defined using Equation 12:

$$S = \frac{1}{q} {v}_{th} {σ}_{n} {( 2 ε {ε}_{0} {N}_{t} Δφ ( 0 ) )}^{0.5} exp ( \frac{Δφ ( 0 )}{kT} ) , \qquad ( 12 )$$

where vₜₕ is the thermal velocity of minority electronic carrier, σₙ capture cross-section of a filled interface state for a minority carrier and Nₜ the density of interface trap states. The recombination velocity, may be relevant to understanding the physics of charge carrier trapping at the interface and is fundamentally split between 1) the extent that the space charge fields can split and collect the photogenerated charges and 2) on the ability of the core grain boundary traps to maintain the trapped charges, reflected by the capture cross section of the trap states at the grain boundary 1312 and the thermal velocity of the minority charge carriers.

When considering its overall temperature dependence, Equation 12 can be inspected to observe that a natural temperature dependence exists as an exponential term, which may relate to the temperature dependent weakening of the field lines in the space charge region 1313 (i.e., exp(Δφ(0)/kT)). Moreover, another term in this equation, also expected to exhibit a strong temperature dependence, is σₙ, the minority carrier capture cross section. Although the temperature dependence of charge carrier recombination for the material system disclosed herein has never, to the best of our knowledge, been measured, other materials systems and experimentally measured recombination lifetime temperature dependencies may be considered for comparison. For example, p-type polycrystalline silicon, an indirect band gap semiconductor exhibits very similar space charge properties as ceria (positively charged grain boundary core).

Reports have shown that contrary to single crystalline silicon that exhibits a direct band recombination process with a negative temperature dependence of the carrier lifetimes, in the case of polycrystalline silicon, defects at grain boundaries 1312 may control the recombination process, and this may lead to a positive thermally activated temperature dependence. This positive thermally activated temperature dependence of the minority carrier lifetime at grain boundaries 1312 may be associated with the capture cross section obeying a Cascade Phonon Capture mechanism, typical for Coulomb attraction centers, such as shallow impurities or charge defect states. The general temperature dependence of the capture cross sections can be expressed as an Arrhenius equation according to Equation 13:

$${σ}_{n} ( {E}_{t} , T ) = {σ}_{0} ( {E}_{t} ) exp ( - \frac{Δ {E}_{σ} ( {E}_{t} )}{kT} ) , \qquad ( 13 )$$

where σ₀ (Eₜ) reflects the fact that capture cross section of a defect posses' inherent properties that may depend on the type of defect and the energy depth of that level with respect to the conductance band edge, Eₜ·ΔE_{σ}(Eₜ), may also depend on the type of defect, but predominantly depends on the depth of the energy levels and its relative position to the Fermi level (i.e., ΔE_{σ}(Eₜ)˜(Eₜ−E_{F})) and is representative of the main mechanism controlling the population density of trapped carriers, which may be a thermalization step instead of direct recombination. In the case of the Cascade phonon recombination mechanism, the value of ΔE_{σ}(Eₜ) may be negative, which may be indicative of the fact that at higher temperatures the capture cross section may become smaller. This reflects the fact that there is a probability of the trapped defect thermalizing due to the absorption of phonons, which can depopulate the trapped states before recombination occurs (i.e., the population density of trapped charge carrier is controlled by their thermalization rate to the conduction band).

Combining those two facts: temperature dependence of space charge region 1313, which may scale with the space charge potential (Δϕ(0)˜0.2 eV), and the capture cross section, which may scale with the energy of the trap state in the band bap (ΔE_{σ}(Eₜ)), a rather large negative exponential dependence on temperature for the grain boundary recombination kinetics may be expected, leading to a similar temperature dependence of the fₚₐₜₕ parameter. Depending on the value of ΔE_{σ}(Eₜ), the activation energy of fₚₐₜₕ may indeed reach similar magnitudes, but opposite in sign, to that of bulk ionic conduction, and therefore may lead to a nearly flat overall temperature dependence as observed herein.

### Temperature and Degradation Monitoring Through High Frequency Impedance Measurements:

The radiation response vs. temperature of the irradiation detection devices disclosed herein (e.g., irradiation detection devices 100, 150, 350, or 1150) may be monitored by either simultaneously measuring the bulk and grain boundary resistance at different frequencies or by measuring intermittently between the different frequencies the bulk and grain boundary resistance under operation of irradiation detection devices.

Measuring the impedance of the irradiation detection devices disclosed herein at higher frequencies (e.g., about 1 KHz to about 10 GHz, for example about >10 MHz to about 100 MHz) may allow for temperature and/or degradation monitoring. For example, measuring the resistance of the irradiation detection devices 100, 150, 350, or 1150 at high frequencies may allow for the determination of the bulk (also known as the grain) conductivity data of the polycrystalline material, which may not exhibit a radiation response but may present a natural temperature dependence that may be used to measure and calibrate the temperature and expected response of the radiation detection device 150. The impedance of the detection devices disclosed herein may be measured at a higher frequency before and after operation of the device to confirm whether there is any degradation of the polycrystalline material. A permanent change in the bulk (e.g., the grain) conductivity of the polycrystalline material may indicate degradation of the irradiation detection device. In contrast, a temporary change in the bulk (e.g., the grain) conductivity of the polycrystalline material may indicate a change in temperature and not degradation of the polycrystalline material. Only the grain boundary resistance of the polycrystalline material changes under irradiation. By calibrating the temperature of the dependence of the bulk (e.g., the grain) conductivity of the polycrystalline material in the dark, it can be determined whether the amount of grain boundary resistance change under irradiation is due to a temperature change or the observed radiation ionic effect. Thus, the temperature of the irradiation detection devices disclosed herein may be calibrated based on the bulk (e.g., the grain) resistance of the polycrystalline material by measuring the high frequency impedance of the polycrystalline material as a function of temperature in the dark (e.g., without irradiation) and plotting the resistance as a function of frequency to obtain the linear coefficient of proportionality.

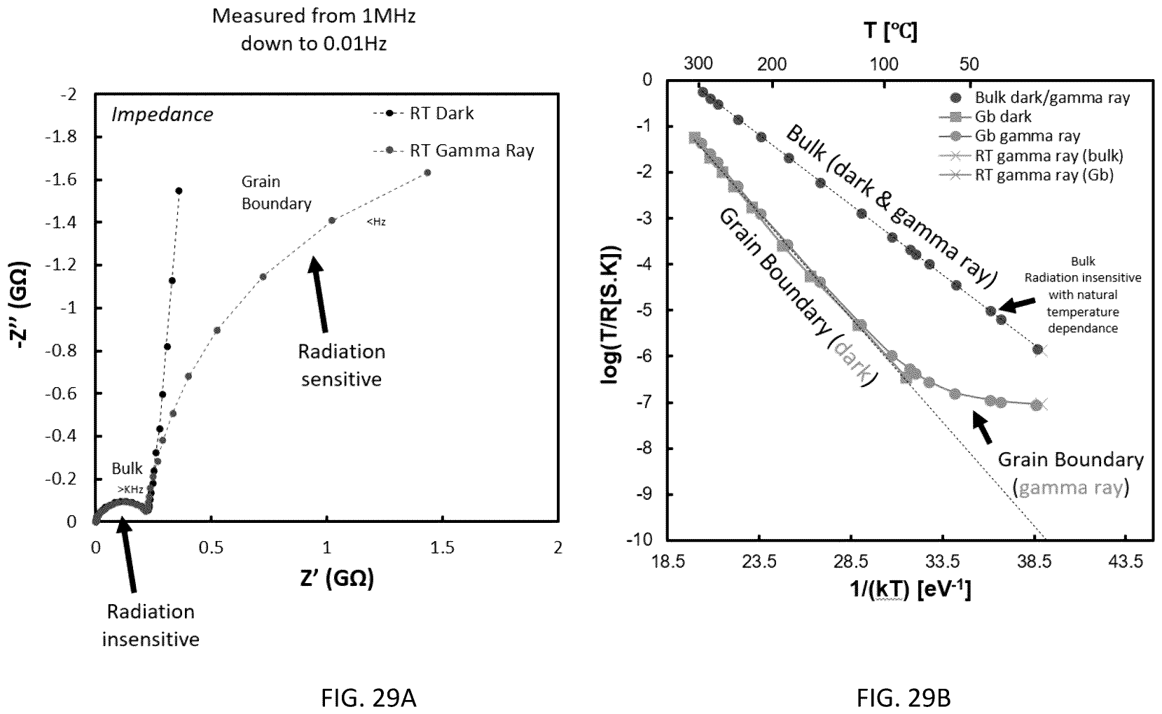

The resistance associated to the bulk (e.g., the grain), which does not exhibit a radiation response may still retain a natural temperature dependance may allow for the monitoring of in-situ environmental temperature variations as illustrated in FIGS. 29A-31B. At lower frequencies (e.g., about 1 KHz to about 50 mHz) the reversible radiation response may be tracked.

This may allow for addressing, for example, the impact of environmental temperature variations during operation of the irradiation detection devices disclosed herein on the dark resistance without the need for active cooling, thus ensuring good temperature insensitivity in the irradiation detection devices radiation response.

Moreover, with a reference temperature sensor (e.g., a thermocouple as described in Example 3), the high frequency resistance may be used to assess the degradation of the radiation detection devices disclosed herein over extended periods of operation. A reference temperature sensor may be used to correlate with the high frequency measurements to determine how much the observed radiation response in the irradiation detection devices disclosed herein (e.g., irradiation detection devices 100, 150, 350, or 1150) arises from heating, grain boundary modulation or irreversible degradation. For example, a reference thermocouple may allow for tracking an irreversible change (e.g., degradation) in conductivity of the bulk of the polycrystalline material that is not associated with a temperature change tracked by the thermocouple These features combined may allow for the design of simple, miniaturized radiation detection devices, such as the irradiation detection devices 100, 150, 350, and 1150 disclosed herein, that may operate in a variety of environments.

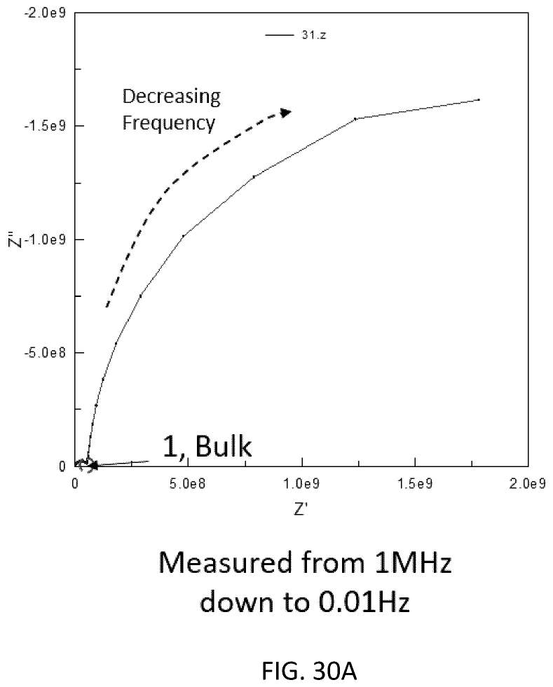

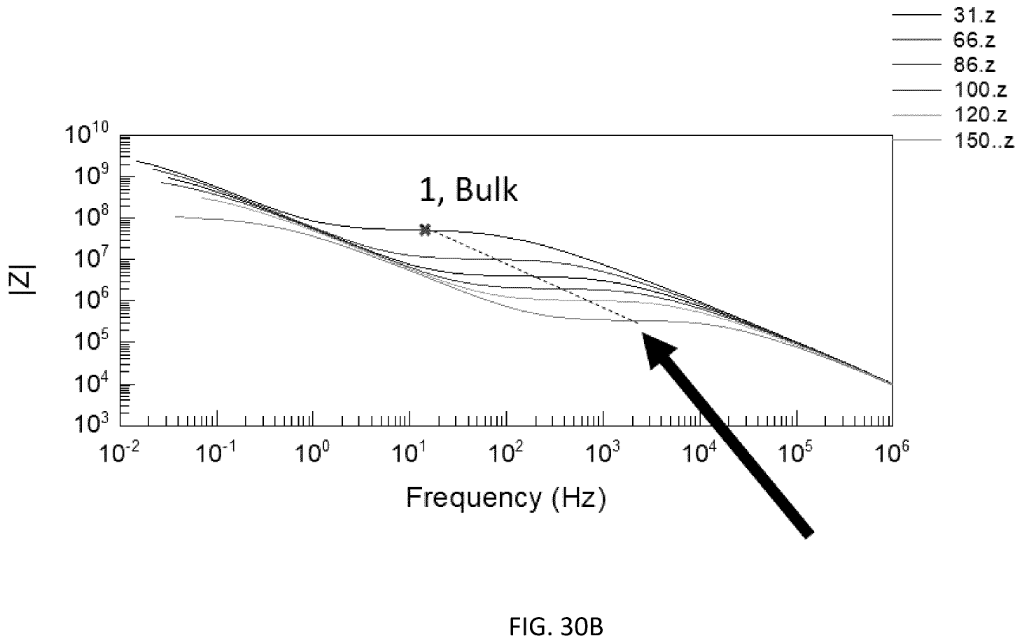

FIGS. 30A-30B illustrate the temperature tracking by measuring bulk resistance at a high frequency (e.g., about 1 KHz to about 10 GHz, for example about >10 kHz to about 100 kHz). The frequency may depend on the type of polycrystalline material used. FIG. 30A displays measured data measured from 1 MHz down to 0.01 Hz. As shown in FIG. 30B, by tracking the value of the plateau region marked with an arrow, at high frequencies, the resistance of the bulk, which does not possess any radiation response, may be tracked. The bulk, however, does possess a natural temperature dependence (as shown in FIG. 30B) that may be used for temperature sensing.

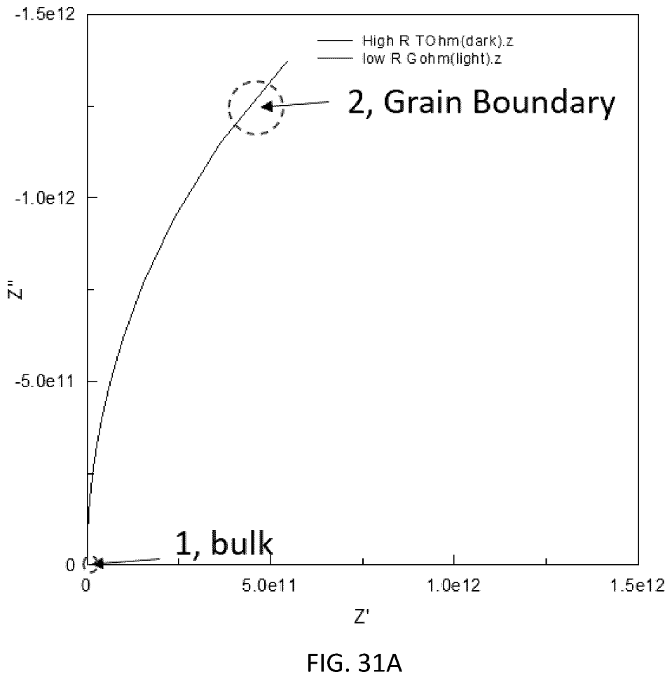

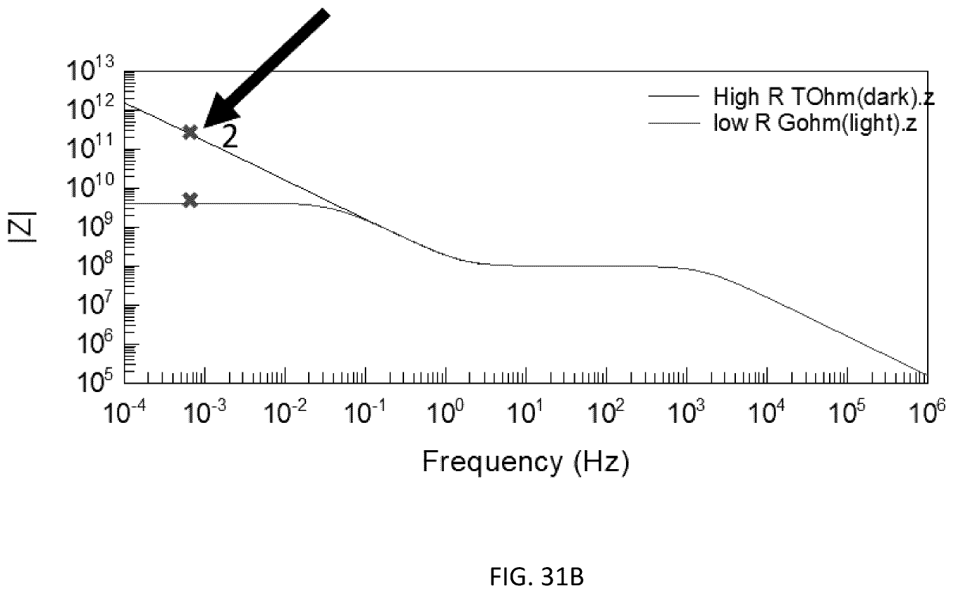

FIGS. 31A-31B illustrate radiation tracking by measuring grain boundary resistance at a low frequency (e.g., <1 KHz). FIG. 31B shows simulated data from 1 MHz down to 0.001 Hz. As shown in FIG. 31B, by tracking the frequency point marked with an arrow and x, the resistance of the grain boundary, which possesses the majority radiation response, may be measured.

### Example 4: A Solid Electrolyte Membrane

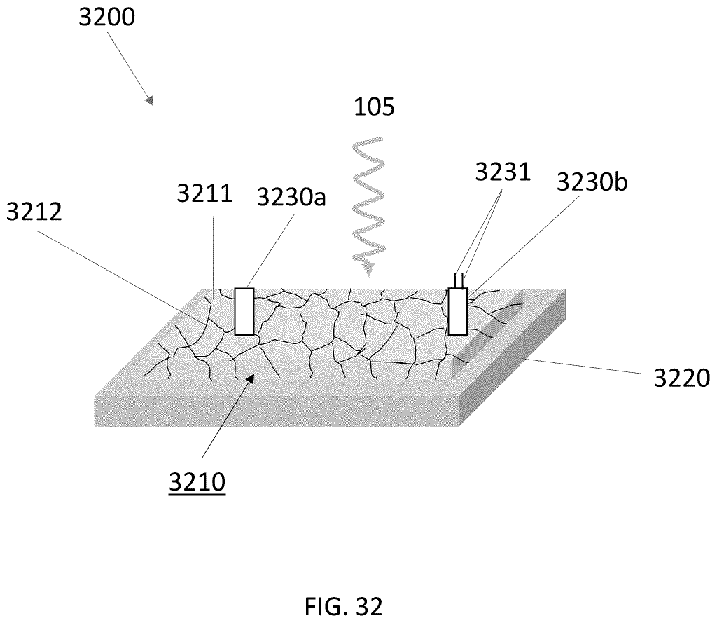

FIG. 32 shows a schematic diagram of another embodiment of an irradiation detection device 3200. The irradiation detection device 3200 may be used in a variety of formats as described above.

The irradiation detection device 3200 may include a solid electrolyte membrane 3210 made of any of the polycrystalline materials disclosed herein. The solid electrolyte membrane 3210 may also be referred to herein as a solid electrolyte thick film. In one embodiment, the solid electrolyte membrane 3210 is an oxygen solid electrolyte membrane. For example, the solid electrolyte membrane 3210 may be a CeO₂ solid electrolyte membrane. The solid electrolyte membrane 3210 may also be doped with any of the materials disclosed herein. In one embodiment, the solid electrolyte membrane 3210 may be a gadolinium (Gd) doped solid electrolyte membrane. The Gd doping may range from about 0.5 atm % to about 40 atm %, for example, about 1 atm % to about 20 atm %. Alternatively, the solid electrolyte membrane 3210 may be a samarium (Sm) doped solid electrolyte membrane. The Sm doping may range from about 0.5 atm % to about 40 atm %, for example, about 1 atm % to about 20 atm %.

The solid electrolyte membrane 3210 may be prepared as described above in the sample preparation section (e.g., by consolidating a powder through applied pressure and high temperature sintering). Other suitable methods for preparing the solid electrolyte membrane 3210 include, but are not limited to, a traditional ceramic consolidation process (e.g., Pressing (uniaxial, isostatic), slip casting, or extrusion), 3D printing, robocasting, palletization, injection molding, physical vapor deposition (PVD), sputtering, thermal evaporation, pulsed laser deposition, chemical vapor deposition (CVD), atomic layer deposition (ALD), a sol-gel process (e.g., spin coat, dip coat, and/or spray coat), tape casting, slip casting, screen printing, phase inversion, and/or extrusion. The preparation of the solid electrolyte membrane 3210 may also include a heat treatment (e.g., a furnace and/or UV irradiation).

The solid electrolyte membrane 3210 may be infiltated with a desired periodic table element (e.g., Al, Ga, Fe, Ti, Pr, Cr, Co, Cu, Mn, B, Li, Na, Sr, Zn, Mg, Y, Zr, Ge, Si, Ca, Pb, P and/or Ni) during the manufacturing process using in-diffusion, segregation, and/or infiltration. For example, a precursor material powder (e.g., a nitrate and/or a citrate) may be infiltated with a desired periodic table element and then exposed to a moderate temperate anneal (e.g., about 200° C. to about 400° C.) to decompose the precursor material and leave the desired periodic table element on the surface of the material. The material may then be used to fabricate solid electrolyte membrane 3210 with the desired periodic table element in the grin boundary of the solid electrolyte membrane 3210.

The solid electrolyte membrane 3210 may be about 2 μm thick to about 2 mm thick. The thickness of the solid electrolyte membrane 3210 may vary depending on the type of polycrystalline material and/or the type of irradiation to be detected. For example, the solid electrolyte membrane 3210 may be about 2 μm, about 5 μm, about 10 μm, about 20 μm, about 30 μm, about 40 μm, about 50 μm, about 60 μm, about 70 μm, about 80 μm, about 90 μm, about 100 μm, about 110 μm, about 120 μm, about 130 μm, about 140 μm, about 150 μm, about 160 μm, about 170 μm, about 180 μm, 190 μm, about 200 μm thick, about 250 μm thick, about 300 μm thick, about 350 μm thick, about 400 μm thick, about 450 μm thick, about 500 μm thick, about 550 μm thick, about 600 μm thick, about 650 μm thick, about 700 μm thick, about 750 μm thick, about 800 μm thick, about 850 μm thick, about 900 μm thick, about 950 μm thick, about 1.0 mm thick, about 1.1 mm thick, about 1.2 mm thick, about 1.3 mm thick, about 1.4 mm thick, about 1.5 mm thick, about 1.6 mm thick, about 1.7 mm thick, about 1.8 mm thick, about 1.9 mm thick, or about 2 mm thick, including all values in between. The solid electrolyte membrane 3210 may range in size depending on the type of detector.

The solid electrolyte membrane 3210 may be circular, semi-circular, rectangular, square, or any other suitable shape. The length solid electrolyte membrane 3210 may range in size from about 5 mm×5 mm to about 2000 mm×2000 mm. For example the solid electrolyte membrane 3210 may be about 5 mm×5 mm, about 6 mm×5 mm, about 5 mm×6 mm, about 6 mm×6 mm, about 7 mm×6 mm, about 6 mm×7 mm, about 7 mm×7 mm, about 8 mm×7 mm, about 7 mm×8 mm, about 8 mm×8 mm, about 9 mm×8 mm, about 8 mm×9 mm, about 9 mm×9 mm, about 10 mm×9 mm, about 9 mm×10 mm, about 10 mm×10 mm, about 20 mm×10 mm, about 10 mm×20 mm, about 20 mm×20 mm, about 50 mm×20 mm, about 20 mm×50 mm, about 50 mm×50 mm, about 100 mm×50 mm, about 50 mm×100 mm, about 100 mm×100 mm, about 150 mm×100 mm, about 100 mm×150 mm, about 150 mm×150 mm, about 200 mm×200 mm, about 500 mm×200 mm, about 200 mm×500 mm, about 500 mm×500 mm, about 1000 mm×500 mm, about 500 mm×1000 mm, about 1000 mm×1000 mm, about 1500 mm×1000 mm, about 1000 mm×1500 mm, about 1500 mm×1500 mm, about 1800 mm×1500 mm, about 1500 mm×1800 mm, about 1800 mm×1800 mm, about 2000 mm×1800 mm, about 1800 mm×2000 mm, or about 2000 mm×2000 mm, including all values in between.

The solid electrolyte membrane 3210 may range in diameter from about 5 mm to about 200 mm. For example, the solid electrolyte membrane 3210 may have a diameter of about 5 mm, about 6 mm, about 7 mm, about 8 mm, about 10 mm, about 15 mm, about 20 mm, about 25 mm, about 30 mm, about 35 mm, about 40 mm, about 45 mm, about 50 mm, about 55 mm, about 60 mm, about 65 mm, about 70 mm, about 75 mm, about 80 mm, about 85 mm, about 90 mm, about 100 mm, about 110 mm, about 120 mm, about 130 mm, about 140 mm, about 150 mm, about 160 mm, about 170 mm, about 180 mm, about 190 mm, or about 200 mm, including all values in between.

The solid electrolyte membrane 3210 may have a material density of >80% density and more preferably >90% density. For example, the solid electrolyte membrane 3210 may have a material density of about 90% to about 95%, and preferably about 92%. The solid electrolyte membrane 3210 may have one or more grain boundaries 3212 as shown in FIG. 32. The grain boundaries 3212 may be positively charged. Alternatively, the grain boundaries may be negatively charged. The spacing between adjacent grain boundaries 3212 may range from about 10 nm to about several μm (e.g., about 1 μm to about 10 μm) including all values in between. For example, the grain boundaries 3212 may be separated from each other by about 200 nm to about 400 nm.

The irradiation detection device 3200 may also include a substrate 3220. The solid electrolyte membrane 3210 may be attached to the substrate 3220 via chemical or physical vapor deposition, including but not limited to chemical vapor deposition, sputtering, pulsed laser deposition, or molecular-beam epitaxy deposition. The substrate 3220 may support the growth of the solid electrolyte membrane 3210. The substrate 3220 may be attached to the underside of the solid electrolyte membrane 3210. The substrate 3220 may be made of any electrically insulating material so as not to partially short out current flowing through the solid electrolyte membrane 3210. For example, the substrate 3220 may include a MgO, Al₂O₃, or SiO₂ substrate.

The irradiation detection device 3200 may also include one or more electrodes 3230. The electrodes 3230 may be made of any metallic material that may conduct electrons at a conductivity of about >10⁻³S/cm and/or any metallic material that may conduct ions at a conductivity of about 10−5S/cm as described above. For example, the electrodes 3230 may be platinum (Pt), a platinum alloy, gold, or stainless-steel electrodes. The platinum alloy may include but is not limited to a PtNi alloy (e.g., Pt₄₀Ni₆₀, Pt₅₀Ni₅₀, and/or Pt₇₅Ni₂₅), a PtFe alloy (e.g., Pt₃Fe), a PtCo alloys (e.g., Pt₃Co and/or PtCo), and/or a PtCu alloys (e.g., Pt_{0.5}Cu_{0.5}). Alternatively, the electrodes 3230 may be made of a highly electronically conducting metallic oxide (e.g., indium tin oxide (ITO)) and/or a mixed ionic-electronic conducting metallic oxide (e.g., lanthanum strontium cobalt iron oxide (LSCF). Alternatively, the electrodes may be made of graphite, lithium, lithium cobalt oxide (LiCoO₂), lithium manganese oxide (LiMn₂O₄), lithium iron phosphate (LiFePO₄), nickel manganese cobalt oxide (NMC), lithium nickel manganese cobalt oxide (LiNiₓMn_{y}Co_{z}O₂), lithium nickel cobalt aluminum oxide (LiNiCoAlO₂ or NCA), lithium titanate (Li₄Ti₅O₁₂), La_{0.6}Sr_{0.4}FeO_{3-δ} (LSF), La_{0.5}Sr_{0.5}Cr_{0.2}Mn_{0.8}O_{3-δ} (LSCrMn), La_{0.9}Sr_{0.1}CoO_{3-δ} (LSC), Ba_{0.5}Sr_{0.5}Co_{0.8}Fe_{0.2}O_{3-δ} (BSCF), La_{0.8}Sr_{0.2}MnO₃ (LSM), Sm_{0.5}Sr_{0.5}CoO_{3-δ} (SSC), La_{0.5}Sr_{0.5}MnO_{3-δ} (LSM), LSM with Sc doping, La_{0.8}Sr_{0.2}Sc_{0.5}Fe_{0.5}O_{3-δ} (LSSF), BaCe_{0.26}Ni_{0.1}Fe_{0.64}O_{3-δ} (BCNF10), BaCo_{0.4}Fe_{0.4}Zr_{0.1}Y_{0.1}O_{3-δ} (BCFZY_{0.1}), BaCe_{0.26}Ni_{0.1}Fe_{0.64}O_{3-δ} (BCNF10), NdBa_{0.5}Sr_{0.5}Co_{1.5}Fe_{0.5}O_{5+δ} (NBSCF), BaPr_{0.8}In_{0.2}O_{3-δ} (BPI), palladium (Pd), a palladium alloy (e.g., PdAg and/or PdCu), NaₓCoO₂, Na₃V₂(PO₄)₃, NaₓMnO₂, NaₓTiO₂, Na₂Ti₃O₇), K_{0.3}MnO₂, K_{0.55}CoO₂, KₓFe₂(CN)₆, K₂Fe₄(CN)₆, K₂Mn[Fe(CN)₆], KₓMnO₂, CuBr, AgBr, PbBr₂, CuBr₂, CsPbBr3, CuI, AgI, PbI2, BiI3, and/or SnI₄. The electrodes 3230 may be attached to the top surface 3211 of the solid electrolyte membrane 3210. Preferably the irradiation detection device 3200 includes two electrodes 3230. In this embodiment, a first electrode 3230a may be a working electrode and the second electrode 3230b may be a counter electrode. In another embodiment, the first electrode 130a may be a cathode and the second electrode 130b may be an anode.

For example, at least two electrodes 3230 may be attached to either side of the solid electrolyte membrane 3210. The electrodes 3230 may be interdigitated electrodes (e.g., with interwoven fingers to increase the electrode 3230 surface area) or planar electrodes. Each electrode 3230 may be approximately 100 nm thick. The electrodes 3230a and 3230b may be the same size (e.g., length, width, or diameter) as solid electrolyte membrane 3210. The electrodes 3230a and 3230b may be spaced about 1 μm apart to about >100 μm apart (e.g., about 100 μm to about 900 μm). If the electrodes 3230a and 3230b are interdigitated electrodes, the spacing between the digits may range from about 1 μm to about >100 μm (e.g., about 100 μm to about 900 μm). For example, the spacing between the digits of the interdigitated electrodes may be about 1 μm, about 10 μm, about 20 μm, about 30 μm, about 50 μm, about 60 μm, about 70 μm, about 80 μm, about 90 μm, about 100 μm, about 200 μm, about 300 μm, about 400 μm, about 500 μm, about 600 μm, about 700 μm, about 800 μm, or about 900 μm, including all values in between. The electrodes 3230 may be oval, circular, square, or rectangular in shape. For example, each electrode 3230 may be a rectangle covering an area of about 5 mm×1 mm on the surface 3211 of the solid electrolyte membrane 3210.

The electrodes 3230 may be deposited on the solid electrolyte membrane 3210 via sputtering. The electrodes 3230 may be attached to one or more wires 3231 using a silver paste. The wires 3231 may be made of any high melting point metal that exhibits corrosion resistance. For example, the wires 3231 may be platinum, gold, and/or stainless-steel wires. The electrodes 13320 may be used to apply a voltage to the solid electrolyte membrane 3210. The irradiation detection device 3200 may also include a thermocouple to measure the temperature of the solid electrolyte membrane 3210.

As described above, the irradiation detection device 3200 may be used to detect optical illumination 105 or other radiation, including gamma radiation and/or UV radiation.

### Example 5: A Multi-Functional, Ion-Conducting Polycrystalline Radiation Detector for Simultaneous Spectroscopic and Dosimetric Applications

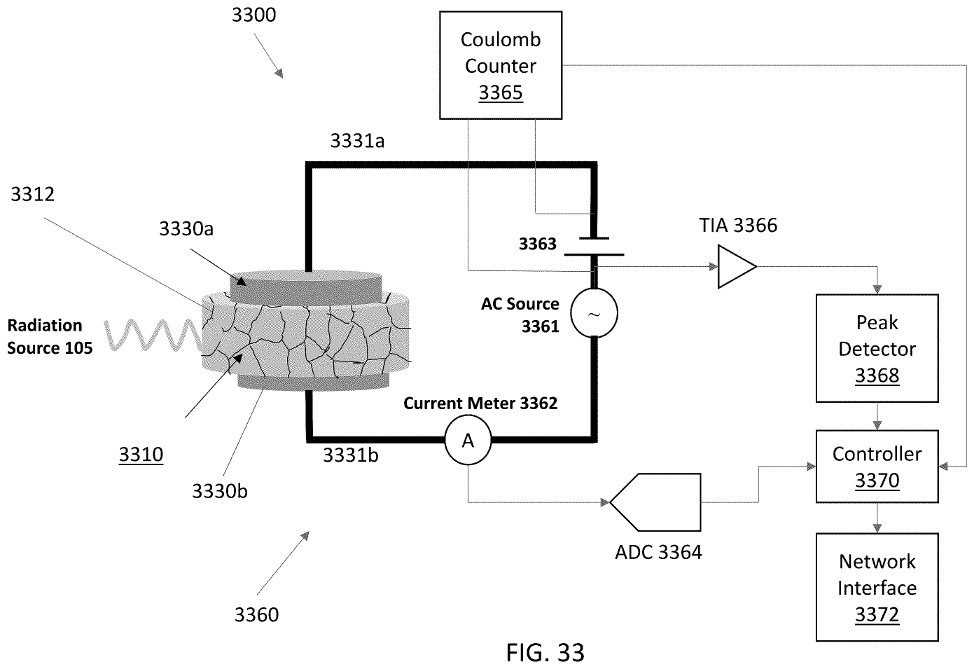

FIG. 33 illustrates a dual-function irradiation detection device 3300. FIG. 33 illustrates a dual-function irradiation detection device 3300. As described above, the irradiation detection device 3300 may be used in a variety of formats. For example, the irradiation detection device 3300 may be in the form of a large panel or plate for use in security. The large panel device may range in size from about 2 mm×2 mm to about 1 m×1 m. Alternatively, the irradiation detection device 3300 may be in the form of a small, encapsulated cylinder for use in drilling and/or mining. The small, encapsulated cylinder device may range in size from about 2 mm in diameter to about 10 mm in diameter and from about 1 cm long to about 5 cm long.

The irradiation detection device 3300 may include a polycrystalline ion-conducting solid electrolyte 3310 made of any of the polycrystalline materials disclosed herein. The polycrystalline ion-conducting solid electrolyte 3310 may be in the form of a solid electrolyte pellet (e.g., pellet 110′), a solid electrolyte membrane (e.g., membrane 3210), and/or a solid electrolyte film (e.g., film 110) as described above. In one embodiment, the polycrystalline ion-conducting solid electrolyte 3310 is in the form of a solid electrolyte pellet (e.g., pellet 110′). The solid electrolyte pellet may be approximately 100 μm thick to about 100 mm thick, preferably >200 μm thick. In another embodiment, the polycrystalline ion-conducting solid electrolyte 3310 is in the form of a solid electrolyte membrane (e.g., membrane 3210). The solid electrolyte membrane may be about 2 μm to about 200 μm thick, including all values in between. In yet another embodiment, the polycrystalline ion-conducting solid electrolyte 3310 is in the form of a solid electrolyte film (e.g., film 110). The solid electrolyte film may be approximately <1 μm thick (e.g., about 100 nm to about 900 nm thick) to about tens of μm thick (e.g., about 10 μm to about 100 μm thick). The polycrystalline ion-conducting solid electrolyte 3310 may be prepared as described above in the sample preparation section (e.g., by consolidating a powder through applied pressure and high temperature sintering). Other suitable methods for preparing the polycrystalline ion-conducting solid electrolyte 3310 include, but are not limited to, a traditional ceramic consolidation process (e.g., Pressing (uniaxial, isostatic), slip casting, or extrusion), 3D printing, robocasting, palletization, injection molding, physical vapor deposition (PVD), sputtering, thermal evaporation, pulsed laser deposition, chemical vapor deposition (CVD), atomic layer deposition (ALD), a sol-gel process (e.g., spin coat, dip coat, and/or spray coat), tape casting, slip casting, screen printing, phase inversion, and/or extrusion. The preparation of the polycrystalline ion-conducting solid electrolyte 3310 may also include a heat treatment (e.g., a furnace and/or UV irradiation).

The polycrystalline ion-conducting solid electrolyte 3310 may have one or more grain boundaries 3312 as shown in FIG. 33. The grain boundaries 3312 may be positively charged. Alternatively, the grain boundaries may be negatively charged. The spacing between adjacent grain boundaries 3312 may range from about 10 nm to about several μm (e.g., about 1 μm to about 10 μm) including all values in between. For example, the grain boundaries 3312 may be separated from each other by about 200 nm to about 400 nm. The polycrystalline ion-conducting solid electrolyte 3310 may conduct one or more ionic species (e.g., O²⁻, Li⁺, Na⁺, Cu⁺, OH⁻, H⁺, K⁺, Br⁻, Cl⁻, Mg²⁺, K⁺, F⁻, Ag⁺, Al³, and/or I⁻) from room temperature (e.g., about 20° C. to about 22° C.) up to about 800° C. The polycrystalline ion-conducting solid electrolyte 3310 may be electronically insulating and/or ionically conductive, allowing for the exclusive transport of ions. In the polycrystalline ion-conducting solid electrolyte 3310, the grain boundaries 3312 may be ionically blocking due to prescribed processing conditions and/or through the in-diffusion/segregation of selected periodic table elements (e.g., Al, Ga, Fe, Ti, Pr, Cr, Co, Cu, Mn, B, Li, Na, Sr, Zn, Mg, Y, Zr, Ge, Si, Ca, Pb, P and/or Ni) that may allow one to control the net charge of the interface. The choice of element may depend on the relative charge of the mobile ion (e.g. O²⁻, Li⁺, and/or H⁺) in the polycrystalline ion-conducting solid electrolyte 3310. For example, Boron and/or lithium may be used with a doped CoO₂ polycrystalline ion-conducting solid electrolyte 3310.

The irradiation detection device 3300 may also include one or more electrodes 3330. The electrodes 3330 may be made of any metallic material that may conduct electrons at a conductivity of about >10⁻³S/cm and/or any metallic material that may conduct ions at a conductivity of about 10⁻⁵S/cm as described above. For example, the electrodes 3330 may be platinum (Pt), a platinum alloy, gold, or stainless-steel electrodes. The platinum alloy may include but is not limited to a PtNi alloy (e.g., Pt₄₀Ni₆₀, Pt₅₀Ni₅₀, and/or Pt₇₅Ni₂₅), a PtFe alloy (e.g., Pt₃Fe), a PtCo alloys (e.g., Pt₃Co and/or PtCo), and/or a PtCu alloys (e.g., Pt_{0.5}Cu_{0.5}). Alternatively, the electrodes 3330 may be made of a highly electronically conducting metallic oxide (e.g., indium tin oxide (ITO) and/or a mixed ionic-electronic conducting metallic oxide (e.g., lanthanum strontium cobalt iron oxide (LSCF)). Alternatively, the electrodes may be made of graphite, lithium, lithium cobalt oxide (LiCoO₂), lithium manganese oxide (LiMn₂O₄), lithium iron phosphate (LiFePO₄), nickel manganese cobalt oxide (NMC), lithium nickel manganese cobalt oxide (LiNiₓMn_{y}Co_{z}O₂), lithium nickel cobalt aluminum oxide (LiNiCoAlO₂ or NCA), lithium titanate (Li₄Ti₅O₁₂), La_{0.6}Sr_{0.4}FeO_{3-δ} (LSF), La_{0.5}Sr_{0.5}Cr_{0.2}Mn_{0.8}O_{3-δ} (LSCrMn), La_{0.9}Sr_{0.1}CoO_{3-δ} (LSC), Ba_{0.5}Sr_{0.5}Co_{0.8}Fe_{0.2}O_{3-δ} (BSCF), La_{0.8}Sr_{0.2}MnO₃ (LSM), Sm_{0.5}Sr_{0.5}CoO_{3-δ} (SSC), La_{0.5}Sr_{0.5}MnO_{3-δ} (LSM), LSM with Sc doping, La_{0.8}Sr_{0.2}Sc_{0.5}Fe_{0.5}O_{3-δ} (LSSF), BaCe_{0.26}Ni_{0.1}Fe_{0.64}O_{3-δ} (BCNF10), BaCo_{0.4}Fe_{0.4}Zr_{0.1}Y_{0.1}O_{3-δ} (BCFZY_{0.1}), BaCe_{0.26}Ni_{0.1}Fe_{0.64}O_{3-δ} (BCNF10), NdBa_{0.5}Sr_{0.5}Co_{1.5}Fe_{0.5}O_{5+δ} (NBSCF), BaPr_{0.8}In_{0.2}O_{3-δ} (BPI), palladium (Pd), a palladium alloy (e.g., PdAg and/or PdCu), NaₓCoO₂, Na₃V₂(PO₄)₃, NaₓMnO₂, NaₓTiO₂, Na₂Ti₃O₇), K_{0.3}MnO₂, K_{0.55}COO₂, KₓFe₂(CN)₆, K₂Fe₄(CN)₆, K₂Mn[Fe(CN)₆], KₓMnO₂, CuBr, AgBr, PbBr₂, CuBr₂, CsPbBr3, CuI, AgI, PbI2, BiI3, and/or SnI₄. In one embodiment, the electrodes 3330 may be attached to a top surface of the polycrystalline ion-conducting solid electrolyte 3310 (not shown).

Preferably the irradiation detection device 3300 includes two electrodes 3330. In this embodiment, a first electrode 3330a may be a working electrode and the second electrode 3330b may be a counter electrode. In another embodiment, the first electrode 130a may be a cathode and the second electrode 130b may be an anode. In another embodiment, shown in FIG. 33, the electrodes 3330 may be attached to either side of the polycrystalline ion-conducting solid electrolyte 3310 such that the polycrystalline ion-conducting solid electrolyte 3310 may be sandwiched between the two ionically and electronically reversible electrodes 3330a and 3330b. These electrodes 3330a and 3330b may conduct ions and electrons, for example as utilized in battery and fuel cell applications, and as described herein. The electrodes 3330a and 3330b may be interdigitated electrodes (e.g., with interwoven fingers to increase the electrode 3330a and 3330b surface area) or planar electrodes.

As described above, the polycrystalline ion-conducting solid electrolyte 3310 may also be attached to a substrate (not shown). The substrate may support the growth of the polycrystalline ion-conducting solid electrolyte 3310. The substrate may be made of any electrically insulating material so as not to partially short out current flowing through the polycrystalline ion-conducting solid electrolyte 3310. For example, the substrate may include a MgO, Al₂O₃, or SiO₂ substrate.

The irradiation detection device 3300 may also include a circuit 3360. The circuit 3360 may include AC source 3361. The AC source 3361 may be used to operate the irradiation detection device 3300 and measure the impedance of the irradiation detection device 3300. The impedance of the irradiation detection device 3300 may be measured by applying an AC current from the AC source 3361 with varying frequency (o) and locking in on the output current to measure amplitude and phase. The amplitude of the current applied by the AC source 3361 may range from about 10 mV to about 100 V, including all values in between. For example, the amplitude of the current applied by the AC source 161 may range from about 10 mV to about 10 V, or about 50 mV to about 500 mV. The circuit 3360 may also include a current meter 3362. The current meter 3362 may measure the current running through the detection device 3350 under the applied AC source 3361.

The AC source 3361 and the current meter 3362 may be connected to the electrodes 3330a and 3330b through one or more wires 3331a and 3331b forming the circuit 3360 as shown in FIG. 33. The wires 3331a and 3331b may be platinum wires. The wires 3331a and 3331b may be attached to the electrodes 3330a and 3330b using a silver paste as described above. The circuit 3360 may also include a DC source 3363. The DC source 3363 may be used to apply a DC overpotential to the circuit 3360. The overpotential may range from about 0 V to about 10 V. When the circuit 3360 includes the DC source 3363, the current meter 3362 may also measure any DC overpotential current induced by the DC source 3363. The irradiation detection device 3300 may also include a thermocouple (not shown) to measure the temperature of the polycrystalline ion-conducting solid electrolyte 3310.

The circuit 3360 may include an analog-to-digital converter (ADC) 3364 to monitor the voltage and measure the cumulative dose of the optical illumination 105 received by the irradiation detection device 3300 over time (e.g., for charge monitoring). The circuit 3360 may also include a Coulomb counter 3365 or fuel gauge IC to track the state of charge of the irradiation detection device 3300.

The circuit 3360 may also include a transimpedance amplifier (TIA) 3366 operably connected to the irradiation detection device 3300 to detect any small-scale discharges from the irradiation detection device 3300 for spectroscopic analysis of individual optical illumination 105 events (e.g., single event detection). The TIA 3366 may be used to convert small current pulses into voltage signals, amplifying them for detection and measurement (e.g., by the microcontroller 3370). The amplification may help preserve the proportionality between the pulse amplitude and the detected energy.

The TIA 3366 may be coupled to a peak detector 3368, which can include a high-speed comparator 3367 that triggers on small-scale discharge events. The high-speed comparator 3367 may be used to discriminate amplified pulses from background noise. When a pulse exceeds a preset threshold, the comparator outputs a logic signal indicating an event has occurred. The peak detector 3368 senses the maximum amplitude of each pulse. This amplitude may be directly related to the energy of the optical illumination 105, enabling the spectroscopic analysis by the irradiation detection device 3300.

The irradiation detection device 3300 may also include a controller 3370, such as a microcontroller or field-programmable gate array (FPGA), to analyze and record measurements of the irradiation detection device 3300. The controller 3370 may process the data from both the charge monitoring and single event detection circuits. The controller 3370 may include or be operably coupled to a memory, such as random-access memory (RAM), dynamic random-access memory (DRAM), flash memory, or any suitable type of memory for short-term (volatile) or long-term (non-volatile) data storage. The controller 3370 may also be communicatively coupled to a storage device, which may be a hard disk drive (HDD), solid-state drive (SSD), cloud storage, or any suitable type of non-volatile storage for storing data over long periods of time. The controller 3370 may also include or be coupled to a network interface 3371. The irradiation detection device may also include a secondary battery (not shown) for powering the measurement circuitry.

The irradiation detection device 3300 may be used to detect optical illumination 105 and/or other radiation, such as gamma radiation, as described above.

### Irradiation Detection Device 3300 Operation:

The irradiation detection device 3300 may determine the radiation type and energy spectra (spectroscopic) while concurrently measuring the total radiation dose (dosimetry) over time. In other words, the irradiation detection device 3300 may operate simultaneously as a spectrometer and dosimeter. This may be achieved by combining an optically modulated solid electrolyte channel with a battery charging scheme that may depend on the amount of channel resistance modulation. Thus, the irradiation detection device 3300 may allow for inexpensive, sensitive, non-toxic, environmentally robust, and/or scalable radiation detectors that can operate in harsh environments, including but not limited to, high/low temperature, high/low pressure, and/or chemical environments.

As described above, the irradiation detection device 3300 disclosed herein relates to the field of radiation detection, specifically a gamma-ray and/or other high-energy radiation detector (e.g., gamma rays, X rays, neutrons and/or alpha particles) and may perform both spectroscopy and dosimetry using an ion-conducting polycrystalline solid electrolytes. As described above, the irradiation detection device 3300 may include an ion-conducting polycrystalline solid electrolyte. The ion-conducting polycrystalline solid electrolyte may be in the form of a film (e.g., solid electrolyte film 110), a pellet (e.g., the solid electrolyte pellet 110′), and/or a membrane (e.g., solid electrolyte membrane 3210). The irradiation detection device 3300 may also be used to detect ultra violet (UV) radiation.

The irradiation detection device 3300 may operate on the principles described above, whereby above band gap illumination or ionizing radiation (e.g., gamma rays, X rays, neutrons and/or alpha particles) may generate electron-hole pairs within a polycrystalline solid electrolyte pellet and/or film, inducing a temporary reduction (only while under illumination) in space-charge barriers at grain boundaries, leading to temporary enhancement in the ionic current. The irradiation detection device 3300 may also enable spectroscopic applications by recording the transient radiation signal as a function of time and signal strength to create a spectroscopic profile of the irradiating source. This second function comes from the fact that with appropriate electrodes, ion charges may be transferred from one electrode to another electrode under applied bias, for example, as is done in batteries. The magnitude of the resistance of the solid electrolyte pellet, membrane, and/or film may determine how many ions will be transferred. This means that as optical illumination (e.g., radiation) hits the material and temporarily increases its conductance, a corresponding quantity of ions will be transferred from one electrode to another. Upon exposure to optical illumination (e.g., irradiation), the charge on the counter electrode may start building up like in a battery. Then, the battery's open circuit voltage as a function of time may be monitored as a means of measuring the total amount of ionic charges transferred as a function of optical illumination exposure history. The irradiation detection device 3300 may have a response time of approximately 1 microsecond to a few seconds (e.g., 1 to 3 seconds), including any values in between. The irradiation detection device 3300 may also be charged like a battery and then upon exposure to optical illumination (e.g., irradiation), the irradiation detection device 3300 may discharge. In this embodiment, the amount of discharge may be proportional to the dose of optical illumination.

### Exclusive Spectroscopic Mode

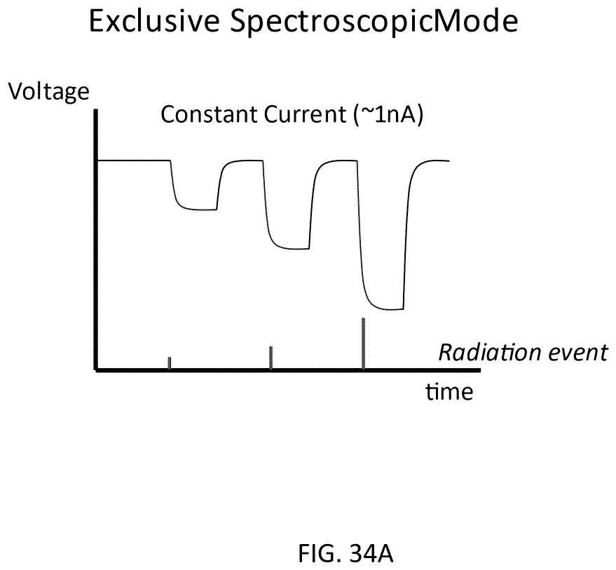

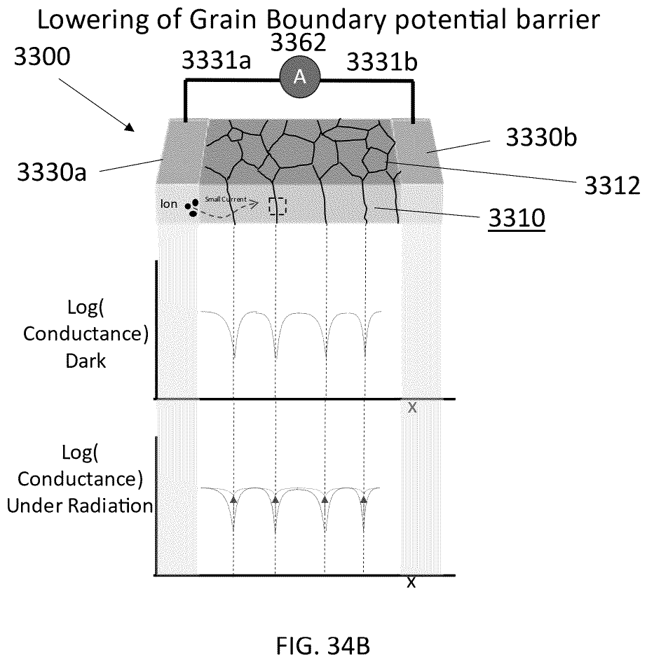

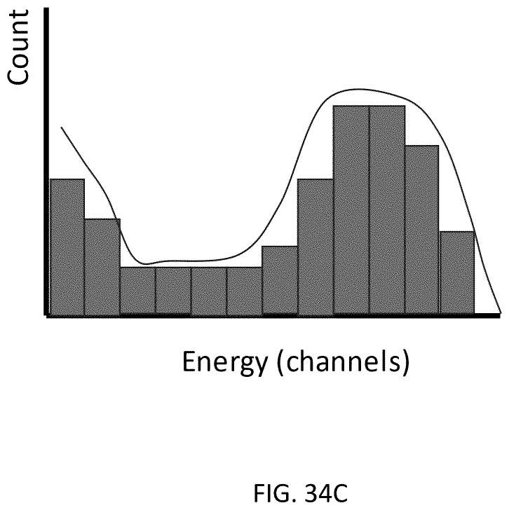

FIGS. 34A-34C illustrate operation of the irradiation detection device 3300 in an exclusive spectroscopic mode. Under small constant current measurements, variations in the circuit 3360 conductance due to irradiation may be recorded as changes in recorded voltage magnitude. The changes in recorded voltage magnitude may be measured using the current meter 3362. Significant changes in circuit 3360 conductance may result in significant voltage changes. This mode may be used for spectroscopic applications, where the irradiation detection device 3300 may measure the energy spectra of the optical illumination 105 since the temporary amount of energy absorbed by the polycrystalline ion-conducting solid electrolyte 3310 (and hence the temporary change in magnitude of the conductivity) may be proportional to the energy of the optical illumination 105.

As shown in FIG. 34A, the polycrystalline ion-conducting solid electrolyte 3310 resistance may decrease upon radiation absorption (e.g., from optical illumination 105 contacting the irradiation detection device 3300), which may result in a decrease in applied voltage. The magnitude of the decrease in applied voltage may be proportional to the magnitude of the optical illumination 105 implanted into the irradiation detection device 3300 due to the proportional and temporary reduction in space charge potential barriers at the grain boundaries 3312 as shown in FIG. 34B. For each detected radiation event, the irradiation detection device 3300 may record the change in conductivity of the polycrystalline ion-conducting solid electrolyte 3310, which can then be used to build an energy spectrum for the optical illumination 105 (see FIG. 34C). A constant current measurement may ensure that the same amount of charge may be transferred between the electrodes 3330a and 3330b. One advantage of operating the irradiation detection device 3300 under constant current mode is that even with reduced circuit 3360 resistance, the number of ionic charges being transferred between the electrodes 3330a and 3330b may be minimal, which may result in a negligible buildup of battery charge. In this embodiment, the irradiation detection device 3300 may be used to measure exclusively spectroscopic information.

### Dosimetric and Spectroscopic Mode

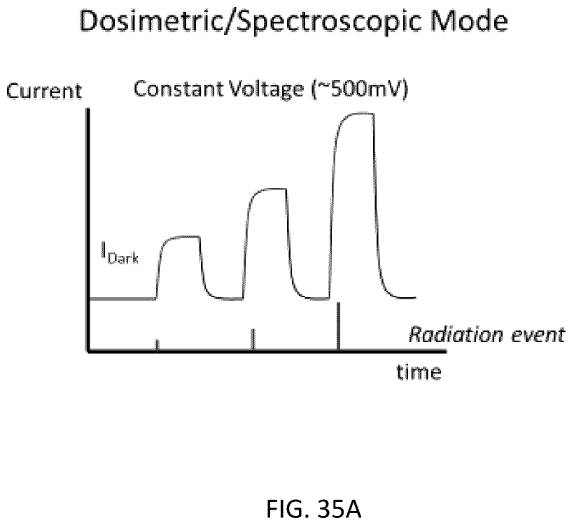

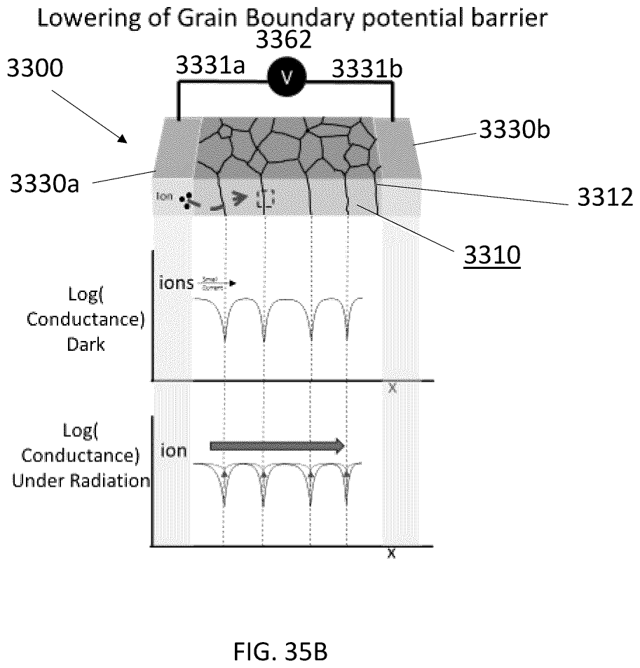

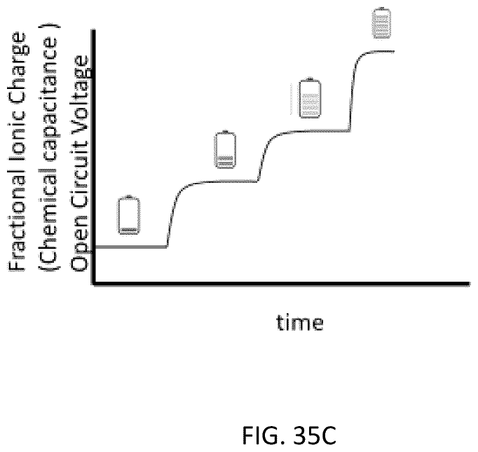

FIGS. 35A-35C illustrate operation of the irradiation detection device 3300 in the dual dosimetric and spectroscopic mode. For dosimetry applications, common detectors may operate in an integral mode, continuously recording the total change in conductivity over time, which is directly proportional to the total absorbed radiation dose. The irradiation detection device 3300 may perform this directly with an open circuit voltage measurement between the electrodes 3330a and 3330b. When the irradiation detection device 3300 is operated under constant voltage mode, a variation in the circuit 3360 conductance of the polycrystalline ion-conducting solid electrolyte 3310 may result in a variation in the measured current density running through the irradiation detection device 3300 (see FIG. 35A). The current density may be measured using the current meter 3362. This temporary modulation of the circuit 3360 current may allow first a spectroscopic measurement as described above.

In operation, when optical illumination 105 interacts with the irradiation detection device 3300 it may create a brief current pulse in the irradiation detection device 3300. The magnitude of this pulse may be proportional to the energy deposited by the optical illumination 105. A radiation spectrum may then be built from this measurement. The irradiation detection device 3300 may perform a pulse height analysis on the optical illumination 105 pulse. The amplitude of each captured pulse may be digitized and binned according to its magnitude. This allows the irradiation detection device 3300 to create a histogram of pulse heights, which corresponds to the energy spectrum of the optical illumination 105.

The irradiation detection device 3300 may also be able to calibrate the radiation spectrum. Prior to operation, the irradiation detection device 3300 may be exposed to optical illumination 105 from known optical illumination 105 (e.g., radiation) sources with well-defined energy peaks. This exposure may be used to calibrate the irradiation detection device 3300 to allow the irradiation detection device 3300 to covert the measured pulse heights into energy values.

As the irradiation detection device 3300 accumulates data from many optical illuminations 105, it may be able to build up a spectrum showing the distribution of energies in the optical illumination 105 source(s). Characteristic peaks in the determined spectrum may be used to identify specific radionuclides in the optical illumination 105.

Additionally, considering the current may be primarily ionic instead of electronic, this means that significant circuit 3360 conductance changes, at equally applied voltages, may result in a large ionic current being transferred between the electrodes 3330a and 3330b, which may lead to a change in the number of ionic charges in the electrodes 3330a and 3330b (e.g., the chemical capacitance of the electrodes 3330a and 3330b). Like a battery, this change in concentration of ionic charge in the electrodes 3330a and 3330b may be read out as an open circuit voltage, proportional to the difference in ion chemical activity between the two electrodes 3330a and 3330b. As shown in FIG. 35B, the increase in circuit 3360 current may be proportional to the magnitude of the optical illumination 105 implanted into the irradiation detection device 3300 due to the proportional and temporary reduction in space charge potential barriers at the grain boundaries 3312. This open circuit voltage may be proportional to the number of ionic charges transferred between the electrodes 3330a and 3330b and proportional to the total radiation dose from the optical illumination 105 the polycrystalline ion-conducting solid electrolyte 3310 was exposed to over time.

In operation, for each radiation event, the amount of ionic charge transferred between the electrodes 3330a and 3330b may be proportional to the optical illumination 105 rate, and the overall build in ionic species transferred between the electrodes 3330a and 3330b may be proportional to the total accumulated dose of optical illumination 105 (see FIG. 35C). In this way, measuring the open circuit voltage of the irradiation detection device 3300 may be a direct integral measure of the optical illumination 105 (e.g., radiation dose) over time and may not require additional circuits to perform the time integration. Additionally, constant voltage measurements may allow for a more significant amount of charge transfer between the electrodes 3330a and 3330b. Thus, the irradiation detection device 3300 may allow for simultaneous spectroscopic and dosimetry applications under constant voltage measurements by looking at the short-term modulation of the ionic current in the circuit 3360 and the long-term build-up of open circuit voltage due to the transfer of ionic species between the electrodes 3330a and 3330b.

Operation of the irradiation detection device 3300 in the dual dosimetric and spectroscopic mode may be analogous to the mode of operation of a normal Li lithium solid-state battery. For example, solid-state lithium-ion battery technology uses solid electrodes and a solid electrolyte instead of the liquid or polymer gel electrolytes found in traditional or “liquid” lithium-ion or lithium polymer batteries to transport Li from one electrode to the other. The working principles of lithium solid-state batteries are still based on lithium-ion movement, similar to traditional lithium-ion batteries, but with notable differences described below due to the solid nature of the electrolyte.

For example, a lithium solid-state battery may work by a reversible redox reaction between two pairs of electrodes (e.g., between a cathode and an anode). During charging, an external power source may apply a voltage across the anode and cathode, driving lithium ions to move from the cathode to the anode. Upon charging, the difference in Li concentration between the anode and cathode may create a built-in chemical potential that can be read out as an open circuit voltage. (e.g., the charge state can be read out electrically under open circuit conditions). After charging, if the lithium solid-state battery is held under open circuit conditions (e.g., the circuit is open), the fraction of Li-ions moved from the anode to the cathode may remain constant. When the battery discharges (e.g., upon closing the circuit and drawing a current), lithium ions may move back from the anode to the cathode through the solid electrolyte. This movement of ions is accompanied by a flow of electrons through the external circuit, which may provide the electric current to power the lithium solid-state battery.

In operation, similar to the operation of a lithium solid-state battery, during charging of the irradiation detection device 3300, an external power source (e.g., AC source 3361 and/or DC source 3363) may apply a voltage across the electrodes 3330a and 3330b, driving ions in the polycrystalline ion-conducting solid electrolyte 3310 to move between the electrodes 3330a and 3330b (e.g., between the cathode electrode and the anode electrode). The charging rate of the irradiation detection device 3300 may depend on the resistance of the polycrystalline ion-conducting solid electrolyte 3310. For example, under high resistance, a small ionic current can be generated, and therefore the charging may be extremely slow (e.g., nearly nonexistent). In contrast, when optical illumination 105 is applied to the irradiation detection device 3300, the optical illumination 105 may lower the overall grain boundary 3312 resistance, and, as a result, the ionic current flowing through the polycrystalline ion-conducting solid electrolyte 3310 may be much larger, enabling a higher charging rate of the irradiation detection device 3300.

The irradiation detection devices 100, 150, 350, 1150, and/or 3200 disclosed herein may operate in two different ways. In one way, the optical illumination may indirectly enable the charging of irradiation detection devices 100, 150, 350, 1150, and/or 3200. In this example, a secondary battery (e.g., battery 3372) may be used to power the measurement electronics for signal processing. The secondary battery may also act as the charging bias and may be activated by the optical illumination. Alternatively, in a second way, the optical illumination may discharge the irradiation detection devices 100, 150, 350, 1150, and/or 3200. In this example, a secondary battery (e.g., battery 3372) may be used to power the measurement electronics and/or initially charge the irradiation detection devices 100, 150, 350, 1150, and/or 3200.

The irradiation detection devices 100, 150, 350, 1150, and/or 3200 disclosed herein may also operate as both a spectrometer and dosimeter according to the example disclosed herein.

The dual functionality of the irradiation detection devices 100, 150, 350, 1150, 3200 and/or 3300 disclosed herein and the portability of the irradiation detection devices 100, 150, 350, 1150, 3200 and/or 3300 may make the irradiation detection devices 100, 150, 350, 1150, 3200 and/or 3300 applicable for personal Radiation Dosimeters and/or spectrometers and/or monitoring devices in a wide range of fields, including, but not limited to, nuclear power plants, radiological medical applications, environmental monitoring, nuclear nonproliferation, and space exploration.

The irradiation detection devices 100, 150, 350, 1150, 3200 and/or 3300 may operate simultaneously as a dosimeter and a spectrometer and may be capable of measuring the optical illumination (e.g., radiation dose) and be capable of determining the type or energy distribution of the optical illumination. The irradiation detection devices 100, 150, 350, 1150, 3200 and/or 3300 may also offer several improvements over current scintillation detectors and/or semiconductor detectors. For example, the irradiation detection devices 100, 150, 350, 1150, 3200 and/or 3300 may offer the advantage of simultaneous spectroscopy and dosimetry functions in a single device without the need for additional circuit elements. The irradiation detection devices 100, 150, 350, 1150, 3200 and/or 3300 may also have a high sensitivity and wide temperature operation range, be robust, scalable (e.g., for large areas), and/or cost-effective. Furthermore, the irradiation detection devices 100, 150, 350, 1150, 3200 and/or 3300 may exhibit radiation hardness, a fast response, and environmental robustness. Finally, the irradiation detection devices 100, 150, 350, 1150, 3200 and/or 3300 may be used in a wide range of pressure, temperature, and/or chemical environments.

### CONCLUSION

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain, using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A detector for gamma radiation, the detector comprising:
an ion-conducting polycrystalline material to absorb the gamma radiation, wherein the ion-conducting polycrystalline material is about 100 μm thick to about 100 mm thick;
a pair of electrodes, electrically coupled to the ion-conducting polycrystalline material, to apply a voltage across the ion-conducting polycrystalline material; and
a sensor, electrically coupled to the pair of electrodes, to measure a change in conductance of the ion-conducting polycrystalline material caused by absorption of the gamma radiation.

2. The detector of claim 1, having a dark resistance>10¹⁴ ohm.

3. The detector of claim 1, having a sensitivity ΔR/R of about 10¹.

4. The detector of claim 1, wherein the detector is not temperature sensitive below 400° C.

5. The detector of claim 1, wherein the voltage is about 10 mV to about 100 V.

6. The detector of claim 5, wherein the voltage is an alternating voltage.

7. The detector of claim 5, wherein the voltage is a constant voltage.

8. The detector of claim 1, wherein the ion-conducting polycrystalline material may conduct oxygen, magnesium, lithium, sodium, potassium, chlorine, fluorine, iodine, bromine, silver, copper, aluminum, hydroxide (OH−) or hydrogen (H+) ions.

9. The detector of claim 1, wherein the ion-conducting polycrystalline material comprises CeO₂ and a Gd dopant.

10. The detector of claim 9, wherein the Gd dopant may range from 0.5 atm % to 40 atm %.

11. The detector of claim 10, wherein the Gd dopant is 3 atm %.

12. The detector of claim 1, wherein the ion-conducting polycrystalline material comprises positively charged grain boundaries, wherein the positively charged grain boundaries are spaced about 10 nm apart from each other to about 1 μm apart from each other.

13. The detector of claim 1, wherein the ion-conducting polycrystalline material comprises negatively charged grain boundaries, wherein the negatively charged grain boundaries are spaced about 10 nm apart from each other to about 1 μm apart from each other.

14. The detector of claim 1, wherein the ion-conducting polycrystalline material is about 500 μm thick to about 10 mm thick.

15. A method of detecting radiation, the method comprising:
irradiating an ion-conducting polycrystalline material with the radiation, the radiation causing ions to migrate across grain boundaries within the ion-conducting polycrystalline material;
applying a voltage across a pair of electrodes, positioned to sandwich the ion-conducting polycrystalline material and electrically coupled to the ion-conducting polycrystalline material; and
sensing a change in conductance of the ion-conducting polycrystalline material caused by migration of the ions across the grain boundaries.

16. The method of claim 15, wherein the voltage is about 10 mV to about 100 V.

17. The method of claim 15, wherein the voltage is an alternating voltage, the method further comprising:
measuring an impedance of the ion-conducting polycrystalline material in response to the alternating voltage at a frequency of about 1 MHz to about 0.01 Hz; and
determining a conductivity of a bulk of the ion-conducting polycrystalline material based on the impedance of the ion-conducting polycrystalline material.

18. The method of claim 15, wherein the voltage is a constant voltage, the method further comprising:
sensing a change in current across the pair of electrodes caused by the radiation; and
determining a type of the radiation in response to the change in current across the pair of electrodes caused by the radiation.

19. The method of claim 18, further comprising:
determining an energy spectrum of the radiation based on the change in current across the pair of electrodes caused by the radiation.

20. The method of claim 15, further comprising:
measuring a change in a concentration of ionic charge in the pair of electrodes; and
determining a total dose of radiation received by the ion-conducting polycrystalline material over a period of time in response to the change in the concentration of ionic charge in the pair of electrodes.
